(19) United States
(12) Patent Application Publication
(10) Pub. No.: US 2019/0393464 A1
(43) Pub. Date: Dec. 26, 2019

(54) PASTING PAPERS AND CAPACITANCE LAYERS FOR BATTERIES COMPRISING MULTIPLE FIBER TYPES AND/OR PARTICLES

(71) Applicant: Hollingsworth & Vose Company, East Walpole, MA (US)

(72) Inventors: Teresa Grocela Rocha, Wellesley, MA (US); Angelika Mayman, Canton, MA (US); Nicolas Clement, Littleton, MA (US); John A. Wertz, Hollis, NH (US); Stephen T. Cox, Radford, VA (US); Sachin Kumar, Milford, NH (US)

(73) Assignee: Hollingsworth & Vose Company, East Walpole, MA (US)

(21) Appl. No.: 16/435,233

(22) Filed: Jun. 7, 2019

Related U.S. Application Data
(63) Continuation-in-part of application No. 16/009,978, filed on Jun. 15, 2018.
Application No. 16/009,978 is a continuation-in-part of application No. 15/839,810, filed on Dec. 12, 2017.

(51) Int. Cl. H01M 2/16; H01M 2/14; H01M 10/06

(52) U.S. Cl. CPC H01M 2/1626; H01M 10/06; H01M 2/1686; H01M 2/145

(57) ABSTRACT

Articles and methods involving pasting papers and/or capacitance layers are generally provided. The pasting paper may comprise a capacitance layer, and/or a stand-alone capacitance layer may be provided. In some embodiments, a pasting paper may comprise a plurality of cellulose fibers, a plurality of multicomponent fibers, and a plurality of glass fibers. In some embodiments, a pasting paper may comprise a plurality of conductive species, a plurality of capacitive species, and/or a plurality of inorganic particles. In some embodiments, a pasting paper may be disposed on a battery paste, such as a battery paste for use in a lead-acid battery. In some cases, forming a battery plate may comprise disposing a pasting paper on a battery paste. In some cases, a lead-acid battery may be assembled by assembling a first battery plate comprising a pasting paper with a separator and a second battery plate.

### RELATED APPLICATIONS

This application is a continuation-in-part of U.S. patent application Ser. No. 16/009,978, filed Jun. 15, 2018, and entitled “Pasting Papers and Capacitance Layers for Batteries Comprising Multiple Fiber Types and/or Particles”, which is a continuation-in-part of U.S. patent application Ser. No. 15/839,810, filed Dec. 12, 2017, and entitled “Pasting Paper for Batteries Comprising Multiple Fiber Types”, both of which are incorporated herein by reference in their entirety for all purposes.

### FIELD

The present invention relates generally to pasting papers and capacitance layers, and, more particularly, to pasting papers and capacitance layers comprising multiple types of fibers and/or particles.

### BACKGROUND

Pasting papers may be used to aid assembly of batteries (e.g., lead-acid batteries) by increasing the ease of manipulation of battery plates. Many pasting papers have properties that are advantageous for either battery use or battery assembly, but not for both. Many capacitance layers include a combination of species that result in sub-optimal performance of the capacitance layer and/or require relatively large amounts of conductive and/or capacitive species to achieve acceptable performance of the capacitance layer. Moreover, many battery plates exhibit undesirable degradation when positioned in lead-acid batteries absent pasting papers and/or capacitance layers.

Accordingly, improved compositions and methods are needed.

### SUMMARY

Pasting papers, capacitance layers, and related components and methods associated therewith are provided.

In some embodiments, lead-acid batteries are provided. The lead-acid battery comprises a battery plate comprising lead and a pasting paper disposed on the battery plate. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % of the non-woven fiber web based on the total weight of the non-woven fiber web.

In some embodiments, a battery comprises a battery plate comprising an active mass comprising lead and a layer comprising a plurality of conductive species and a plurality of capacitive species. A ratio of a weight of the plurality of conductive species to a weight of a plurality of capacitive species is greater than or equal to 5:95 and less than or equal to 30:70. A ratio of a sum of a weight of the plurality of conductive species and a weight of the plurality of capacitive species to a weight of the active mass is less than 1:100.

In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % and less than or equal to 80 wt % of the non-woven fiber web based on the total weight of the non-woven fiber web. The plurality of multicomponent fibers makes up greater than or equal to 10 wt % and less than or equal to 50 wt % of the non-woven fiber web based on the total weight of the non-woven fiber web. The plurality of glass fibers makes up greater than or equal to 10 wt % and less than or equal to 50 wt % of the non-woven fiber web based on the total weight of the non-woven fiber web. In some cases, the pasting paper has a thickness of less than 0.2 mm.

In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The pasting paper has a thickness of less than 0.2 mm, an air permeability of less than or equal to 300 CFM, a 1.28 spg sulfuric acid wicking height of greater than or equal to 3 cm, and/or is configured to have a dry tensile strength in a machine direction of greater than or equal to 1 lb/in after storage in 1.28 spg sulfuric acid at 75° C. for 7 days.

In some embodiments, a pasting paper for use in a battery comprises a non-woven fiber web comprising a plurality of cellulose fibers and a plurality of multicomponent fibers. The plurality of cellulose fibers makes up greater than or equal to 20 wt % of the non-woven fiber web based on the total weight of the non-woven fiber web. The pasting paper further comprises a plurality of conductive species. The plurality of conductive species comprises conductive fibers and/or conductive particles.

In some embodiments, a pasting paper for use in a battery comprises a non-woven fiber web comprising a plurality of cellulose fibers, a plurality of multicomponent fibers, and a plurality of glass fibers. The plurality of cellulose fibers makes up greater than or equal to 20 wt % of the non-woven fiber web based on the total weight of the non-woven fiber web. The pasting paper further comprises a plurality of conductive species and a plurality of capacitive species. A ratio of the weight of the plurality of conductive species to the plurality of capacitive species is greater than or equal to 5:95 and less than or equal to 30:70.

In some embodiments, a pasting paper for use in a battery comprises a non-woven fiber web comprising a plurality of cellulose fibers, a plurality of multicomponent fibers, and a plurality of glass fibers. The plurality of cellulose fibers makes up greater than or equal to 20 wt % of the non-woven fiber web based on the total weight of the non-woven fiber web. The pasting paper further comprises a plurality of inorganic particles.

In some embodiments, a pasting paper for use in a battery comprises a non-woven fiber web. The non-woven fiber web comprises a plurality of fibers. The pasting paper comprises barium oxide in an amount of greater than or equal to 0.1 wt % and less than or equal to 10 wt %.

In some embodiments, methods of forming battery plates are provided. A method of forming a battery plate comprises disposing a pasting paper on a battery paste comprising lead. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

In some embodiments, a method of forming a battery plate comprises disposing a pasting paper on a battery paste comprising lead. The pasting paper comprises a non-woven fiber web comprising a plurality of cellulose fibers and a plurality of multicomponent fibers having an average fiber diameter of greater than or equal to 1 micron. The plurality of cellulose fibers makes up greater than or equal to 20 wt % of the non-woven fiber web based on the total weight of the non-woven fiber web. The pasting paper further comprises one or more of a plurality of conductive species, a plurality of capacitive species, and a plurality of inorganic particles.

In some embodiments, methods of assembling lead-acid batteries are provided. A method of assembling a lead-acid battery comprises assembling a first battery plate comprising lead with a separator and a second battery plate to form a lead-acid battery. A pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

In some embodiments, methods of forming lead-acid batteries are provided. A method of forming a lead-acid battery comprises assembling a first battery plate comprising lead with a separator, an electrolyte, and a second battery plate to form a lead-acid battery. The pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web. The method further comprises dissolving at least a portion of the plurality of cellulose fibers within the pasting paper in the electrolyte.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a schematic depiction of a pasting paper, according to some embodiments;

FIG. 1B shows a schematic depiction of a pasting paper comprising two layers, according to some embodiments;

FIG. 2 shows a schematic depiction of a pasting paper disposed on a battery plate, according to some embodiments;

FIG. 3 shows a schematic depiction of a battery, according to some embodiments;

FIG. 4 shows a schematic depiction of a capacitance layer according to some embodiments; and

FIG. 5 shows a schematic depiction of a capacitance layer disposed on a battery plate, according to some embodiments.

### DETAILED DESCRIPTION

Articles that may be disposed on battery plates and methods involving articles that may be disposed on battery plates are generally provided. Such articles may include pasting papers, components of pasting papers, and/or capacitance layers. The capacitance layers described herein may be provided with a pasting paper (e.g., disposed thereon) or may be provided as a stand-alone layer.

In some embodiments, a pasting paper or capacitance layer comprises a non-woven fiber web comprising a combination of fiber types that is particularly advantageous. For instance, a pasting paper or capacitance layer may comprise a non-woven fiber web comprising multiple types of fibers, each of which provides certain advantages to the pasting paper or capacitance layer, and/or compensates for one or more disadvantages of other types of fibers also present in the pasting paper or capacitance layer. In some embodiments, a pasting paper or capacitance layer comprises a non-woven fiber web comprising multiple types of fibers and further comprises one or more types of particles and/or one or more types of microcapsules. The particles and/or the microcapsules may be present in the non-woven fiber web and/or the particles may be present in a layer disposed on the non-woven fiber web. In some embodiments, a capacitance layer comprises one or more types of particles and/or one or more types of microcapsules.

As an example of one fiber type, in some embodiments, a pasting paper or capacitance layer may comprise a plurality of glass fibers. When glass fibers are present therein, the pasting paper or capacitance layer may comprise a non-woven fiber web comprising the plurality of glass fibers, and/or the pasting paper or capacitance layer may comprise a layer comprising the plurality of glass fibers disposed on a non-woven fiber web. The glass fibers may strengthen the pasting paper or capacitance layer and increase its hydrophilicity and/or tendency to be wet by an electrolyte (e.g., as evidenced by a relatively large water absorption and/or a relatively low water contact angle), but may not adhere together well in the absence of a component binding them together. In some embodiments, glass fibers may reduce acid stratification in a battery in which the pasting paper or capacitance layer is positioned.

As another example of a fiber type, in some embodiments, a pasting paper or capacitance layer may comprise a plurality of multicomponent fibers. When multicomponent fibers are present therein, the pasting paper or capacitance layer may comprise a non-woven fiber web comprising the plurality of multicomponent fibers, and/or the pasting paper or capacitance layer may comprise a layer comprising the plurality of multicomponent fibers disposed on a non-woven fiber web. The multicomponent fibers may be weaker than glass fibers and/or less hydrophilic than glass fibers, but may bond glass fibers together. In some cases, it may be beneficial to bond glass fibers using multicomponent fibers. The use of multicomponent fibers for this purpose may result in a pasting paper and/or a non-woven fiber web (or a capacitance layer) that is less hydrophobic compared to the use of other materials that may be employed to bond glass fibers together, such as binder resins.

As a third example of a fiber type, in some embodiments, a pasting paper may comprise a plurality of fibers that enables the pasting paper or capacitance layer to have different properties prior to battery assembly than during battery cycling. The pasting paper or capacitance layer may comprise a non-woven fiber web comprising the plurality of fibers that enables the pasting paper or capacitance layer to have different properties prior to battery assembly than during battery cycling.

For example, a pasting paper may comprise a plurality of cellulose fibers. In some embodiments, a capacitance layer may comprise a plurality of cellulose fibers. When cellulose fibers are present therein, the pasting paper or capacitance layer may comprise a non-woven fiber web comprising the plurality of cellulose fibers, and/or the pasting paper or capacitance layer may comprise a layer comprising the plurality of cellulose fibers disposed on a non-woven fiber web. The plurality of cellulose fibers may be soluble in an electrolyte present in the battery. The plurality of cellulose fibers may reduce the mean pore size and air permeability of the pasting paper or capacitance layer prior to exposure to the electrolyte and increase the hydrophilicity of the pasting paper or capacitance layer, resulting in a pasting paper or capacitance layer with a lower mean pore size, lower air permeability, and/or higher hydrophilicity than an otherwise equivalent pasting paper or capacitance layer lacking these fibers. In turn, these fibers may increase the wicking height of the pasting paper or capacitance layer and/or enhance initial transport of the electrolyte into the pasting paper or capacitance layer. Upon exposure to the electrolyte, the plurality of cellulose fibers may partially or fully dissolve, leaving behind a pasting paper, capacitance layer, and/or a non-woven fiber web made up of relatively larger amounts of other fiber types, particles, and/or microcapsules. Pasting papers or capacitance layers comprising a plurality of fibers with this property, such as a plurality of cellulose fibers, may have a less open structure prior to battery assembly, reducing wet battery paste bleeding and/or dry battery paste dusting during fabrication, and may have a more open structure during battery usage, facilitating electrolyte and/or gas transport across the pasting paper or capacitance layer. The amount of cellulose fibers employed may be selected such that the pasting paper or capacitance layer still retains structural integrity after cellulose dissolution, and/or has an appropriate pore size and/or tensile strength such that battery paste shedding is minimized.

As a fourth example of a fiber type, in some embodiments, a pasting paper or capacitance layer may comprise a plurality of conductive fibers. When conductive fibers are present therein, the pasting paper or capacitance layer may comprise a non-woven fiber web comprising the plurality of conductive fibers, and/or the pasting paper or capacitance layer may comprise a layer comprising the plurality of conductive fibers disposed on a non-woven fiber web. The conductive fibers may form a conductive network through the pasting paper, through the capacitance layer, and/or through the layer in which they are positioned (e.g., a non-woven fiber web, a layer disposed on a non-woven fiber web, a stand-alone layer). The conductive network may have one or more benefits, such as enhancing the dynamic charge acceptance of a battery plate on which the pasting paper or capacitance layer is disposed, improving the cycling stability of a battery plate on which the pasting paper or capacitance layer is disposed, and/or increasing the utilization of active material within a battery plate on which the pasting paper or capacitance layer is disposed.

As a fifth example of a fiber type, in some embodiments, a pasting paper or capacitance layer may comprise a plurality of capacitive fibers. When capacitive fibers are present therein, the pasting paper or capacitance layer may comprise a non-woven fiber web comprising the plurality of capacitive fibers, and/or the pasting paper or capacitance layer may comprise a layer comprising the plurality of capacitive fibers disposed on a non-woven fiber web. The capacitive fibers may store non-faradaic charge on their surfaces. In some such embodiments, the pasting paper or capacitance layer comprising the capacitive fibers may have a lower electrical resistance than the battery plate, and so may become charged prior to the battery plate during high current charging and/or become discharged prior to the battery plate during high current discharging. This may reduce battery plate charging and/or discharging, which may reduce battery plate degradation. Battery plates with reduced degradation may enhance cycle life of batteries in which they are positioned.

As a sixth example of a fiber type, in some embodiments, a pasting paper or capacitance layer may comprise a plurality of fibers configured to scavenge contaminants from the battery. When fibers configured to scavenge contaminants from the battery are present therein, the pasting paper or capacitance layer may comprise a non-woven fiber web comprising the plurality of fibers configured to scavenge contaminants from the battery, and/or the pasting paper or capacitance layer may comprise a layer disposed on a non-woven fiber web comprising such fibers. The contaminants may be scavenged by a chemical reaction between the fibers and the contaminant (e.g., the contaminants may be scavenged by a reaction that causes the contaminant to be incorporated into the fibers) and/or may be scavenged by a physical interaction between the fibers and the contaminant (e.g., the fibers may have a porous structure that acts as a filter that holds contaminants in the interior of the fibers). As contaminants may negatively interact with other battery components, scavenging them may enhance battery life and/or performance. In some embodiments, contaminant scavenging may reduce self-discharge by the battery and/or may reduce water loss during battery cycling. Fibers comprising activated carbon are one example of a type of fiber configured to scavenge contaminants from the battery.

In some embodiments, a pasting paper includes some or all of the fibers types described above. In some embodiments, a pasting paper lacks one or more of the fiber types described above, or includes one or more of the fiber types described above in minimal amounts. For instance, some pasting papers described herein may lack glass fibers, or may comprise glass fibers in minimal amounts. Similarly, the capacitance layers described herein may include a variety of suitable combinations of the fibers described herein (e.g., a capacitance layer may comprise conductive fibers and/or capacitive fibers but lack multicomponent fibers). Other fiber types are also possible as described in more detail below.

As described herein, in some embodiments, a pasting paper and/or non-woven web may include particles. In some embodiments, a capacitance layer may include particles. As an example of a particle type, in some embodiments, a pasting paper or capacitance layer may comprise a plurality of conductive particles. When conductive particles are present therein, the pasting paper or capacitance layer may comprise a non-woven fiber web comprising the plurality of conductive particles, and/or the pasting paper or capacitance layer may comprise a layer comprising the plurality of conductive particles disposed on a non-woven fiber web. The conductive particles may enhance the utility of the pasting paper or capacitance layer for one or more of the reasons described above with respect to conductive fibers. For instance, the conductive particles may form a conductive network through the pasting paper or capacitance layer.

As a second example of a particle type, in some embodiments, a pasting paper or capacitance layer may comprise a plurality of capacitive particles. When capacitive particles are present therein, the pasting paper or capacitance layer may comprise a non-woven fiber web comprising the plurality of capacitive particles, and/or the pasting paper or capacitance layer may comprise a layer comprising the plurality of capacitive particles disposed on a non-woven fiber web. The capacitive particles may enhance the utility of the pasting paper or capacitance layer for one or more of the reasons described above with respect to capacitive fibers. For instance, the capacitive particles may store non-faradaic charge on their surfaces.

As a third example of a particle type, in some embodiments, a pasting paper or capacitance layer may comprise a plurality of inorganic particles. When inorganic particles are present therein, the pasting paper or capacitance layer may comprise a non-woven fiber web comprising the plurality of inorganic particles, and/or the pasting paper may comprise a layer comprising the plurality of inorganic particles disposed on a non-woven fiber web. There are a variety of types of inorganic particles that may be incorporated into the pasting paper or capacitance layer.

Silica particles (e.g., particles comprising SiO₂, fumed silica particles) are one type of inorganic particle that may be included in a pasting paper or capacitance layer described herein. Silica may enhance one or more physical properties of the pasting paper or capacitance layer. For instance, the silica may increase the tortuosity of pores within the pasting paper or capacitance layer, which may result in reduced hydration shorts and/or reduced water loss in batteries comprising the pasting paper or capacitance layer. As another example, the silica may increase the surface area of the pasting paper or capacitance layer, which may assist in retention and/or absorption of electrolyte within the pasting paper or capacitance layer. Either or both of these properties may enhance the cycle life of a battery in which the pasting paper or capacitance layer comprising the silica is positioned. Silica may facilitate application of the pasting paper or capacitance layer to a battery electrode. For instance, silica may reduce the slip of the pasting paper or capacitance layer on a pasting belt. As described in further detail below, some types of silica, such as precipitated silica, may be configured to scavenge contaminants from a battery when positioned in a pasting paper or capacitance layer.

Barium sulfate particles are another type of inorganic particle that may be included in a pasting paper or capacitance layer described herein. Barium sulfate particles may assist in the nucleation of lead sulfate particles with finer sizes and/or assist in the nucleation of lead sulfate particles in advantageous locations in the battery during battery cycling.

As a fourth example of a particle type, in some embodiments, a pasting paper or capacitance layer may comprise a plurality of particles configured to scavenge contaminants from the battery. Such particles may be inorganic or may be organic. When particles configured to scavenge contaminants from the electrolyte are present therein, the pasting paper or capacitance layer may comprise a non-woven fiber web comprising the plurality of particles configured to scavenge contaminants from the battery, and/or the pasting paper or capacitance layer may comprise a layer disposed on a non-woven fiber web comprising such particles. The contaminants may be scavenged by a chemical reaction between the particles and the contaminant (e.g., the contaminants may be scavenged by a reaction that causes the contaminant to be incorporated into the particles) and/or may be scavenged by a physical interaction between the particles and the contaminant (e.g., the particles may have a porous structure that acts as a filter that holds contaminants in the interior of the particles). The particles configured to scavenge contaminants from the battery may enhance the utility of the pasting paper or capacitance layer for one or more of the reasons described above with respect to fibers particles configured to scavenge contaminants from the battery. For instance, the particles configured to scavenge contaminants from the battery may enhance battery life and/or performance.

Diatomite particles are one type of particle configured to scavenge contaminants from the battery that may be included in a pasting paper or capacitance layer described herein. As used herein, the term “diatomite” refers to a material formed by pulverizing the shells of diatom algae to form a powder. Advantageously, diatomite is inert to battery acid, and so can enhance one or more properties of a pasting paper or capacitance layer when positioned in a battery without undergoing significant degradation. For instance, in addition to scavenging contaminants, diatomite particles may enhance the porosity of the pasting paper or capacitance layer, which may enhance the acid absorption thereof (and/or of a battery plate adjacent to which the pasting paper or capacitance layer is positioned).

Precipitated silica and activated carbon are further examples of types of particle configured to scavenge contaminants from the battery that may be included in a pasting paper or capacitance layer described herein.

As a fifth example of a particle type, in some embodiments, a pasting paper or capacitance layer may comprise a plurality of particles configured to reduce hydrogen generation in the battery. When particles configured to reduce hydrogen generation in the battery are present therein, the pasting paper or capacitance layer may comprise a non-woven fiber web comprising the plurality of particles configured to reduce hydrogen generation in the battery, and/or the pasting paper or capacitance layer may comprise a layer comprising the plurality of particles configured to reduce hydrogen generation in the battery disposed on a non-woven fiber web. Hydrogen is commonly generated during battery operation, and disadvantageously causes water loss from the battery. This water loss reduces the recharge and charge acceptance of the battery plates in the battery. Hydrogen is also an explosive gas. Accordingly, reduction of hydrogen generation in a battery may advantageously increase its safety and/or performance. There are a variety of types of particles configured to reduce hydrogen generation that may be incorporated into the pasting paper or capacitance layer, including, but not limited to, rubber particles, metal oxide particles, and barium sulfate particles.

As described herein, in some embodiments, a pasting paper and/or non-woven web may include microcapsules. In some embodiments, a capacitance layer may include microcapsules. When microcapsules are present therein, the pasting paper or capacitance layer may comprise a non-woven fiber web comprising the plurality of microcapsules, and/or the pasting paper or capacitance layer may comprise a layer comprising the plurality of microcapsules disposed on a non-woven fiber web. The microcapsules may comprise an active agent that is encapsulated in a coating. The coating may comprise pores through which the active agent is configured to be slowly transported, allowing for release of the active agent over time. Such behavior may be advantageous for delivering a beneficial species to a battery over an appreciable period of time and/or for maintaining a desirable concentration of a beneficial species in the battery over time. In some embodiments, the coating is configured to degrade and/or dissolve over time in the battery. When the coating degrades and/or dissolves to a particular degree, it may be unable to prevent the active agent from being transported therethrough and may thus release the active agent. Such behavior may be advantageous for delivering a beneficial species to a battery at a point in time after battery assembly.

In some embodiments, as described above, a capacitance layer is provided. The capacitance layer may comprise a plurality of capacitive species (e.g., a plurality of capacitive fibers, a plurality of capacitive particles) and a plurality of conductive species (e.g., a plurality of conductive fibers, a plurality of conductive particles). The capacitance layer may further comprise one or more types of fibers, particles, and/or other species also described herein (e.g., described herein as being suitable for use in a pasting paper, a layer disposed on a non-woven fiber web, a resinous layer, etc.). The capacitance layer may take the form of a non-woven fiber web and/or may take the form of a resinous layer comprising one or more species dispersed within a binder resin. As described in more detail below, the capacitance layer may be provided alone (e.g., as a stand-alone layer), or in combination with a non-woven web or pasting paper described herein.

In some embodiments, a component of a battery other than a pasting paper or a capacitance layer is provided. Such components may comprise one or more types of fibers, particles, and/or other species also described herein. For instance, in some embodiments, a separator is provided comprising one or more types of fibers, particles, and/or other species also described herein.

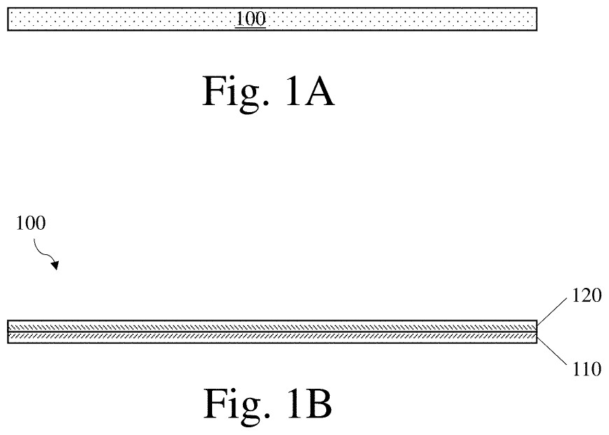

As described above, in some embodiments, pasting papers and other articles configured to be disposed on battery plates are generally provided. FIG. 1A shows one non-limiting example of a pasting paper 100. Some articles and methods relate to pasting papers, such as that shown in FIG. 1A; some articles and methods relate to the use of pasting papers, such as that shown in FIG. 1A, in batteries, such as lead-acid batteries. For instance, pasting papers as described herein may be employed during the formation of battery plates (e.g., lead battery plates for lead-acid batteries, lead dioxide plates for lead-acid batteries). In some embodiments, articles described herein may comprise pasting papers disposed on battery plates. In some embodiments, methods may comprise forming such articles by disposing pasting papers on battery pastes.

In some embodiments, a pasting paper comprises a non-woven fiber web. The non-woven fiber web may comprise two or more types of fibers that together enhance the properties of the pasting paper. In some embodiments, the pasting paper may include exactly one layer. The one layer may be a non-woven fiber web. In other embodiments, a pasting paper comprises two or more layers. One layer may be a non-woven fiber web, and the pasting paper may further comprise a layer (e.g., an additional layer) disposed on the non-woven fiber web. FIG. 1B shows one non-limiting example of a pasting paper 100 comprising a non-woven fiber web 110 and a layer 120 disposed on (e.g., adjacent) the non-woven fiber web. The layer disposed on the non-woven fiber web may be a second non-woven fiber web and/or may be a resinous layer comprising one or more species dispersed within a binder resin. In some embodiments, the layer disposed on the non-woven fiber web is a capacitance layer (e.g., a capacitance layer that is a second non-woven fiber web and/or a resinous layer).

When both a resinous layer (e.g., a resinous layer that is also a non-woven fiber web) and a non-woven fiber web (e.g., a non-woven fiber web that is not a resinous layer, a non-woven fiber web comprising less binder than the resinous layer) are present, the resinous layer typically includes a larger relative amount of particles and a lower relative amount of fibers than the non-woven fiber web, is typically less porous than the non-woven fiber web, and typically has a higher basis weight than the non-woven fiber web. In some embodiments, the air permeability of the resinous layer may be lower than the air permeability of the non-woven fiber web, and the air permeability of the pasting paper as a whole may be dominated by the air permeability of the non-woven fiber web. For example, the air permeability of the pasting paper as a whole may be within 10%, within 5%, within 2%, or within 1% of the air permeability of the resinous layer alone).

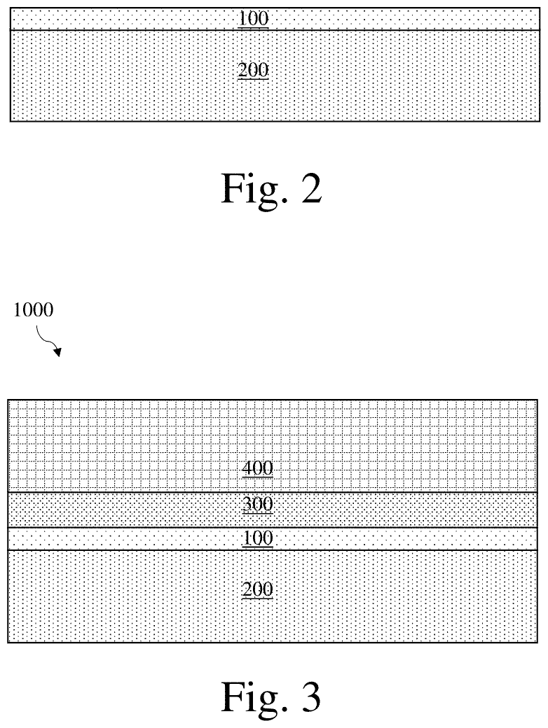

In some embodiments, a pasting paper disposed on a battery plate may aid handling of the battery plate. The pasting paper-covered battery plate may be easier to manipulate than an uncovered battery plate. FIG. 2 shows one non-limiting example of a pasting paper 100 disposed on a battery plate 200. In some embodiments, the battery plate may further comprise one or more additional components, such as a grid on which the battery paste is disposed (not shown). It should be noted that, although FIG. 2 shows the pasting paper and the battery plate as fully separate layers, in some embodiments the pasting paper may be partially and/or fully embedded in the battery plate. For instance, the pasting paper may be positioned such that at least a portion of the battery plate (e.g., the battery paste therein) penetrates into at least a portion of the pasting paper, and/or such that at least a portion of the pasting paper penetrates into at least a portion of the battery plate (e.g., into at least a portion of the battery paste therein). The surface of the pasting paper opposite the battery plate is typically free from any components present in the battery plate (e.g., it is typically free from the battery paste in the battery plate). In other words, the surface of the pasting paper opposite the battery plate is typically not embedded in the battery plate. As used herein, when a battery component is referred to as being “disposed on” another battery component, it can be directly disposed on the battery component, or an intervening battery component also may be present. A battery component that is “directly disposed on” another battery component means that no intervening battery component is present.

In embodiments in which a pasting paper or capacitance layer comprises more than one layer, the layer facing the battery plate may be selected as desired. In embodiments in which the pasting paper or capacitance layer comprises an external resinous layer comprising one or more species dispersed within a binder resin, the external resinous layer comprising the one or more species dispersed within the binder resin may be directly disposed on the battery plate. In some embodiments, an external resinous layer comprising the one or more species dispersed within the binder resin is partially and/or fully embedded in the battery plate. Layers comprising conductive species, capacitive species, microcapsules, and/or other types of particles and/or fibers described herein (e.g., glass fibers, multicomponent fibers, cellulose fibers inorganic particles, particles and/or fibers configured to scavenge contaminants, and/or particles and/or fibers configured to reduce hydrogen generation) may be directly disposed on battery plates, partially embedded in battery plates, and/or fully embedded in battery plates.

When disposed on a battery plate, a pasting paper may cover the battery plate during subsequent battery fabrication steps such as cutting the battery plate to size, drying and/or curing the battery plate in an oven, and assembling the battery plate with other battery components. The presence of the pasting paper on the battery plate during such steps may be advantageous. For instance, in some cases, the pasting paper may have a relatively low permeability to a battery paste. As an example, in the case of a pasting paper configured to be disposed on battery plates comprising lead particles, the pasting paper may have a relatively low permeability to lead particles. Relatively low amounts of wet lead and/or dry lead may be capable of passing through the pasting paper (e.g., the pasting paper may exhibit relatively low levels of wet lead bleeding and/or dry lead dusting therethrough). As another example, in the case of a pasting paper configured to be disposed on battery plates comprising lead dioxide particles, the pasting paper may have a relatively low permeability to lead dioxide particles. Relatively low amounts of wet lead dioxide and/or dry lead dioxide may be capable of passing through the pasting paper (e.g., the pasting paper may exhibit relatively low levels of wet lead dioxide bleeding and/or dry lead dioxide dusting therethrough). In such cases, the presence of a pasting paper disposed on the battery plate may also reduce exposure of individuals handling the battery plate to components of the battery plate (e.g., hazardous components, such as lead particles and/or lead dioxide particles in pasting papers configured for use in lead-acid batteries), and/or may reduce sticking between adjacent battery plates.

In some embodiments, a battery plate on which a pasting paper or capacitance layer is disposed may be incorporated into a battery. For example, in some embodiments, methods described herein may comprise positioning a battery plate (e.g., a battery plate on which a pasting paper is disposed) in a battery. The pasting paper may be positioned on a battery plate during battery plate processing, and then not removed from the battery plate prior to incorporation of the battery plate into a battery. As another example, in some embodiments, a method may comprise assembling a battery, such as a lead-acid battery. The battery may be assembled by assembling a first battery plate on which a pasting paper or capacitance layer is disposed with other battery components. These components may include one or more of a second battery plate, a separator, an electrolyte, and one or more current collectors. FIG. 3 shows one non-limiting example of a battery 1000 comprising a pasting paper 100, a first battery plate 200, a separator 300, and a second battery plate 400. It should be understood that pasting papers described herein may be incorporated into batteries comprising fewer components than those shown in FIG. 3 (e.g., batteries lacking a separator), and/or may be incorporated into batteries comprising more components than those shown in FIG. 3 (e.g., batteries comprising one or more current collectors). Other configurations are also possible.

In some embodiments, a battery plate and a pasting paper disposed thereon may be exposed to an electrolyte (e.g., during battery fabrication, during battery assembly). In some cases, at least a portion of the pasting paper (and/or all or portions of one or more layers therein) may dissolve in the electrolyte upon exposure of the battery plate and the pasting paper to the electrolyte. The remaining pasting paper (and/or layer(s) therein) may have a more open structure (e.g., as evidenced by a larger mean pore size and/or larger air permeability), and so may be more permeable to the electrolyte and/or gas, than the pasting paper prior to partial dissolution. The more open structure may still be sufficiently strong and impermeable to the battery paste (e.g., lead, lead dioxide) to prevent appreciable battery paste shedding (e.g., lead shedding, lead dioxide shedding).

For instance, a pasting paper may initially comprise a non-woven fiber web comprising a plurality of cellulose fibers that are configured to dissolve in the electrolyte (e.g., an electrolyte such as sulfuric acid, such as sulfuric acid at a concentration of 1.28 spg), and pluralities of glass fibers and multicomponent fibers that are configured to not dissolve in the electrolyte. The pasting paper may, additionally or alternatively, comprise pluralities of other species that are configured to not dissolve in the electrolyte (e.g., a plurality of conductive species such as conductive fibers and/or conductive particles, a plurality of capacitive species such as capacitive fibers and/or capacitive particles, a plurality of inorganic particles such as silica particles). The pluralities of species configured to not dissolve in the electrolyte may be present in a non-woven fiber web in the pasting paper and/or present in an additional layer (e.g., a capacitance layer) disposed on the non-woven fiber web.

In some embodiments, a pasting paper may comprise a non-woven fiber web comprising a plurality of species configured to dissolve in the electrolyte and/or may comprise an additional layer, such as a capacitance layer, that does not include species that are configured to dissolve in the electrolyte. For instance, a pasting paper may comprise a non-woven fiber web configured to entirely dissolve in the electrolyte and an additional layer configured to be stable in the electrolyte. Upon placement of a pasting paper of this type in a battery, the non-woven fiber web may dissolve away while the additional layer maintains its structural integrity. This process may result in the formation of a stand-alone additional layer in the battery, which may provide some or all of the advantages described elsewhere herein related to the use of a pasting paper during additional layer and/or battery fabrication while also allowing for the formation of a stand-alone layer. This may be advantageous for applications in which the additional layer is a capacitance layer whose handling is aided by the non-woven fiber web configured to dissolve in the electrolyte but for which the presence of that non-woven fiber web in the final battery is not desired.

After dissolution of at least a portion of the pasting paper (e.g., at least a portion of the plurality of cellulose fibers, or the entirety of the plurality of cellulose fibers), the non-woven fiber web may still comprise the plurality of glass fibers, the plurality of multicomponent fibers, and/or any other pluralities of species configured to not dissolve in the electrolyte. These remaining fibers and/or particles may make up a sufficient percentage of the non-woven fiber web and may be bound together sufficiently strongly to provide advantages to the resulting battery, such as preventing battery paste shedding. These remaining fibers and/or particles may be present in an additional layer, such as a capacitance layer, that remains disposed on a battery plate.

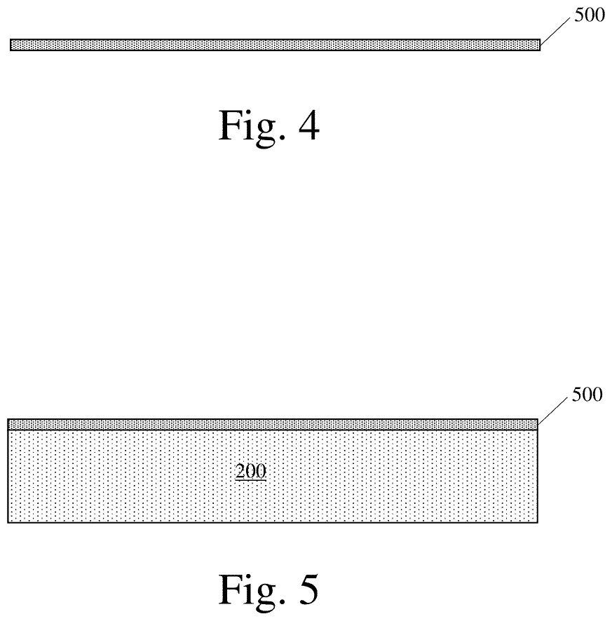

As described above, in some embodiments, capacitance layers are provided. FIG. 4 shows one non-limiting embodiment of a capacitance layer 500. When disposed on a battery plate, as is shown in FIG. 5, the capacitance layer may reduce battery plate degradation during charging and/or discharging. In some embodiments, a capacitance layer has one or more of the features described elsewhere herein with respect to one or more layers present in pasting papers, such as one or more features described elsewhere herein with respect to additional layers, layers disposed on non-woven fiber webs, non-woven fiber webs, and/or resinous layers comprising one or more species dispersed in a binder resin. By way of example, in some embodiments, a capacitance layer is an additional layer. In some embodiments, a capacitance layer is a non-woven fiber web and/or a resinous layer comprising a binder resin in which a plurality of capacitive species is dispersed and in which a plurality of conductive species is dispersed. The capacitance layer may be provided in the form of a layer of a pasting paper (e.g., an additional layer of a pasting paper, a layer disposed on a non-woven fiber web positioned in a pasting paper, a resinous layer positioned in a pasting paper), or may be provided separately from a pasting paper (e.g., as a stand-alone layer, as an additional layer not forming part of a pasting paper, as a non-woven fiber web not forming part of a pasting paper, as a resinous layer not forming part of a pasting paper).

Some articles and methods relate to capacitance layers, such as that shown in FIG. 4; some articles and methods relate to the use of capacitance layers (as components of pasting papers and/or as stand-alone layers), such as that shown in FIG. 4, in batteries, such as lead-acid batteries. In some embodiments, articles described herein may comprise capacitance layers disposed on battery plates (as shown in FIG. 5). In some embodiments, methods may comprise forming such articles by disposing capacitance layers on battery pastes.

It should be noted that, although FIG. 5 shows the capacitance layer and the battery plate as fully separate layers, in some embodiments the capacitance layer may be partially and/or fully embedded in the battery plate. For instance, the capacitance layer may be positioned such that at least a portion of the battery plate (e.g., the battery paste therein) penetrates into at least a portion of the capacitance layer, and/or such that at least a portion of the capacitance layer penetrates into at least a portion of the battery plate (e.g., into at least a portion of the battery paste therein). In some embodiments, a portion but not all of the capacitance layer penetrates into the battery plate or battery paste. The surface of the capacitance layer opposite the battery plate may be free from any components present in the battery plate (e.g., it may be free from the battery paste in the battery plate). In other words, in some embodiments, the surface of the capacitance layer opposite the battery plate is not embedded in the battery plate.

As described above, in some embodiments, a pasting paper or a capacitance layer may comprise a non-woven fiber web comprising a plurality of glass fibers. In some embodiments, glass fibers may be positioned in a non-woven fiber web (i.e., a non-woven fiber web may comprise a plurality of glass fibers, such as a non-woven fiber web that is a pasting paper or a non-woven fiber web that is a capacitance layer), may be positioned in a resinous layer (i.e., a resinous layer may comprise a plurality of glass fibers dispersed within a binder resin, such as a resinous layer comprising a binder resin with glass fibers dispersed within the binder resin), may be positioned in an additional layer (e.g., a layer disposed on a non-woven fiber web may comprise a plurality of glass fibers, an additional layer that is a capacitance layer may comprise a plurality of glass fibers), and/or may be positioned in a stand-alone layer (e.g., a stand-alone layer that is a capacitance layer may comprise a plurality of glass fibers).

When present in a non-woven fiber web or a pasting paper, all of the glass fibers within a plurality of glass fibers may together make up any suitable amount of the non-woven fiber web or the pasting paper. In other words, the total amount of glass fibers (e.g., the total amount of fibers that are microglass fibers, chopped strand glass fibers, or any other type of glass fiber) in the non-woven fiber web or the pasting paper may be selected as desired. Glass fibers may make up greater than or equal to 0 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, or greater than or equal to 60 wt % of the non-woven fiber web or the pasting paper. Glass fibers may make up less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 5 wt %, or less than or equal to 2 wt % of the non-woven fiber web or the pasting paper. Combinations of the above-referenced ranges are also possible (e.g., greater than or equal to 0 wt % and less than or equal to 70 wt % of the non-woven fiber web or the pasting paper, greater than or equal to 2 wt % and less than or equal to 70 wt % of the non-woven fiber web or the pasting paper, greater than or equal to 5 wt % and less than or equal to 50 wt % of the non-woven fiber web or the pasting paper, greater than or equal to 10 wt % and less than or equal to 50 wt % of the non-woven fiber web or the pasting paper, greater than or equal to 5 wt % and less than or equal to 40 wt % of the non-woven fiber web or the pasting paper, greater than or equal to 5 wt % and less than or equal to 20 wt % of the non-woven fiber web or the pasting paper, greater than or equal to 10 wt % and less than or equal to 25 wt % of the non-woven fiber web or the pasting paper, greater than or equal to 10 wt % and less than or equal to 15 wt % of the non-woven fiber web or the pasting paper, or greater than or equal to 20 wt % and less than or equal to 30 wt % of the non-woven fiber web or the pasting paper). In some embodiments, the pasting paper or the non-woven fiber web include 0 wt % glass fibers. Other ranges are also possible. In some embodiments, the ranges above for weight percentage are based on the total weight of the non-woven fiber web or the pasting paper. For example, the glass fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the glass fibers may be present in an amount of greater than or equal to 2 wt % and less than or equal to 70 wt % of the total amount of fibers in the non-woven fiber web or the pasting paper.

In some embodiments, a pasting paper may comprise a non-woven fiber web with an amount of glass fibers in one or more of the ranges described above with respect to the total weight of the non-woven fiber web, and/or may comprise a non-woven fiber web with an amount of glass fibers in one or more of the ranges described above with respect to the total amount of fibers in the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising glass fibers and an additional layer, and the pasting paper as a whole may have an amount of glass fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise glass fibers, and the pasting paper as a whole may have an amount of glass fibers in one or more of the ranges described above with respect to the total weight of the pasting paper and/or in one or more of the ranges described above with respect to the total amount of the fibers in the pasting paper. In some embodiments, a stand-alone layer comprising glass fibers is provided, such as a stand-alone layer that is a capacitance layer. In some embodiments, the additional layer or the stand-alone layer may be a resinous layer comprising a binder resin with the glass fibers dispersed within the binder resin.

When present in an additional layer (e.g., a layer disposed on a non-woven fiber web, an additional layer that is a capacitance layer, an additional layer that is a non-woven fiber web comprising glass fibers, an additional layer that is a resinous layer comprising a binder resin with glass fibers dispersed within the binder resin) or a stand-alone layer (e.g., a stand-alone layer that is a capacitance layer, a stand-alone layer that is a non-woven fiber web comprising glass fibers, a stand-alone layer that is a resinous layer comprising a binder resin with glass fibers dispersed within the binder resin), the glass fibers may make up any suitable amount of the additional layer or the stand-alone layer. The glass fibers may make up greater than or equal to 0 wt %, greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, or greater than or equal to 40 wt % of the additional layer or the stand-alone layer. The glass fibers may make up less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.5 wt %, less than or equal to 0.2 wt %, or less than or equal to 0.1 wt % of the additional layer or the stand-alone layer. Combinations of the above-referenced ranges are also possible (e.g., greater than or equal to 0 wt % and less than or equal to 50 wt % of the additional layer or the stand-alone layer, greater than or equal to 0 wt % and less than or equal to 10 wt % of the additional layer or the stand-alone layer, or greater than or equal to 1 wt % and less than or equal to 5 wt % of the additional layer or the stand-alone layer). In some embodiments, the additional layer or the stand-alone layer include 0 wt % glass fibers. Other ranges are also possible. The ranges above for weight percentage are based on the total dry weight of the additional layer or the stand-alone layer. For example, the glass fibers may be present in an amount of greater than or equal to 0 wt % and less than or equal to 50 wt % of the total dry weight of the additional layer or the stand-alone layer.

When glass fibers are present in a pasting paper, a capacitance layer, a non-woven fiber web, an additional layer, or a stand-alone layer, the average fiber diameter of all of the glass fibers may be any suitable value. In other words, the average diameter of the glass fibers (e.g., the average diameter of fibers that are microglass fibers, chopped strand glass fibers, or any other type of glass fiber) in the pasting paper, the capacitance layer, the non-woven fiber web, the resinous layer, the additional layer, or the stand-alone layer may be selected as desired. The average fiber diameter of the glass fibers may be greater than or equal to 1 micron, greater than or equal to 2 microns, greater than or equal to 5 microns, greater than or equal to 10 microns, greater than or equal to 15 microns, greater than or equal to 20 microns, or greater than or equal to 25 microns. The average fiber diameter of the glass fibers may be less than or equal to 30 microns, less than or equal to 25 microns, less than or equal to 20 microns, less than or equal to 15 microns, less than or equal to 10 microns, less than or equal to 5 microns, or less than or equal to 2 microns. Combinations of the above-referenced ranges are also possible (e.g., greater than or equal to 1 micron and less than or equal to 30 microns, greater than or equal to 1 micron and less than or equal to 20 microns, or greater than or equal to 1 micron and less than or equal to 15 microns). Other ranges are also possible. One of ordinary skill in the art would be familiar with techniques that may be used to determine the average fiber diameter of glass fibers in a pasting paper, a capacitance layer, a non-woven fiber web, a resinous layer, an additional layer, or a stand-alone layer. Two examples of suitable techniques are transmission electron microscopy and scanning electron microscopy. Unless otherwise specified, references to an average fiber diameter of the glass fibers should be understood to refer to a number average diameter of the glass fibers.

When glass fibers are present in a pasting paper, a capacitance layer, a non-woven fiber web, a resinous layer, an additional layer, or a stand-alone layer, the average length of all of the glass fibers may be any suitable value. In other words, the average length of the glass fibers (e.g., the average length of fibers that are microglass fibers, chopped strand glass fibers, or any other type of glass fiber) in the pasting paper, the capacitance layer, the non-woven fiber web, the resinous layer, the additional layer, or the stand-alone layer may be selected as desired. The average length of the glass fibers may be greater than or equal to 0.1 mm, greater than or equal to 0.2 mm, greater than or equal to 0.5 mm, greater than or equal to 1 mm, greater than or equal to 2 mm, greater than or equal to 5 mm, greater than or equal to 10 mm, greater than or equal to 15 mm, or greater than or equal to 20 mm. The average length of the glass fibers may be less than or equal to 25 mm, less than or equal to 20 mm, less than or equal to 15 mm, less than or equal to 10 mm, less than or equal to 5 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 25 mm, greater than or equal to 0.1 mm and less than or equal to 25 mm, or greater than or equal to 0.2 mm and less than or equal to 15 mm). Other ranges are also possible.

In some embodiments, the glass fibers present in a pasting paper, a capacitance layer, a non-woven fiber web, a resinous layer, an additional layer, or a stand-alone layer may be microglass fibers and/or chopped strand glass fibers. Such pasting papers, capacitance layers, non-woven fiber webs, additional layers, or stand-alone layers may further comprise other, different, types of glass fibers.

In some embodiments, a plurality of glass fibers may comprise microglass fibers. In some embodiments, microglass fibers may be positioned in a non-woven fiber web (i.e., a non-woven fiber web may comprise a plurality of microglass fibers, such as a non-woven fiber web that is a pasting paper or a non-woven fiber web that is a capacitance layer), may be positioned in a resinous layer (i.e., a resinous layer may comprise a plurality of microglass fibers dispersed within a binder resin, such as a resinous layer comprising a binder resin with microglass fibers dispersed within the binder resin), may be positioned in an additional layer (e.g., a layer disposed on a non-woven fiber web may comprise a plurality of microglass fibers, an additional layer that is a capacitance layer may comprise a plurality of microglass fibers), and/or may be positioned in a stand-alone layer (e.g., a stand-alone layer that is a capacitance layer may comprise a plurality of microglass fibers).

When present in a non-woven fiber web or a pasting paper, the microglass fibers may make up greater than or equal to 0 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, or greater than or equal to 60 wt % of the non-woven fiber web or the pasting paper. When present in a non-woven fiber web or a pasting paper, the microglass fibers may make up less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 5 wt %, or less than or equal to 2 wt % of the non-woven fiber web or the pasting paper. Combinations of the above-referenced ranges are also possible (e.g., greater than or equal to 0 wt % and less than or equal to 70 wt % of the non-woven fiber web or the pasting paper, greater than or equal to 2 wt % and less than or equal to 70 wt % of the non-woven fiber web or the pasting paper, greater than or equal to 5 wt % and less than or equal to 50 wt % of the non-woven fiber web or the pasting paper, greater than or equal to 10 wt % and less than or equal to 50 wt % of the non-woven fiber web or the pasting paper, greater than or equal to 5 wt % and less than or equal to 40 wt % of the non-woven fiber web or the pasting paper, greater than or equal to 5 wt % and less than or equal to 20 wt % of the non-woven fiber web or the pasting paper, greater than or equal to 10 wt % and less than or equal to 25 wt % of the non-woven fiber web or the pasting paper, greater than or equal to 10 wt % and less than or equal to 15 wt % of the non-woven fiber web or the pasting paper, or greater than or equal to 20 wt % and less than or equal to 30 wt % of the non-woven fiber web or the pasting paper). In some embodiments, the pasting paper or the non-woven fiber web include 0 wt % microglass fibers. Other ranges are also possible. In some embodiments, the ranges above for weight percentage are based on the total weight of the non-woven fiber web or the pasting paper. For example, the microglass fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the microglass fibers may be present in an amount of greater than or equal to 2 wt % and less than or equal to 70 wt % of the total amount of fibers in the non-woven fiber web or the pasting paper.

In some embodiments, a pasting paper may comprise a non-woven fiber web with an amount of microglass fibers in one or more of the ranges described above with respect to the total weight of the non-woven fiber web, and/or may comprise a non-woven fiber web with an amount of microglass fibers in one or more of the ranges described above with respect to the total amount of fibers in the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising microglass fibers and an additional layer, and the pasting paper as a whole may have an amount of microglass fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise microglass fibers, and the pasting paper as a whole may have an amount of microglass fibers in one or more of the ranges described above with respect to the total weight of the pasting paper and/or in one or more of the ranges described above with respect to the total amount of the fibers in the pasting paper. In some embodiments, a stand-alone layer comprising microglass fibers is provided, such as a stand-alone layer that is a capacitance layer. In some embodiments, the additional layer or the stand-alone layer may be a resinous layer comprising a binder resin with the microglass fibers dispersed within the binder resin.

When present in an additional layer (e.g., a layer disposed on a non-woven fiber web, an additional layer that is a capacitance layer, an additional layer that is a non-woven fiber web comprising microglass fibers, an additional layer that is a resinous layer comprising a binder resin with microglass fibers dispersed within the binder resin) or a stand-alone layer (e.g., a stand-alone layer that is a capacitance layer, a stand-alone layer that is a non-woven fiber web comprising microglass fibers, a stand-alone layer that is a resinous layer comprising a binder resin with microglass fibers dispersed within the binder resin), the microglass fibers may make up any suitable amount of the additional layer or the stand-alone layer. The microglass fibers may make up greater than or equal to 0 wt %, greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, or greater than or equal to 40 wt % of the additional layer or the stand-alone layer. The microglass fibers may make up less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.5 wt %, less than or equal to 0.2 wt %, or less than or equal to 0.1 wt % of the additional layer or the stand-alone layer. Combinations of the above-referenced ranges are also possible (e.g., greater than or equal to 0 wt % and less than or equal to 50 wt %, greater than or equal to 0 wt % and less than or equal to 10 wt %, or greater than or equal to 1 wt % and less than or equal to 5 wt %). In some embodiments, the additional layer or the stand-alone layer includes 0 wt % microglass fibers. Other ranges are also possible. The ranges above for weight percentage are based on the total dry weight of the additional layer or the stand-alone layer. For example, the microglass fibers may be present in an amount of greater than or equal to 0 wt % and less than or equal to 50 wt % of the total dry weight of the additional layer or the stand-alone layer.

When present, a plurality of microglass fibers may comprise any suitable type(s) of microglass fibers. The plurality of microglass fibers may comprise microglass fibers drawn from bushing tips and further subjected to flame blowing or rotary spinning processes. In some cases, microglass fibers may be made using a remelting process. The plurality of microglass fibers may comprise microglass fibers for which alkali metal oxides (e.g., sodium oxides, magnesium oxides) make up 10-20 wt % of the fibers. Such fibers may have relatively lower melting and processing temperatures. Non-limiting examples of microglass fibers are M glass fibers according to Man Made Vitreous Fibers by Nomenclature Committee of TIMA Inc. March 1993, Page 45 and C glass fibers (e.g., Lauscha C glass fibers, JM 253 C glass fibers). It should be understood that a plurality of microglass fibers may comprise one or more of the types of microglass fibers described herein.

When present, the microglass fibers may have any suitable average fiber diameter. The average fiber diameter of the microglass fibers may be greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, or greater than or equal to 9 microns. The average fiber diameter of the microglass fibers may be less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, or less than or equal to 2 microns. Combinations of the above-referenced ranges are also possible (e.g., greater than or equal to 1 micron and less than or equal to 10 microns, greater than or equal to 1 micron and less than or equal to 5 microns, or greater than or equal to 1 micron and less than or equal to 2 microns). Other ranges are also possible. One of ordinary skill in the art would be familiar with techniques that may be used to determine the average fiber diameter of microglass fibers in a non-woven fiber web, resinous layer, pasting paper, capacitance layer, stand-alone layer, or additional layer. Two examples of suitable techniques are transmission electron microscopy and scanning electron microscopy. Unless otherwise specified, references to an average fiber diameter of the microglass fibers should be understood to refer to a number average diameter of the microglass fibers.

When present, the microglass fibers may have any suitable average length. The average length of the microglass fibers may be greater than or equal to 0.1 mm, greater than or equal to 0.2 mm, greater than or equal to 0.5 mm, greater than or equal to 0.7 mm, greater than or equal to 1 mm, greater than or equal to 1.2 mm, greater than or equal to 1.5 mm, or greater than or equal to 1.7 mm. The average length of the microglass fibers may be less than or equal to 2 mm, less than or equal to 1.7 mm, less than or equal to 1.5 mm, less than or equal to 1.2 mm, less than or equal to 1 mm, less than or equal to 0.7 mm, less than or equal to 0.5 mm, or less than or equal to 0.2 mm. Combinations of the above-referenced ranges are also possible (e.g., greater than or equal to 0.1 mm and less than or equal to 2 mm, greater than or equal to 0.1 mm and less than or equal to 1 mm, or greater than or equal to 0.1 mm and less than or equal to 0.7 mm). Other ranges are also possible.

In some embodiments, a pasting paper may comprise a plurality of glass fibers, and the plurality of glass fibers may comprise chopped strand glass fibers. In some embodiments, chopped strand glass fibers may be positioned in a non-woven fiber web (i.e., a non-woven fiber web may comprise a plurality of chopped strand glass fibers, such as a non-woven fiber web that is a pasting paper or a non-woven fiber web that is a capacitance layer), may be positioned in an additional layer (e.g., a layer disposed on a non-woven fiber web may comprise a plurality of chopped strand glass fibers, an additional layer that is a capacitance layer may comprise a plurality of chopped strand glass fibers), may be positioned in a resinous layer (i.e., a resinous layer may comprise a plurality of glass fibers dispersed within a binder resin, such as a resinous layer comprising a binder resin with glass fibers dispersed within the binder resin), and/or may be positioned in a stand-alone layer (e.g., a stand-alone layer that is a capacitance layer may comprise a plurality of chopped glass fibers). Such pasting papers, non-woven fiber webs, additional layers, or stand-alone layers may further comprise other, different, types of glass fibers.

When the chopped strand glass fibers are present in a non-woven fiber web or a pasting paper, they may make up greater than or equal to 0 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, or greater than or equal to 60 wt % of the non-woven fiber web or the pasting paper. When present in a non-woven fiber web or a pasting paper, the chopped strand glass fibers may make up less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 5 wt %, or less than or equal to 2 wt % of the non-woven fiber web or the pasting paper. Combinations of the above-referenced ranges are also possible (e.g., greater than or equal to 0 wt % and less than or equal to 70 wt % of the non-woven fiber web or the pasting paper, greater than or equal to 2 wt % and less than or equal to 70 wt % of the non-woven fiber web or the pasting paper, greater than or equal to 5 wt % and less than or equal to 50 wt % of the non-woven fiber web or the pasting paper, greater than or equal to 10 wt % and less than or equal to 50 wt % of the non-woven fiber web or the pasting paper, greater than or equal to 5 wt % and less than or equal to 40 wt % of the non-woven fiber web or the pasting paper, greater than or equal to 5 wt % and less than or equal to 20 wt % of the non-woven fiber web or the pasting paper, greater than or equal to 10 wt % and less than or equal to 25 wt % of the non-woven fiber web or the pasting paper, greater than or equal to 10 wt % and less than or equal to 15 wt % of the non-woven fiber web or the pasting paper, or greater than or equal to 20 wt % and less than or equal to 30 wt % of the non-woven fiber web or the pasting paper). In some embodiments, the pasting paper or the non-woven fiber web include 0 wt % chopped strand glass fibers. Other ranges are also possible. In some embodiments, the ranges above for weight percentage are based on the total weight of the non-woven fiber web or the pasting paper. For example, the chopped strand glass fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the chopped strand glass fibers may be present in an amount of greater than or equal to 2 wt % and less than or equal to 70 wt % of the total amount of fibers in the non-woven fiber web or the pasting paper.

In some embodiments, a pasting paper may comprise a non-woven fiber web with an amount of chopped strand glass fibers in one or more of the ranges described above with respect to the total weight of the non-woven fiber web, and/or may comprise a non-woven fiber web with an amount of chopped strand glass fibers in one or more of the ranges described above with respect to the total amount of fibers in the non-woven fiber web. Such pasting papers may further comprise an additional layer, such as a layer disposed on the non-woven fiber web and/or an additional layer that is a capacitance layer. In some embodiments, a pasting paper may comprise a non-woven fiber web comprising chopped strand glass fibers and an additional layer, and the pasting paper as a whole may have an amount of chopped strand glass fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise chopped strand glass fibers, and the pasting paper as a whole may have an amount of chopped strand glass fibers in one or more of the ranges described above with respect to the total weight of the pasting paper and/or in one or more of the ranges described above with respect to the total amount of the fibers in the pasting paper. In some embodiments, a stand-alone layer comprising chopped strand glass fibers is provided, such as a stand-alone layer that is a capacitance layer. In some embodiments, the additional layer or the stand-alone layer may be a resinous layer comprising a binder resin with the chopped strand glass fibers dispersed within the binder resin.

When present in an additional layer (e.g., a layer disposed on a non-woven fiber web, an additional layer that is a capacitance layer, an additional layer that is a non-woven fiber web comprising chopped strand glass fibers, an additional layer that is a resinous layer comprising a binder resin with chopped strand glass fibers dispersed within the binder resin) or a stand-alone layer (e.g., a stand-alone layer that is a capacitance layer, a stand-alone layer that is a non-woven fiber web comprising chopped strand glass fibers, a stand-alone layer that is a resinous layer comprising a binder resin with chopped strand glass fibers dispersed within the binder resin), the chopped strand glass fibers may make up any suitable amount of the additional layer or the stand-alone layer. The chopped strand glass fibers may make up greater than or equal to 0 wt %, greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, or greater than or equal to 40 wt % of the additional layer or the stand-alone layer. The chopped strand glass fibers may make up less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.5 wt %, less than or equal to 0.2 wt %, or less than or equal to 0.1 wt % of the additional layer or the stand-alone layer. Combinations of the above-referenced ranges are also possible (e.g., greater than or equal to 0 wt % and less than or equal to 50 wt %, greater than or equal to 0 wt % and less than or equal to 10 wt %, or greater than or equal to 1 wt % and less than or equal to 5 wt %). In some embodiments, the additional layer or the stand-alone layer includes 0 wt % chopped strand glass fibers. Other ranges are also possible. The ranges above for weight percentage are based on the total dry weight of the additional layer or the stand-alone layer. For example, the chopped strand glass fibers may be present in an amount of greater than or equal to 0 wt % and less than or equal to 50 wt % of the total dry weight of the additional layer or the stand-alone layer.

When present, a plurality of chopped strand glass fibers may comprise any suitable type(s) of chopped strand glass fibers. The plurality of chopped strand glass fibers may comprise chopped strand glass fibers which were produced by drawing a melt of glass from bushing tips into continuous fibers and then cutting the continuous fibers into short fibers. The plurality of chopped strand glass fibers may comprise chopped strand glass fibers for which alkali metal oxides (e.g., sodium oxides, magnesium oxides) make up a relatively low amount of the fibers. In some embodiments, chopped strand glass fibers may include relatively large amounts of calcium oxide and/or alumina (Al₂O₃). It should be understood that a plurality of chopped strand glass fibers may comprise one or more of the types of chopped strand glass fibers described herein.

When present, the chopped strand glass fibers may have any suitable average fiber diameter. The average fiber diameter of the chopped strand glass fibers may be greater than or equal to 5 microns, greater than or equal to 7 microns, greater than or equal to 10 microns, greater than or equal to 12 microns, greater than or equal to 15 microns, greater than or equal to 17 microns, greater than or equal to 20 microns, greater than or equal to 22 microns, greater than or equal to 25 microns, or greater than or equal to 27 microns. The average fiber diameter of the chopped strand glass fibers may be less than or equal to 30 microns, less than or equal to 27 microns, less than or equal to 25 microns, less than or equal to 22 microns, less than or equal to 20 microns, less than or equal to 17 microns, less than or equal to 15 microns, less than or equal to 12 microns, less than or equal to 10 microns, or less than or equal to 7 microns. Combinations of the above-referenced ranges are also possible (e.g., greater than or equal to 5 microns and less than or equal to 30 microns, greater than or equal to 10 microns and less than or equal to 30 microns, greater than or equal to 10 microns and less than or equal to 20 microns, or greater than or equal to 10 microns and less than or equal to 15 microns). Other ranges are also possible. One of ordinary skill in the art would be familiar with techniques that may be used to determine the average fiber diameter of chopped strand glass fibers in a pasting paper, a non-woven fiber web, a resinous layer, a capacitance layer, a stand-alone layer, or an additional layer. Two examples of suitable techniques are transmission electron microscopy and scanning electron microscopy. Unless otherwise specified, references to an average fiber diameter of the chopped strand glass fibers should be understood to refer to a number average diameter of the chopped strand glass fibers.

When present, the chopped strand glass fibers may have any suitable average length. The average length of the chopped strand glass fibers may be greater than or equal to 2 mm, greater than or equal to 4 mm, greater than or equal to 5 mm, greater than or equal to 10 mm, greater than or equal to 15 mm, or greater than or equal to 20 mm. The average length of the chopped strand glass fibers may be less than or equal to 25 mm, less than or equal to 20 mm, less than or equal to 15 mm, less than or equal to 10 mm, less than or equal to 5 mm, or less than or equal to 4 mm. Combinations of the above-referenced ranges are also possible (e.g., greater than or equal to 2 mm and less than or equal to 25 mm, greater than or equal to 4 mm and less than or equal to 20 mm, or greater than or equal to 5 mm and less than or equal to 15 mm). Other ranges are also possible.

As described above, in some embodiments, a pasting paper or a capacitance layer may comprise a non-woven fiber web comprising a plurality of synthetic fibers. In some embodiments, synthetic fibers may be positioned in a non-woven fiber web (i.e., a non-woven fiber web may comprise a plurality of synthetic fibers, such as a non-woven fiber web that is a pasting paper or a non-woven fiber web that is a capacitance layer), may be positioned in a resinous layer (i.e., a resinous layer may comprise a plurality of synthetic fibers dispersed within a binder resin, such as a resinous layer comprising a binder resin with synthetic fibers dispersed within the binder resin), may be positioned in an additional layer (e.g., a layer disposed on a non-woven fiber web may comprise a plurality of synthetic fibers, an additional layer that is a capacitance layer may comprise a plurality of synthetic fibers), and/or may be positioned in a stand-alone layer (e.g., a stand-alone layer that is a capacitance layer may comprise a plurality of synthetic fibers).

When present in a non-woven fiber web or a pasting paper, the synthetic fibers may make up any suitable amount of the non-woven fiber web or the pasting paper. The synthetic fibers may make up greater than or equal to 1 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 60 wt % of the non-woven fiber web or the pasting paper. The synthetic fibers may make up less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, or less than or equal to 2 wt % of the non-woven fiber web or the pasting paper. Combinations of the above-referenced ranges are also possible (e.g., greater than or equal to 1 wt % and less than or equal to 70 wt % of the non-woven fiber web or the pasting paper, or greater than or equal to 10 wt % and less than or equal to 30 wt % of the non-woven fiber web or the pasting paper). Other ranges are also possible. In some embodiments, the ranges above for weight percentage are based on the total weight of the non-woven fiber web or the pasting paper. For example, the synthetic fibers may be present in an amount of greater than or equal to 1 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the synthetic fibers may be present in an amount of greater than or equal to 1 wt % and less than or equal to 70 wt % of the total amount of fibers in the non-woven fiber web or the pasting paper.

In some embodiments, a pasting paper may comprise a non-woven fiber web with an amount of synthetic fibers in one or more of the ranges described above with respect to the total weight of the non-woven fiber web, and/or may comprise a non-woven fiber web with an amount of synthetic fibers in one or more of the ranges described above with respect to the total amount of fibers in the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising synthetic fibers and an additional layer, and the pasting paper as a whole may have an amount of synthetic fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise synthetic fibers, and the pasting paper as a whole may have an amount of synthetic fibers in one or more of the ranges described above with respect to the total weight of the pasting paper and/or in one or more of the ranges described above with respect to the total amount of the fibers in the pasting paper. In some embodiments, a stand-alone layer comprising synthetic fibers is provided, such as a stand-alone layer that is a capacitance layer. In some embodiments, the additional layer or the stand-alone layer may be a resinous layer comprising a binder resin with the synthetic fibers dispersed within the binder resin.

When present in an additional layer (e.g., a layer disposed on a non-woven fiber web, an additional layer that is a capacitance layer, an additional layer that is a non-woven fiber web comprising synthetic fibers, an additional layer that is a resinous layer comprising a binder resin with synthetic fibers dispersed within the binder resin) or a stand-alone layer (e.g., a stand-alone layer that is a capacitance layer, a stand-alone layer that is a non-woven fiber web comprising synthetic fibers, a stand-alone layer that is a resinous layer comprising a binder resin with synthetic fibers dispersed within the binder resin), the synthetic fibers may make up any suitable amount of the additional layer or the stand-alone layer. The synthetic fibers may make up greater than or equal to 0 wt %, greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, or greater than or equal to 40 wt % of the additional layer or the stand-alone layer. The synthetic fibers may make up less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.5 wt %, less than or equal to 0.2 wt %, or less than or equal to 0.1 wt % of the additional layer or the stand-alone layer. Combinations of the above-referenced ranges are also possible (e.g., greater than or equal to 0 wt % and less than or equal to 20 wt % of the additional layer or the stand-alone layer, or greater than or equal to 1 wt % and less than or equal to 10 wt % of the additional layer or the stand-alone layer). In some embodiments, the additional layer or the stand-alone layer include 0 wt % synthetic fibers. Other ranges are also possible. The ranges above for weight percentage are based on the total dry weight of the additional layer or the stand-alone layer. For example, the synthetic fibers may be present in an amount of greater than or equal to 0 wt % and less than or equal to 50 wt % of the total dry weight of the additional layer or the stand-alone layer.

When synthetic fibers are present in a pasting paper, a capacitance layer, a resinous layer, a non-woven fiber web, an additional layer, or a stand-alone layer, the average diameter of all of the synthetic fibers may be any suitable value. In other words, the average diameter of the synthetic fibers (e.g., the average diameter of fibers that are monocomponent synthetic fibers, multicomponent fibers, or any other type of synthetic fiber) in the pasting paper, the capacitance layer, the non-woven fiber web, the resinous layer, or the additional layer may be selected as desired. The average fiber diameter of the synthetic fibers may be greater than or equal to 1 micron, greater than or equal to 2 microns, greater than or equal to 5 microns, greater than or equal to 10 microns, greater than or equal to 15 microns, greater than or equal to 20 microns, or greater than or equal to 25 microns. The average fiber diameter of the synthetic fibers may be less than or equal to 30 microns, less than or equal to 25 microns, less than or equal to 20 microns, less than or equal to 15 microns, less than or equal to 10 microns, less than or equal to 5 microns, or less than or equal to 2 microns. Combinations of the above-referenced ranges are also possible (e.g., greater than or equal to 1 micron and less than or equal to 30 microns, greater than or equal to 5 microns and less than or equal to 20 microns, or greater than or equal to 10 microns and less than or equal to 15 microns). Other ranges are also possible. One of ordinary skill in the art would be familiar with techniques that may be used to determine the average fiber diameter of synthetic fibers in a pasting paper, a capacitance layer, a non-woven fiber web, a resinous layer, an additional layer, or a stand-alone layer. Two examples of suitable techniques are transmission electron microscopy and scanning electron microscopy. Unless otherwise specified, references to an average fiber diameter of the synthetic fibers should be understood to refer to a number average diameter of the synthetic fibers.

When synthetic fibers are present in a pasting paper, a capacitance layer, a non-woven fiber web, a resinous layer, an additional layer, or a stand-alone layer, the average length of all of the synthetic fibers may be any suitable value. In other words, the average length of the synthetic fibers (e.g., the average length of fibers that are monocomponent synthetic fibers, multicomponent fibers, or any other type of synthetic fiber) in the pasting paper, the capacitance layer, the non-woven fiber web, the resinous layer, the additional layer, or the stand-alone layer may be selected as desired. The average length of the synthetic fibers may be greater than or equal to 2 mm, greater than or equal to 4 mm, greater than or equal to 5 mm, greater than or equal to 10 mm, greater than or equal to 15 mm, or greater than or equal to 20 mm. The average length of the synthetic fibers may be less than or equal to 25 mm, less than or equal to 20 mm, less than or equal to 15 mm, less than or equal to 10 mm, less than or equal to 5 mm, less than or equal to 4 mm, or less than or equal to 2 mm. Combinations of the above-referenced ranges are also possible (e.g., greater than or equal to 2 mm and less than or equal to 25 mm, greater than or equal to 4 mm and less than or equal to 20 mm, or greater than or equal to 5 mm and less than or equal to 15 mm). Other ranges are also possible.

When present, the plurality of synthetic fibers may comprise any suitable types of synthetic fibers. The synthetic fibers may include polyolefins such as poly(ethylene) (PE), poly(propylene) (PP), and poly(butylene); polyesters and/or co-polyesters such as poly(ethylene terephthalate) (PET) and poly(butylene terephthalate) (PBT); polyamides such as nylons and aramids; and halogenated polymers such as polytetrafluoroethylene. It should be understood that a plurality of synthetic fibers may comprise one or more of the types of synthetic fibers described herein.

In some embodiments, the plurality of synthetic fibers includes monocomponent fibers. It should be understood that monocomponent synthetic fibers may make up any of the amounts of the pasting paper, the capacitance layer, the non-woven fiber web, the resinous layer, the additional layer, or the stand-alone layer described above with respect to synthetic fibers (e.g., the monocomponent synthetic fibers may make up greater than or equal to 1 wt % and less than or equal to 70 wt % of the non-woven fiber web or the pasting paper based on the total weight of the non-woven fiber web or the pasting paper, the monocomponent synthetic fibers may make up greater than or equal to 1 wt % and less than or equal to 70 wt % of the non-woven fiber web or the pasting paper based on the total amount of fibers in the non-woven fiber web or the pasting paper, the monocomponent synthetic fibers may make up greater than or equal to 0 wt % and less than or equal to 50 wt % of the total dry weight of the capacitance layer, the additional layer or the stand-alone layer). Similarly, a plurality of monocomponent synthetic fibers in a pasting paper, a capacitance layer, a non-woven fiber web, a resinous layer, an additional layer, or a stand-alone layer may have an average diameter in one or more of the ranges listed above with respect to synthetic fibers (e.g., greater than or equal to 1 micron and less than or equal to 30 microns, greater than or equal to 5 microns and less than or equal to 20 microns, or greater than or equal to 10 microns and less than or equal to 15 microns) and/or a length in one or more of the ranges listed above with respect to synthetic fibers (e.g., greater than or equal to 2 mm and less than or equal to 25 mm, greater than or equal to 4 mm and less than or equal to 20 mm, or greater than or equal to 5 mm and less than or equal to 15 mm).

As described above, in some embodiments, a pasting paper or a capacitance layer may comprise a non-woven fiber web comprising a plurality of multicomponent fibers (e.g., synthetic fibers that are multicomponent fibers). In some embodiments, multicomponent fibers may be positioned in a non-woven fiber web (i.e., a non-woven fiber web may comprise a plurality of multicomponent fibers, such as a non-woven fiber web that is a pasting paper or a non-woven fiber web that is a capacitance layer), may be positioned in a resinous layer (i.e., a resinous layer may comprise a plurality of multicomponent fibers dispersed within a binder resin, such as a resinous layer comprising a binder resin with multicomponent fibers dispersed within the binder resin), may be positioned in an additional layer (e.g., a layer disposed on a non-woven fiber web may comprise a plurality of multicomponent fibers, an additional layer that is a capacitance layer may comprise a plurality of multicomponent fibers), and/or may be positioned in a stand-alone layer (e.g., a stand-alone layer that is a capacitance layer may comprise a plurality of multicomponent fibers).

When present in a non-woven fiber web or a pasting paper, the multicomponent fibers may make up any suitable amount of the non-woven fiber web or the pasting paper. The multicomponent fibers may make up greater than or equal to 1 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 60 wt % of the non-woven fiber web or the pasting paper. The multicomponent fibers may make up less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, or less than or equal to 2 wt % of the non-woven fiber web or the pasting paper. Combinations of the above-referenced ranges are also possible (e.g., greater than or equal to 1 wt % and less than or equal to 70 wt % of the non-woven fiber web or the pasting paper, greater than or equal to 2 wt % and less than or equal to 70 wt % of the non-woven fiber web or the pasting paper, greater than or equal to 10 wt % and less than or equal to 50 wt % of the non-woven fiber web or the pasting paper, greater than or equal to 10 wt % and less than or equal to 30 wt % of the non-woven fiber web or the pasting paper, or greater than or equal to 25 wt % and less than or equal to 45 wt % of the non-woven fiber web or the pasting paper). Other ranges are also possible. In some embodiments, the ranges above for weight percentage are based on the total weight of the non-woven fiber web or the pasting paper. For example, the multicomponent fibers may be present in an amount of greater than or equal to 2 wt % and less than or equal to 70 wt % of the total weight of the non-woven fiber web or the pasting paper. In some embodiments, the ranges above for weight percentage are based on the total amount of fibers in the non-woven fiber web or the pasting paper. For example, the multicomponent fibers may be present in an amount of greater than or equal to 2 wt % and less than or equal to 70 wt % of the total amount of fibers in the non-woven fiber web or the pasting paper.

In some embodiments, a pasting paper may comprise a non-woven fiber web with an amount of multicomponent fibers in one or more of the ranges described above with respect to the total weight of the non-woven fiber web, and/or may comprise a non-woven fiber web with an amount of multicomponent fibers in one or more of the ranges described above with respect to the total amount of fibers in the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising multicomponent fibers and an additional layer, and the pasting paper as a whole may have an amount of multicomponent fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise multicomponent fibers, and the pasting paper as a whole may have an amount of multicomponent fibers in one or more of the ranges described above with respect to the total weight of the pasting paper and/or in one or more of the ranges described above with respect to the total amount of the fibers in the pasting paper. In some embodiments, a stand-alone layer comprising multicomponent fibers is provided, such as a stand-alone layer that is a capacitance layer. In some embodiments, the additional layer or the stand-alone layer may be a resinous layer comprising a binder resin with the multicomponent fibers dispersed within the binder resin.

When present in an additional layer (e.g., a layer disposed on a non-woven fiber web, an additional layer that is a capacitance layer, an additional layer that is a non-woven fiber web comprising multicomponent fibers, an additional layer that is a resinous layer comprising a binder resin with multicomponent fibers dispersed within the binder resin) or a stand-alone layer (e.g., a stand-alone layer that is a capacitance layer, a stand-alone layer that is a non-woven fiber web comprising multicomponent fibers, a stand-alone layer that is a resinous layer comprising a binder resin with multicomponent fibers dispersed within the binder resin), the multicomponent fibers may make up any suitable amount of the additional layer or the stand-alone layer. The multicomponent fibers may make up greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, or greater than or equal to 40 wt % of the additional layer or the stand-alone layer. The multicomponent fibers may make up less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.5 wt %, or less than or equal to 0.2 wt % of the additional layer or the stand-alone layer. Combinations of the above-referenced ranges are also possible (e.g., greater than or equal to 0.1 wt % and less than or equal to 50 wt % of the additional layer or the stand-alone layer, greater than or equal to 0.5 wt % and less than or equal to 40 wt % of the additional layer or the stand-alone layer, or greater than or equal to 1 wt % and less than or equal to 10 wt % of the additional layer or the stand-alone layer). In some embodiments, the additional layer or the stand-alone layer include 0 wt % multicomponent fibers. Other ranges are also possible. The ranges above for weight percentage are based on the total dry weight of the additional layer or the stand-alone layer. For example, the multicomponent fibers may be present in an amount of greater than or equal to 0.1 wt % and less than or equal to 50 wt % of the total dry weight of the additional layer or the stand-alone layer.

It should be understood that a plurality of multicomponent synthetic fibers in a pasting paper, a capacitance layer, a non-woven fiber web, a resinous layer, an additional layer, or a stand-alone layer may have an average diameter in one or more of the ranges listed above with respect to synthetic fibers (e.g., greater than or equal to 1 micron and less than or equal to 30 microns, greater than or equal to 5 microns and less than or equal to 20 microns, or greater than or equal to 10 microns and less than or equal to 15 microns) and/or a length in one or more of the ranges listed above with respect to synthetic fibers (e.g., greater than or equal to 2 mm and less than or equal to 25 mm, greater than or equal to 4 mm and less than or equal to 20 mm, or greater than or equal to 5 mm and less than or equal to 15 mm).

When present, the plurality of multicomponent fibers may comprise any suitable types of multicomponent fibers. The multicomponent fibers may include more than one component in each fiber. Non-limiting examples of suitable components that may be present in multicomponent fibers include polyolefins such as PE, PP, and poly(butylene); polyesters and/or co-polyesters such as PET and PBT; polyamides such as nylons and aramids; and halogenated polymers such as polytetrafluoroethylene. It should be understood that a plurality of multicomponent fibers may comprise one or more of the types of multicomponent fibers described herein.

In some embodiments, a plurality of multicomponent fibers may comprise bicomponent fibers. It should be understood that bicomponent fibers may make any of the amounts of the pasting paper, the capacitance layer, the non-woven fiber web, the resinous layer, the additional layer, or the stand-alone layer described above with respect to multicomponent fibers (e.g., the bicomponent fibers may make up greater than or equal to 2 wt % and less than or equal to 70 wt % of the non-woven fiber web or the pasting paper based on the total weight of the non-woven fiber web or the pasting paper, the bicomponent fibers may make up greater than or equal to 2 wt % and less than or equal to 70 wt % of the non-woven fiber web or the pasting paper based on the total amount of fibers in the non-woven fiber web or the pasting paper, the bicomponent fibers may make up greater than or equal to 0.1 wt % and less than or equal to 50 wt % of the total dry weight of the capacitance layer, the additional layer, or the stand-alone layer). Similarly, a plurality of bicomponent synthetic fibers in a pasting paper, a capacitance layer, a non-woven fiber web, a resinous layer, an additional layer, or a stand-alone layer may have an average diameter in one or more of the ranges listed above with respect to synthetic fibers (e.g., greater than or equal to 1 micron and less than or equal to 30 microns, greater than or equal to 5 microns and less than or equal to 20 microns, or greater than or equal to 10 microns and less than or equal to 15 microns) and/or a length in one or more of the ranges listed above with respect to synthetic fibers (e.g., greater than or equal to 2 mm and less than or equal to 25 mm, greater than or equal to 4 mm and less than or equal to 20 mm, or greater than or equal to 5 mm and less than or equal to 15 mm).

When present, the bicomponent fibers may have any suitable structure, such as core/sheath (e.g., concentric core/sheath, non-concentric core-sheath), split fibers, side-by-side fibers, and “island in the sea” fibers. When core-sheath bicomponent fibers are present, the sheath may have a lower melting temperature than the core. When heated, the sheath may melt prior to the core, binding other fibers within a non-woven fiber web or pasting paper together while the core remains solid. Non-limiting examples of suitable bicomponent fibers, in which the component with the lower melting temperature is listed first and the component with the higher melting temperature is listed second, include the following: PE/PET, PP/PET, co-PET/PET, PBT/PET, co-polyamide/polyamide, and PE/PP. It should be understood that a plurality of bicomponent fibers may comprise one or more of the types of bicomponent fibers described herein.

As described above, in some embodiments, a pasting paper or a capacitance layer may comprise a non-woven fiber web comprising a plurality of cellulose fibers. In some embodiments, cellulose fibers may be positioned in a non-woven fiber web (i.e., a non-woven fiber web may comprise a plurality of cellulose fibers, such as a non-woven fiber web that is a pasting paper or a non-woven fiber web that is a capacitance layer), may be positioned in a resinous layer (i.e., a resinous layer may comprise a plurality of cellulose fibers dispersed within a binder resin, such as a resinous layer comprising a binder resin with cellulose fibers dispersed within the binder resin), may be positioned in an additional layer (e.g., a layer disposed on a non-woven fiber web may comprise a plurality of cellulose fibers, an additional layer that is a capacitance layer may comprise a plurality of cellulose fibers), and/or may be positioned in a stand-alone layer (e.g., a stand-alone layer that is a capacitance layer may comprise a plurality of cellulose fibers). The cellulose fibers may be soluble in some electrolytes (e.g., sulfuric acid, such as 1.28 spg sulfuric acid), and may at least partially dissolve in an electrolyte to which the pasting paper is exposed during and/or after battery fabrication.

When present in a non-woven fiber web or a pasting paper, the cellulose fibers may make up any suitable amount of the non-woven fiber web or the pasting paper. The cellulose fibers may make up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of the non-woven fiber web or the pasting paper. The cellulose fibers may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, or less than or equal to 15 wt % of the non-woven fiber web or the pasting paper. Combinations of the above-referenced ranges are also possible (e.g., greater than or equal to 10 wt % and less than or equal to 95 wt % of the non-woven fiber web or the pasting paper, greater than or equal to 20 wt % and less than or equal to 80 wt % of the non-woven fiber web or the pasting paper, or greater than or equal to 25 wt % and less than or equal to 55 wt % of the non-woven fiber web or the pasting paper). Other ranges are also possible. In some embodiments, the ranges above for weight percentage are based on the total weight of the non-woven fiber web or the pasting paper. For example, the cellulose fibers may be present in an amount of greater than or equal to 10 wt % and less than or equal to 95 wt % of the total weight of the non-woven fiber web or the pasting paper. In some embodiments, the ranges above for weight percentage are based on the total amount of fibers in the non-woven fiber web or the pasting paper. For example, the cellulose fibers may be present in an amount of greater than or equal to 10 wt % and less than or equal to 95 wt % of the total amount of fibers in the non-woven fiber web or the pasting paper.

In some embodiments, a pasting paper may comprise a non-woven fiber web with an amount of cellulose fibers in one or more of the ranges described above with respect to the total weight of the non-woven fiber web, and/or may comprise a non-woven fiber web with an amount of cellulose fibers in one or more of the ranges described above with respect to the total amount of fibers in the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising cellulose fibers and an additional layer, and the pasting paper as a whole may have an amount of cellulose fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise cellulose fibers, and the pasting paper as a whole may have an amount of cellulose fibers in one or more of the ranges described above with respect to the total weight of the pasting paper and/or in one or more of the ranges described above with respect to the total amount of the fibers in the pasting paper. In some embodiments, a stand-alone layer comprising cellulose fibers is provided, such as a stand-alone layer that is a capacitance layer. In some embodiments, the additional layer or the stand-alone layer may be a resinous layer comprising a binder resin with the cellulose fibers dispersed within the binder resin.

When present in an additional layer (e.g., a layer disposed on a non-woven fiber web, an additional layer that is a capacitance layer, an additional layer that is a non-woven fiber web comprising cellulose fibers, an additional layer that is a resinous layer comprising a binder resin with cellulose fibers dispersed within the binder resin) or a stand-alone layer (e.g., a stand-alone layer that is a capacitance layer, a stand-alone layer that is a non-woven fiber web comprising cellulose fibers, a stand-alone layer that is a resinous layer comprising a binder resin with cellulose fibers dispersed within the binder resin, the cellulose fibers may make up any suitable amount of the additional layer or the stand-alone layer. The cellulose fibers may make up greater than or equal to 0 wt %, greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 7 wt %, greater than or equal to 8 wt %, greater than or equal to 10 wt %, greater than or equal to 20 wt %, greater than or equal to 30 wt %, or greater than or equal to 40 wt % of additional layer or the stand-alone layer. The cellulose fibers may make up less than or equal to 50 wt %, less than or equal to 40 wt %, less than or equal to 30 wt %, less than or equal to 20 wt %, less than or equal to 10 wt %, less than or equal to 8 wt %, less than or equal to 7 wt %, less than or equal to 5 wt %, less than or equal to 2 wt %, less than or equal to 1 wt %, less than or equal to 0.2 wt %, less than or equal to 0.5 wt %, less than or equal to 0.2 wt %, or less than or equal to 0.1 wt % of the additional layer or the stand-alone layer. Combinations of the above-referenced ranges are also possible (e.g., greater than or equal to 0 wt % and less than or equal to 50 wt % of the additional layer or the stand-alone layer, greater than or equal to 0 wt % and less than or equal to 20 wt % of the additional layer or the stand-alone layer, greater than or equal to 0.1 wt % and less than or equal to 50 wt % of the additional layer or the stand-alone layer, greater than or equal to 0.5 wt % and less than or equal to 40 wt % of the additional layer or the stand-alone layer, greater than or equal to 1 wt % and less than or equal to 10 wt % of the additional layer or the stand-alone layer, or greater than or equal to 7 wt % and less than or equal to 8 wt % of the additional layer or the stand-alone layer). In some embodiments, the additional layer or the stand-alone layer include 0 wt % cellulose fibers. Other ranges are also possible. The ranges above for weight percentage are based on the total dry weight of the additional layer or the stand-alone layer. For example, the cellulose fibers may be present in an amount of greater than or equal to 0.1 wt % and less than or equal to 50 wt % of the total dry weight of the additional layer or the stand-alone layer.

When present, the cellulose fibers may comprise any suitable types of cellulose. In some embodiments, the cellulose fibers may comprise natural cellulose fibers, such as cellulose wood (e.g., cedar), softwood fibers, and/or hardwood fibers. Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga. It should be understood that a plurality of cellulose fibers may comprise one or more of the types of natural cellulose fibers described herein.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”). It should be understood that a plurality of cellulose fibers may comprise one or more of the types of hardwood fibers described herein.

In some embodiments, a pasting paper may comprise a non-woven fiber web comprising cellulose fibers other than natural cellulose fibers and/or may comprise an additional layer comprising cellulose fibers other than natural cellulose fibers. In some embodiments, a capacitance layer or a stand-alone layer may comprise cellulose fibers other than natural cellulose fibers. As an example, the cellulose fibers may comprise regenerated and/or synthetic cellulose such as lyocell, rayon, and celluloid. As another example, the cellulose fibers comprise natural cellulose derivatives, such as cellulose acetate and carboxymethylcellulose. It should be understood that a plurality of cellulose fibers may comprise one or more of the types of other than natural cellulose fibers described herein.

The cellulose fibers, when present, may comprise fibrillated cellulose fibers, and/or may comprise unfibrillated cellulose fibers.

When present, the cellulose fibers may have any suitable average fiber diameter. The average fiber diameter of the cellulose fibers may be greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, or greater than or equal to 70 microns. The average fiber diameter of the cellulose fibers may be less than or equal to 75 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 5 microns, less than or equal to 2 microns, less than or equal to 1 micron, less than or equal to 0.5 microns, or less than or equal to 0.2 microns. Combinations of the above-referenced ranges are also possible (e.g., greater than or equal to 0.1 micron and less than or equal to 75 microns, greater than or equal to 1 micron and less than or equal to 40 microns, or greater than or equal to 10 microns and less than or equal to 30 microns). Other ranges are also possible. One of ordinary skill in the art would be familiar with techniques that may be used to determine the average fiber diameter of cellulose fibers in a pasting paper, a capacitance layer, a non-woven fiber web, an additional layer, a resinous layer, or a stand-alone layer. Two examples of suitable techniques are transmission electron microscopy and scanning electron microscopy. Unless otherwise specified, references to an average fiber diameter of the cellulose fibers should be understood to refer to a number average diameter of the cellulose fibers.

When present, the cellulose fibers may have any suitable average length. The average length of the cellulose fibers may be 0.1 mm, greater than or equal to 0.2 mm, greater than or equal to 0.5 mm, greater than or equal to 1 mm, greater than or equal to 2 mm, greater than or equal to 5 mm, greater than or equal to 10 mm, greater than or equal to 15 mm, or greater than or equal to 20 mm. The average length of the cellulose fibers may be less than or equal to 25 mm, less than or equal to 20 mm, less than or equal to 15 mm, less than or equal to 10 mm, less than or equal to 5 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 25 mm, greater than or equal to 1 mm and less than or equal to 10 mm, or greater than or equal to 2 mm and less than or equal to 5 mm). Other ranges are also possible.

When present, the cellulose fibers may have any suitable Canadian Standard Freeness. The Canadian Standard Freeness of the cellulose fibers may be selected to provide a desired pore size and/or air permeability for the pasting paper, the capacitance layer, the non-woven fiber web, the resinous layer, the additional layer, and/or the stand-alone layer. In general, lower values of Canadian Standard Freeness are correlated with smaller pore sizes and lower air permeabilities of the pasting paper, capacitance layer, non-woven fiber web, resinous layer, additional layer, or stand-alone layer comprising the cellulose fibers, and higher values of Canadian Standard Freeness are correlated with larger pore sizes and higher air permeabilities of the pasting paper, capacitance layer, non-woven fiber web, resinous layer, additional layer, or stand-alone layer comprising the cellulose fibers. The Canadian Standard Freeness of the cellulose fibers may be greater than or equal to 45 CSF, greater than or equal to 100 CSF, greater than or equal to 150 CSF, greater than or equal to 200 CSF, greater than or equal to 250 CSF, greater than or equal to 300 CSF, greater than or equal to 350 CSF, greater than or equal to 400 CSF, greater than or equal to 450 CSF, greater than or equal to 500 CSF, greater than or equal to 550 CSF, greater than or equal to 600 CSF, greater than or equal to 650 CSF, greater than or equal to 700 CSF, or greater than or equal to 750 CSF. The Canadian Standard Freeness of the cellulose fibers may be less than or equal to 800 CSF, less than or equal to 750 CSF, less than or equal to 700 CSF, less than or equal to 650 CSF, less than or equal to 600 CSF, less than or equal to 550 CSF, less than or equal to 500 CSF, less than or equal to 450 CSF, less than or equal to 400 CSF, less than or equal to 350 CSF, less than or equal to 300 CSF, less than or equal to 250 CSF, less than or equal to 200 CSF, less than or equal to 150 CSF, or less than or equal to 100 CSF. Combinations of the above-referenced ranges also apply (e.g., greater than or equal to 45 CSF and less than or equal to 800 CSF, greater than or equal to 300 CSF and less than or equal to 700 CSF, or greater than or equal to 550 CSF and less than or equal to 650 CSF). Other ranges are also possible. The Canadian Standard Freeness of the cellulose fibers can be measured according to a Canadian Standard Freeness test, specified by TAPPI test method T-227-om-09 Freeness of pulp. The test can provide an average CSF value.

In some embodiments, a non-woven fiber web forming a part of a pasting paper or a capacitance layer may comprise a plurality of fibers, other than or in addition to the cellulose fibers described above, that is soluble in an electrolyte present in a battery in which a battery plate comprising the pasting paper or capacitance layer is configured to be used, and/or decomposes upon exposure to an electrolyte present in a battery in which a battery plate comprising the pasting paper or capacitance layer is configured to be used. As an example, a pasting paper, a capacitance layer, a non-woven fiber web, a resinous layer, an additional layer, or a stand-alone layer may comprise a plurality of fibers comprising poly(vinyl alcohol) fibers, poly(amide) fibers, poly(acrylate) fibers, and/or poly(acrylonitrile) fibers. It should be understood this plurality of fibers, if present, may make up any suitable wt % of the pasting paper, the capacitance layer, the non-woven fiber web, the resinous layer, the additional layer, or the stand-alone layer (e.g., a wt % of the pasting paper, the capacitance layer, the non-woven fiber web, the resinous layer, the additional layer, or the stand-alone layer in a range described above with respect to cellulose fibers). It should also be understood that a plurality of fibers soluble in an electrolyte may comprise one or more of the types of fibers soluble in an electrolyte described herein.

As described above, in some embodiments, a pasting paper or a capacitance layer may comprise a non-woven fiber web comprising a plurality of conductive species. In some embodiments, an additional layer (e.g., a layer disposed on a non-woven fiber web, an additional layer that is a capacitance layer) and/or a stand-alone layer (e.g., a stand-alone layer that is a capacitance layer) comprise a plurality of conductive species. The conductive species may comprise conductive fibers and/or conductive particles.

In some embodiments, conductive fibers may be positioned in a non-woven fiber web (i.e., a non-woven fiber web may comprise a plurality of conductive fibers, such as a non-woven fiber web that is a pasting paper or a non-woven fiber web that is a capacitance layer), may be positioned in a resinous layer (i.e., a resinous layer may comprise a plurality of conductive fibers dispersed within a binder resin, such as a resinous layer comprising a binder resin with conductive fibers dispersed within the binder resin), may be positioned in an additional layer (e.g., a layer disposed on a non-woven fiber web may comprise a plurality of conductive fibers, an additional layer that is a capacitance layer may comprise a plurality of conductive fibers), and/or may be positioned in a stand-alone layer (e.g., a stand-alone layer that is a capacitance layer may comprise a plurality of conductive fibers).

When present in a fiber web or a pasting paper, the conductive fibers may make up any suitable amount of the fiber web or the pasting paper. The conductive fibers may make up greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 50 wt %, greater than or equal to 70 wt %, greater than or equal to 75 wt %, greater than or equal to 80 wt %, greater than or equal to 85 wt %, or greater than or equal to 90 wt % of the non-woven fiber web or the pasting paper. The conductive fibers may make up less than or equal to 95 wt %, less than or equal to 90 wt %, less than or equal to 85 wt %, less than or equal to 80 wt %, less than or equal to 75 wt %, less than or equal to 70 wt %, less than or equal to 50 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, less than or equal to 1 wt %, less than or equal to 0.5 wt %, or less than or equal to 0.2 wt % of the non-woven fiber web or the pasting paper. Combinations of the above-referenced ranges are also possible (e.g., greater than or equal to 0.1 wt % and less than or equal to 95 wt % of the non-woven fiber web or the pasting paper, greater than or equal to 0.1 wt % and less than or equal to 70 wt % of the non-woven fiber web or the pasting paper, greater than or equal to 5 wt % and less than or equal to 50 wt % of the non-woven fiber web or the pasting paper, or greater than or equal to 15 wt % and less than or equal to 25 wt % of the non-woven fiber web or the pasting paper). In some embodiments, the non-woven fiber web or the pasting paper include 0 wt % conductive fibers. Other ranges are also possible. In some embodiments, the ranges above for weight percentage are based on the total weight of the non-woven fiber web or the pasting paper. For example, the conductive fibers may be present in an amount of greater than or equal to 0.1 wt % and less than or equal to 95 wt % of the total weight of the non-woven fiber web or the pasting paper. In some embodiments, the ranges above for weight percentage are based on the total amount of fibers in the non-woven fiber web or the pasting paper. For example, the conductive fibers may be present in an amount of greater than or equal to 0.1 wt % and less than or equal to 95 wt % of the total amount of fibers in the non-woven fiber web or the pasting paper.

In some embodiments, a pasting paper may comprise a non-woven fiber web with an amount of conductive fibers in one or more of the ranges described above with respect to the total weight of the non-woven fiber web, and/or may comprise a non-woven fiber web with an amount of conductive fibers in one or more of the ranges described above with respect to the total amount of fibers in the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising conductive fibers and an additional layer, and the pasting paper as a whole may have an amount of conductive fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise conductive fibers, and the pasting paper as a whole may have an amount of conductive fibers in one or more of the ranges described above with respect to the total weight of the pasting paper and/or in one or more of the ranges described above with respect to the total amount of the fibers in the pasting paper. In some embodiments, a stand-alone layer comprising conductive fibers is provided, such as a stand-alone layer that is a capacitance layer. In some embodiments, the additional layer or stand-alone layer may be a resinous layer comprising a binder resin with the conductive fibers dispersed within the binder resin.

When present in an additional layer (e.g., a layer disposed on a non-woven fiber web, an additional layer that is a capacitance layer, an additional layer that is a non-woven fiber web comprising conductive fibers, an additional layer that is a resinous layer comprising a binder resin with conductive fibers dispersed within the binder resin) or a stand-alone layer (e.g., a stand-alone layer that is a capacitance layer, a stand-alone layer that is a non-woven fiber web comprising conductive fibers, a stand-alone layer that is a resinous layer comprising a binder resin with conductive fibers dispersed within the binder resin), the conductive fibers may make up any suitable amount of the additional layer or the stand-alone layer. The conductive fibers may make up greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 50 wt %, greater than or equal to 75 wt %, greater than or equal to 90 wt %, greater than or equal to 95 wt %, or greater than or equal to 99 wt % of the additional layer or the stand-alone layer. The conductive fibers may make up less than or equal to 99.9 wt %, less than or equal to 99 wt %, less than or equal to 95 wt %, less than or equal to 90 wt %, less than or equal to 75 wt %, less than or equal to 50 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.5 wt %, or less than or equal to 0.2 wt % of the additional layer or the stand-alone layer. Combinations of the above-referenced ranges are also possible (e.g., greater than or equal to 0.1 wt % and less than or equal to 99.9 wt % of the additional layer or the stand-alone layer, greater than or equal to 5 wt % and less than or equal to 30 wt % of the additional layer or the stand-alone layer, greater than or equal to 30 wt % and less than or equal to 95 wt % of the additional layer or the stand-alone layer, or greater than or equal to 50 wt % and less than or equal to 90 wt % of the additional layer or the stand-alone layer). In some embodiments, the additional layer or the stand-alone layer include 0 wt % conductive fibers. Other ranges are also possible. The ranges above for weight percentage are based on the total dry weight of the additional layer or the stand-alone layer. For example, the conductive fibers may be present in an amount of greater than or equal to 0.1 wt % and less than or equal to 99.9 wt % of the total dry weight of the additional layer or the stand-alone layer. When present, the conductive fibers may comprise any suitable types of conductive fibers. In some embodiments, the conductive fibers may comprise carbon-containing materials. The carbon-containing materials may include graphite, poly(acrylonitrile), carbon nanotubes, conductive polymers, pitch-based materials, and/or carbonaceous materials produced from pitch-based materials (e.g., the conductive fibers may comprise carbon fibers produced from pitch-based materials). Non-limiting examples of conductive polymers include poly(aniline)s, poly(pyrrole), poly(p-phenylene), and poly(thiophene). Non-limiting examples of pitch-based materials include hydrocarbons produced from plants, crude petroleum oil, and/or coal. Pitch-based materials may be processed to produce carbon fibers, that may optionally undergo one or more further processing steps to add additional functionality (e.g., activation, graphitization). Without wishing to be bound by any particular theory, it is believed that carbon fibers produced from pitch-based materials may exhibit desirably high mechanical strengths. It should be understood that a plurality of conductive fibers may comprise one or more of the types of conductive fibers described herein. The conductive fibers may comprise one or more of the materials described above throughout the fiber (e.g., the fiber may be formed from one or more of the materials described above), or may comprise one or more of the materials described above as a coating (e.g., on a core of a different composition).

When present, the conductive fibers may have any suitable average fiber diameter. The average fiber diameter of the conductive fibers may be greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 30 microns, greater than or equal to 50 microns, or greater than or equal to 75 microns. The average fiber diameter of the conductive fibers may be less than or equal to 100 microns, less than or equal to 75 microns, less than or equal to 50 microns, less than or equal to 30 microns, less than or equal to 20 microns, less than or equal to 15 microns, less than or equal to 10 microns, less than or equal to 5 microns, less than or equal to 2 microns, less than or equal to 1 micron, less than or equal to 0.5 microns, or less than or equal to 0.2 microns. Combinations of the above-referenced ranges are also possible (e.g., greater than or equal to 0.1 micron and less than or equal to 100 microns, greater than or equal to 2 microns and less than or equal to 30 microns, or greater than or equal to 5 microns and less than or equal to 15 microns). Other ranges are also possible. One of ordinary skill in the art would be familiar with techniques that may be used to determine the average fiber diameter of conductive fibers in a pasting paper, a capacitance layer, a non-woven fiber web, an additional layer, a resinous layer, or a stand-alone layer. Two examples of suitable techniques are transmission electron microscopy and scanning electron microscopy. Unless otherwise specified, references to an average fiber diameter of the conductive fibers should be understood to refer to a number average diameter of the conductive fibers.

When present, the conductive fibers may have any suitable average length. The average length of the conductive fibers may be greater than or equal to 0.1 mm, greater than or equal to 0.2 mm, greater than or equal to 0.5 mm, greater than or equal to 1 mm, greater than or equal to 2 mm, greater than or equal to 3 mm, greater than or equal to 5 mm, greater than or equal to 10 mm, greater than or equal to 15 mm, greater than or equal to 20 mm, greater than or equal to 50 mm, greater than or equal to 75 mm, greater than or equal to 100 mm, or greater than or equal to 200 mm. The average length of the conductive fibers may be less than or equal to 500 mm, less than or equal to 200 mm, less than or equal to 100 mm, less than or equal to 75 mm, less than or equal to 50 mm, less than or equal to 20 mm, less than or equal to 15 mm, less than or equal to 10 mm, less than or equal to 5 mm, less than or equal to 3 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 500 mm, greater than or equal to 1 mm and less than or equal to 20 mm, or greater than or equal to 3 mm and less than or equal to 15 mm). Other ranges are also possible.

When present, the conductive fibers may have any suitable average electrical conductivity. The average electrical conductivity of the conductive fibers may be greater than or equal to 1 S/m, greater than or equal to 2 S/m, greater than or equal to 5 S/m, greater than or equal to 10 S/m, greater than or equal to 20 S/m, greater than or equal to 50 S/m, greater than or equal to 100 S/m, greater than or equal to 200 S/m, greater than or equal to 500 S/m, greater than or equal to 1,000 S/m, greater than or equal to 2,000 S/m, greater than or equal to 5,000 S/m, greater than or equal to 10,000 S/m, greater than or equal to 20,000 S/m, greater than or equal to 50,000 S/m, greater than or equal to 100,000 S/m, greater than or equal to 200,000 S/m, or greater than or equal to 250,000 S/m. The average electrical conductivity of the conductive fibers may be less than or equal to 300,000 S/m, less than or equal to 250,000 S/m, less than or equal to 200,000 S/m, less than or equal to 100,000 S/m, less than or equal to 50,000 S/m, less than or equal to 20,000 S/m, less than or equal to 10,000 S/m, less than or equal to 5,000 S/m, less than or equal to 2,000 S/m, less than or equal to 1,000 S/m, less than or equal to 500 S/m, less than or equal to 200 S/m, less than or equal to 100 S/m, less than or equal to 50 S/m, less than or equal to 20 S/m, less than or equal to 10 S/m, less than or equal to 5 S/m, or less than or equal to 2 S/m. Combinations of the above-referenced ranges are also possible (e.g., greater than or equal to 1 S/m and less than or equal to 300,000 S/m, greater than or equal to 5 S/m and less than or equal to 250,000 S/m, or greater than or equal to 10 S/m and less than or equal to 200,000 S/m). Other ranges are also possible. The average electrical conductivity of the conductive fibers may be determined by forming a sheet of the conductive fibers by a wet laid process, measuring the resistivity of the sheet according to the four point method described in ASTM F390-11 (2018), and then dividing the inverse of the measured resistivity by the thickness of the sheet. The wet laid process comprises: (1) forming a slurry comprising water, the conductive fibers, and 1:1 PE/PET bicomponent fibers with an average fiber diameter of 13 microns and an average fiber length of 6 mm; (2) agitating the slurry until no bundles of fibers can be observed by eye; (3) using a web process to form a 30 gsm handsheet including 95 wt % of the conductive fibers and 5 wt % of the PE/PET bicomponent fibers from the slurry; (4) drying the handsheet in an oven at 120° C. for 30 minutes; and (5) heating the dried handsheet at 150° C. for one minute to cure the bicomponent fibers.

When present, the conductive fibers may have any suitable specific surface area. The specific surface area of the conductive fibers may be greater than or equal to 0.1 m²/g, greater than or equal to 0.2 m²/g, greater than or equal to 0.5 m²/g, greater than or equal to 0.75 m²/g, greater than or equal to 1 m²/g, greater than or equal to 2 m²/g, greater than or equal to 5 m²/g, greater than or equal to 7.5 m²/g, greater than or equal to 10 m²/g, greater than or equal to 20 m²/g, greater than or equal to 30 m²/g, greater than or equal to 40 m²/g, greater than or equal to 50 m²/g, greater than or equal to 75 m²/g, greater than or equal to 100 m²/g, greater than or equal to 200 m²/g, greater than or equal to 300 m²/g, greater than or equal to 500 m²/g, or greater than or equal to 750 m²/g. The specific surface area of the conductive fibers may be less than or equal to 1000 m²/g, less than or equal to 750 m²/g, less than or equal to 500 m²/g, less than or equal to 300 m²/g, less than or equal to 200 m²/g, less than or equal to 100 m²/g, less than or equal to 75 m²/g, less than or equal to 50 m²/g, less than or equal to 40 m²/g, less than or equal to 30 m²/g, less than or equal to 20 m²/g, less than or equal to 10 m²/g, less than or equal to 7.5 m²/g, less than or equal to 5 m²/g, less than or equal to 2 m²/g, less than or equal to 1 m²/g, less than or equal to 0.75 m²/g, less than or equal to 0.5 m²/g, or less than or equal to 0.2 m²/g. Combinations of the above-referenced ranges are also possible (e.g., greater than or equal to 0.1 m²/g and less than or equal to 1000 m²/g, greater than or equal to 10 m²/g and less than or equal to 1000 m²/g, or greater than or equal to 20 m²/g and less than or equal to 500 m²/g). Other ranges are also possible.

The specific surface area of the conductive fibers may be determined in accordance with section 10 of Battery Council International Standard BCIS-03A (2002), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a ¾″ tube; and, the sample is allowed to degas at 100° C. for a minimum of 3 hours.

In some embodiments, conductive particles may be positioned in a non-woven fiber web (i.e., a non-woven fiber web may comprise a plurality of conductive particles, such as a non-woven fiber web that is a pasting paper or a non-woven fiber web that is a capacitance layer), may be positioned in a resinous layer (i.e., a resinous layer may comprise a plurality of conductive particles dispersed within a binder resin, such as a resinous layer comprising a binder resin with conductive particles dispersed within the binder resin), may be positioned in an additional layer (e.g., a layer disposed on a non-woven fiber web may comprise a plurality of conductive particles, an additional layer that is a capacitance layer may comprise a plurality of conductive particles), and/or may be positioned in a stand-alone layer (e.g., a stand-alone layer that is a capacitance layer may comprise a plurality of conductive particles).

When present in a non-woven fiber web or a pasting paper, the conductive particles may make up any suitable amount of the non-woven fiber web or the pasting paper. The conductive particles may make up greater than or equal to 0.1 wt %, greater than or equal to 0.2 wt %, greater than or equal to 0.5 wt %, greater than or equal to 1 wt %, greater than or equal to 2 wt %, greater than or equal to 3 wt %, greater than or equal to 5 wt %, greater than or equal to 10 wt %, greater than or equal to 15 wt %, greater than or equal to 20 wt %, greater than or equal to 30 wt %, or greater than or equal to 40 wt % of the non-woven fiber web or the pasting paper. The conductive particles may make up less than or equal to 50 wt %, less than or equal to 40 wt %, less than or equal to 30 wt %, less than or equal to 20 wt %, less than or equal to 15 wt %, less than or equal to 10 wt %, less than or equal to 5 wt %, less than or equal to 3 wt %, less than or equal to 2 wt %, less than or equal to 1 wt %, less than or equal to 0.5 wt %, or less than or equal to 0.2 wt % of the non-woven fiber web or the pasting paper. Combinations of the above-referenced ranges are also possible (e.g., greater than or equal to 0.1 wt % and less than or equal to 50 wt % of the non-woven fiber web or the pasting paper, greater than or equal to 1 wt % and less than or equal to 30 wt % of the non-woven fiber web or the pasting paper, or greater than or equal to 3 wt % and less than or equal to 10 wt % of the non-woven fiber web or the pasting paper). In some embodiments, the non-woven fiber web or the pasting paper include 0 wt % conductive particles. Other ranges are also possible. In some embodiments, the ranges above for weight percentage are based on the total weight of the non-woven fiber web or the pasting paper. For example, the conductive particles may be present in an amount of greater than or equal to 0.1 wt % and less than or equal to 50 wt % of the total weight of the non-woven fiber web or the pasting paper.

In some embodiments, a pasting paper may comprise a non-woven fiber web with an amount of conductive particles in one or more of the ranges described above with respect to the total weight of the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising conductive particles and an additional layer, and the pasting paper as a whole may have an amount of conductive particles in one or more of the ranges described above with respect to the total weight of the pasting paper. In some embodiments, a pasting paper may comprise a non-woven fiber web and an additional layer, the additional layer may comprise conductive particles, and the pasting paper as a whole may have an amount of conductive particles in one or more of the ranges described above with respect to the total weight of the pasting paper. In some embodiments, a stand-alone layer comprising conductive particles is provided, such as a stand-alone layer that is a capacitance layer. In some embodiments, additional layer or the capacitance layer may be a resinous layer comprising a binder resin with the conductive particles dispersed within the binder resin.

When present in an additional layer (e.g., a layer disposed on a non-woven fiber web, an additional layer that is a capacitance layer, an additional layer that is a non-woven fiber web comprising conductive particles, an additional layer that is a resinous layer comprising a binder resin with conductive particles dispersed within the binder resin) or a stand-alone layer (e.g., a stand-alone layer that is a capacitance layer, a stand-alone layer that is a non-woven fiber web comprising conductive particles, a stand-alone layer that is a resinous layer comprising a binder resin with conductive particles dispersed within the binder resin), the conductive particles may make up any suitable amount of the additional layer or the stand-alone layer. The conductive particles may make up greater than or equal to 0.01 wt %, greater than or equal to 0.02 wt %, greater than or equal to 0.05 wt %, greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 8 wt %, greater than or equal to 10 wt %, greater than or equal to 20 wt %, greater than or equal to 30 wt %, greater than or equal to 50 wt %, greater than or equal to 75 wt %, greater than or equal to 90 wt %, greater than or equal to 95 wt %, or greater than or equal to 99 wt % of the additional layer or the stand-alone layer. The conductive particles may make up less than or equal to 99.9 wt %, less than or equal to 99 wt %, less than or equal to 95 wt %, less than or equal to 90 wt %, less than or equal to 75 wt %, less than or equal to 50 wt %, less than or equal to 30 wt %, less than or equal to 20 wt %, less than or equal to 10 wt %, less than or equal to 8 wt %, less than or equal to 5 wt %, less than or equal to 2 wt %, less than or equal to 1 wt %, less than or equal to 0.5 wt %, less than or equal to 0.2 wt %, less than or equal to 0.1 wt %, less than or equal to 0.05 wt %, or less than or equal to 0.02 wt % of the additional layer or the stand-alone layer. Combinations of the above-referenced ranges are also possible (e.g., greater than or equal to 0.01 wt % and less than or equal to 99.9 wt % of the additional layer or the stand-alone layer, greater than or equal to 0.01 wt % and less than or equal to 50 wt % of the additional layer or the stand-alone layer, greater than or equal to 0.05 wt % and less than or equal to 20 wt % of the additional layer or the stand-alone layer, greater than or equal to 0.1 wt % and less than or equal to 99.9 wt % of the additional layer or the stand-alone layer, greater than or equal to 0.1 wt % and less than or equal to 5 wt % of the additional layer or the stand-alone layer, greater than or equal to 5 wt % and less than or equal to 30 wt % of the additional layer or the stand-alone layer, greater than or equal to 8 wt % and less than or equal to 10 wt % of the additional layer or the stand-alone layer, greater than or equal to 30 wt % and less than or equal to 95 wt % of the additional layer or the stand-alone layer, or greater than or equal to 50 wt % and less than or equal to 90 wt % of the additional layer or the stand-alone layer). In some embodiments, the additional layer or the stand-alone layer include 0 wt % conductive particles. Other ranges are also possible. The ranges above for weight percentage are based on the total dry weight of the additional layer or the stand-alone layer. For example, the conductive particles may be present in an amount of greater than or equal to 0.1 wt % and less than or equal to 99.9 wt % of the total dry weight of the additional layer or the stand-alone layer.

In some embodiments, an additional layer (e.g., a layer disposed on a non-woven fiber web, an additional layer that is a capacitance layer) or a stand-alone layer (e.g., a stand-alone layer that is a capacitance layer) comprises a plurality of conductive fibers and a plurality of conductive particles, and the plurality of conductive fibers and plurality of conductive particles together make up an amount of the additional layer or the stand-alone layer in one or more of the ranges above. For example, the additional layer or the stand-alone layer may comprise a plurality of conductive species that is present in an amount of greater than or equal to 0.1 wt % and less than or equal to 99.9 wt % of the total dry weight of the additional layer or the stand-alone layer, and the plurality of conductive species may comprise conductive fibers and conductive particles.

When present, the conductive particles may comprise any suitable types of conductive particles. In some embodiments, the conductive particles may comprise carbon-containing materials. The carbon-containing materials may include carbon black, acetylene black, graphite (e.g., graphite comprising crystals that are relatively aligned with each other, such as highly-oriented pyrolytic graphite and/or pure and ordered synthetic graphite), graphene, carbon nanotubes, and glassy carbon. Without wishing to be bound by any particular theory, it is believed that highly-oriented pyrolytic graphite may be advantageous for inclusion in conductive particles because it may exhibit anisotropic conductivity and/or may be relatively unreactive with other components present in the additional layer or stand-alone layer. In some embodiments, the conductive particles may comprise oxides, such as tin oxide and/or molybdenum oxide. In some embodiments, the conductive particles may comprise metalloids and/or metals, such as germanium, silver, copper, gold, and/or platinum. It should be understood that a plurality of conductive particles may comprise one or more of the types of conductive particles described herein. The conductive particles may comprise one or more of the materials described above throughout the particle (e.g., the particle may be formed from one or more of the materials described above and/or may be one of the species described above), or may comprise one or more of the materials described above as a coating (e.g., on a core of a different composition).

Without wishing to be bound by any particular theory, it is believed that some of the above-referenced conductive particles may have a higher electrical conductivity and/or may be more expensive than others. Such conductive particles may be included in a pasting paper, in a capacitance layer, or in a layer described herein (e.g., a non-woven fiber web, a resinous layer, an additional layer, a stand-alone layer) in relatively low amounts. In some embodiments, relatively lower amounts of these conductive particles may enhance the electrical conductivity of the relevant layer by an amount similar to or greater than the amount by which relatively higher amounts of other conductive particles would enhance the electrical conductivity of the relevant layer.

As a specific example, in some embodiments, an additional layer (e.g., an additional layer that is a capacitance layer) or stand-alone layer (e.g., a stand-alone layer that is a capacitance layer) comprises conductive particles comprising graphene and/or carbon nanotubes, and the conductive particles comprising the graphene and/or carbon nanotubes make up greater than or equal to 0.01 wt %, greater than or equal to 0.02 wt %, greater than or equal to 0.05 wt %, greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 8 wt %, greater than or equal to 10 wt %, greater than or equal to 20 wt %, or greater than or equal to 30 wt % of the additional layer or the stand-alone layer. In some embodiments, an additional layer or stand-alone layer comprises conductive particles comprising graphene and/or carbon nanotubes, and the conductive particles comprising the graphene and/or carbon nanotubes make up less than or equal to 50 wt %, less than or equal to 30 wt %, less than or equal to 20 wt %, less than or equal to 10 wt %, less than or equal to 8 wt %, less than or equal to 5 wt %, less than or equal to 2 wt %, less than or equal to 1 wt %, less than or equal to 0.5 wt %, less than or equal to 0.2 wt %, less than or equal to 0.1 wt %, less than or equal to 0.05 wt %, or less than or equal to 0.02 wt % of the additional layer or the stand-alone layer. Combinations of the above-referenced ranges are also possible (e.g., greater than or equal to 0.01 wt % and less than or equal to 50 wt % of the additional layer or the stand-alone layer, greater than or equal to 0.05 wt % and less than or equal to 20 wt % of the additional layer or the stand-alone layer, or greater than or equal to 0.1 wt % and less than or equal to 5 wt % of the additional layer or the stand-alone layer). In some embodiments, the additional layer or the stand-alone layer include 0 wt % conductive particles comprising graphene and/or carbon nanotubes. Other ranges are also possible.

The ranges above for weight percentage are based on the total dry weight of the additional layer or the stand-alone layer. For example, the conductive particles comprising graphene and/or carbon nanotubes may be present in an amount of greater than or equal to 0.01 wt % and less than or equal to 50 wt % of the total dry weight of the additional layer or the stand-alone layer.

When present, the conductive particles may have any suitable average diameter. The average diameter of the conductive particles may be greater than or equal to 0.001 micron, greater than or equal to 0.002 microns, greater than or equal to 0.005 microns, greater than or equal to 0.01 micron, greater than or equal to 0.02 microns, greater than or equal to 0.05 microns, greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 20 microns, or greater than or equal to 50 microns. The average diameter of the conductive particles may be less than or equal to 100 microns, less than or equal to 50 microns, less than or equal to 20 microns, less than or equal to 10 microns, less than or equal to 5 microns, less than or equal to 2 microns, less than or equal to 1 micron, less than or equal to 0.5 microns, less than or equal to 0.2 microns, less than or equal to 0.1 micron, less than or equal to 0.05 microns, less than or equal to 0.02 microns, less than or equal to 0.01 micron, less than or equal to 0.005 microns, or less than or equal to 0.002 microns. Combinations of the above-referenced ranges are also possible (e.g., greater than or equal to 0.001 micron and less than or equal to 100 microns, greater than or equal to 0.01 micron and less than or equal to 20 microns, or greater than or equal to 0.1 micron and less than or equal to 2 microns). Other ranges are also possible. The average diameter of the conductive particles may be measured by transmission electron microscopy and/or by scanning electron microscopy. Unless otherwise specified, references to an average diameter of the conductive particles should be understood to refer to a number average diameter of the conductive particles. For the purpose of calculating the average diameter of the conductive particles, conductive particles that are not spherical are considered to have a diameter that is the average of their shortest diameter and their longest diameter.

When present, the conducive particles may have any suitable average aspect ratio. The average aspect ratio of the conductive particles may be less than or equal to 1000:1, less than or equal to 500:1, less than or equal to 200:1, less than or equal to 100:1, less than or equal to 50:1, less than or equal to 20:1, less than or equal to 10:1, less than or equal to 5:1, less than or equal to 3:1, less than or equal to 2:1, or less than or equal to 1.5:1 and greater than or equal to 1:1. It should be understood that different types of conductive particles may have different suitable average aspect ratios. For instance, conductive particles comprising graphene may have a relatively large average aspect ratio (e.g., up to 1000:1), while other types of conductive particles may have a relatively smaller average aspect ratio (e.g., up to 3:1). As used herein, the aspect ratio of a conductive particle is the ratio of the longest line segment that may be drawn from one surface of the conductive particle through the center of mass of the conductive particle to an opposing surface of the conductive particle to the shortest line segment that may be drawn from one surface of the conductive particle through the center of mass of the conductive particle to an opposing surface of the conductive particle. The average aspect ratio of the conductive particles is the average of the aspect ratios of the conductive particles in the plurality of conductive particles. The average aspect ratio of the conductive particles may be measured by transmission electron microscopy and/or by scanning electron microscopy.

When present, the conductive particles may have any suitable average electrical conductivity. The average electrical conductivity of the conductive particles may be greater than or equal to 1 S/m, greater than or equal to 2 S/m, greater than or equal to 5 S/m, greater than or equal to 10 S/m, greater than or equal to 20 S/m, greater than or equal to 50 S/m, greater than or equal to 100 S/m, greater than or equal to 200 S/m, greater than or equal to 500 S/m, greater than or equal to 1,000 S/m, greater than or equal to 2,000 S/m, greater than or equal to 5,000 S/m, greater than or equal to 10,000 S/m, greater than or equal to 20,000 S/m, greater than or equal to 50,000 S/m, greater than or equal to 100,000 S/m, greater than or equal to 200,000 S/m, greater than or equal to 250,000 S/m, greater than or equal to 300,000 S/m, greater than or equal to 500,000 S/m, greater than or equal to 1,000,000 S/m, greater than or equal to 2,000,000 S/m, greater than or equal to 5,000,000 S/m, greater than or equal to 10,000,000 S/m, greater than or equal to 20,000,000 S/m, or greater than or equal to 50,000,000 S/m. The average electrical conductivity of the conductive particles may be less than or equal to 70,000,000 S/m, less than or equal to 50,000,000 S/m, less than or equal to 20,000,000 S/m, less than or equal to 10,000,000 S/m, less than or equal to 5,000,000 S/m, less than or equal to 2,000,000 S/m, less than or equal to 1,000,000 S/m, less than or equal to 500,000 S/m, less than or equal to 300,000 S/m, less than or equal to 250,000 S/m, less than or equal to 200,000 S/m, less than or equal to 100,000 S/m, less than or equal to 50,000 S/m, less than or equal to 20,000 S/m, less than or equal to 10,000 S/m, less than or equal to 5,000 S/m, less than or equal to 2,000 S/m, less than or equal to 1,000 S/m, less than or equal to 500 S/m, less than or equal to 200 S/m, less than or equal to 100 S/m, less than or equal to 50 S/m, less than or equal to 20 S/m, less than or equal to 10 S/m, less than or equal to 5 S/m, or less than or equal to 2 S/m. Combinations of the above-referenced ranges are also possible (e.g., greater than or equal to 1 S/m and less than or equal to 70,000,000 S/m, greater than or equal to 1 S/m and less than or equal to 300,000 S/m, greater than or equal to 5 S/m and less than or equal to 250,000 S/m, greater than or equal to 10 S/m and less than or equal to 200,000 S/m, or greater than or equal to 1,000,000 S/m and less than or equal to 70,000,000 S/m). Other ranges are also possible. It should be understood that different types of conductive particles may have different average electrical conductivities. For instance, conductive particles comprising metals may have a relatively large average electrical conductivities (e.g., greater than or equal to 1,000,000 S/m and less than or equal to 70,000,000 S/m), while other types of conductive particles may have a relatively smaller average electrical conductivities (e.g., greater than or equal to 1 S/m and less than or equal to 300,000 S/m). The average electrical conductivity of the conductive particles may be determined by applying a pressure of 500 lbs/in² to press the conductive particles into a pellet of known length and cross-sectional area, applying a voltage across the pellet, measuring the current across the pellet, dividing the voltage by the current to determine the resistance of the pellet, and then dividing the inverse of the resistance by the ratio of the cross-sectional area of the pellet to the length of the pellet.

When present, the conductive particles may have any suitable specific surface area. The specific surface area of the conductive particles may be greater than or equal to 0.1 m²/g, greater than or equal to 0.2 m²/g, greater than or equal to 0.5 m²/g, greater than or equal to 0.75 m²/g, greater than or equal to 1 m²/g, greater than or equal to 2 m²/g, greater than or equal to 5 m²/g, greater than or equal to 7.5 m²/g, greater than or equal to 10 m²/g, greater than or equal to 20 m²/g, greater than or equal to 30 m²/g, greater than or equal to 40 m²/g, greater than or equal to 50 m²/g, greater than or equal to 75 m²/g, greater than or equal to 100 m²/g, greater than or equal to 200 m²/g, greater than or equal to 300 m²/g, greater than or equal to 500 m²/g, greater than or equal to 750 m²/g, or greater than or equal to 1000 m²/g. The specific surface area of the conductive particles may be less than or equal to 2000 m²/g, less than or equal to 1000 m²/g, less than or equal to 750 m²/g, less than or equal to 500 m²/g, less than or equal to 300 m²/g, less than or equal to 200 m²/g, less than or equal to 100 m²/g, less than or equal to 75 m²/g, less than or equal to 50 m²/g, less than or equal to 40 m²/g, less than or equal to 30 m²/g, less than or equal to 20 m²/g, less than or equal to 10 m²/g, less than or equal to 7.5 m²/g, less than or equal to 5 m²/g, less than or equal to 2 m²/g, less than or equal to 1 m²/g, less than or equal to 0.75 m²/g, less than or equal to 0.5 m²/g, or less than or equal to 0.2 m²/g. Combinations of the above-referenced ranges are also possible (e.g., greater than or equal to 0.1 m²/g and less than or equal to 2000 m²/g, greater than or equal to 10 m²/g and less than or equal to 2000 m²/g, or greater than or equal to 20 m²/g and less than or equal to 500 m²/g). Other ranges are also possible.

The specific surface area of the conductive particles may be determined in accordance with section 10 of Battery Council International Standard BCIS-03A (2002), “Recommended Battery Materials Specifications Valve Regulated Recombinant Batteries”, section 10 being “Standard Test Method for Surface Area of Recombinant Battery Separator Mat” as described elsewhere herein.

As described above, in some embodiments, a pasting paper or a capacitance layer may comprise a non-woven fiber web comprising a plurality of capacitive species. In some embodiments, an additional layer (e.g., a layer disposed on a non-woven fiber web, an additional layer that is a capacitance layer) and/or a stand-alone layer (e.g., a stand-alone layer that is a capacitance layer) comprise a plurality of capacitive species. The capacitive species may comprise capacitive fibers and/or capacitive particles. In some embodiments, a pasting paper or an additional layer comprises a species that is both capacitive and has one or more of the physical properties described elsewhere herein. For instance, some species may be both capacitive and conducive (e.g., a conductive polymer, graphene) and some species may be both capacitive and configured to scavenge contaminants (e.g., activated carbon). In such cases, the species that both is capacitive and has the relevant physical property should be understood to contribute to the amounts of capacitive species and amounts of species having the relevant physical property, should be understood to possibly have some or all of the features described herein for capacitive species, and should be understood to possibly have some or all of the features described elsewhere herein for species having the relevant physical property.

In some embodiments, capacitive fibers may be positioned in a non-woven fiber web (i.e., a non-woven fiber web may comprise a plurality of capacitive fibers, such as a non-woven fiber web that is a pasting paper or a non-woven fiber web that is a capacitance layer), may be positioned in a resinous layer (i.e., a resinous layer may comprise a plurality of capacitive fibers dispersed within a binder resin, such as a resinous layer comprising a binder resin with capacitive fibers dispersed within the binder resin), may be positioned in an additional layer (e.g., a layer disposed on a non-woven fiber web may comprise a plurality of capacitive fibers, an additional layer that is a capacitance layer may comprise a plurality of capacitive fibers), and/or may be positioned in a stand-alone layer (e.g., a stand-alone layer that is a capacitance layer may comprise a plurality of capacitive fibers).

When present in a non-woven fiber web or a pasting paper, the capacitive fibers may make up any suitable amount of the fiber web or the pasting paper. The capacitive fibers may make up greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 50 wt %, greater than or equal to 70 wt %, greater than or equal to 75 wt %, greater than or equal to 80 wt %, greater than or equal to 85 wt %, or greater than or equal to 90 wt % of the non-woven fiber web or the pasting paper. The capacitive fibers may make up less than or equal to 95 wt %, less than or equal to 90 wt %, less than or equal to 85 wt %, less than or equal to 80 wt %, less than or equal to 75 wt %, less than or equal to 70 wt %, less than or equal to 50 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, less than or equal to 1 wt %, less than or equal to 0.5 wt %, or less than or equal to 0.2 wt % of the non-woven fiber web or the pasting paper. Combinations of the above-referenced ranges are also possible (e.g., greater than or equal to 0.1 wt % and less than or equal to 95 wt % of the non-woven fiber web or the pasting paper, greater than or equal to 0.1 wt % and less than or equal to 70 wt % of the non-woven fiber web or the pasting paper, greater than or equal to 5 wt % and less than or equal to 50 wt % of the non-woven fiber web or the pasting paper, or greater than or equal to 15 wt % and less than or equal to 25 wt % of the non-woven fiber web or the pasting paper). In some embodiments, the non-woven fiber web or the pasting paper include 0 wt % capacitive fibers. Other ranges are also possible. In some embodiments, the ranges above for weight percentage are based on the total weight of the non-woven fiber web or the pasting paper. For example, the capacitive fibers may be present in an amount of greater than or equal to 0.1 wt % and less than or equal to 95 wt % of the total weight of the non-woven fiber web or the pasting paper. In some embodiments, the ranges above for weight percentage are based on the total amount of fibers in the non-woven fiber web or the pasting paper. For example, the capacitive fibers may be present in an amount of greater than or equal to 0.1 wt % and less than or equal to 95 wt % of the total amount of fibers in the non-woven fiber web or the pasting paper.

In some embodiments, a pasting paper may comprise a non-woven fiber web with an amount of capacitive fibers in one or more of the ranges described above with respect to the total weight of the non-woven fiber web, and/or may comprise a non-woven fiber web with an amount of capacitive fibers in one or more of the ranges described above with respect to the total amount of fibers in the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising capacitive fibers and an additional layer, and the pasting paper as a whole may have an amount of capacitive fibers in one or more of the ranges described above with respect to the total weight of the pasting paper and/or in one or more of the ranges described above with respect to the total amount of the fibers in the pasting paper. In some embodiments, a pasting paper may comprise a non-woven fiber web and an additional layer, the additional layer may comprise capacitive fibers, and the pasting paper as a whole may have an amount of capacitive fibers in one or more of the ranges described above with respect to the total weight of the pasting paper and/or in one or more of the ranges described above with respect to the total amount of the fibers in the pasting paper. In some embodiments, a stand-alone layer comprising capacitive fibers is provided, such as a stand-alone capacitance layer. In some embodiments, the additional layer or the stand-alone layer may be a resinous layer comprising a binder resin with the capacitive fibers dispersed within the binder resin.

When present in an additional layer (e.g., a layer disposed on a non-woven fiber web, an additional layer that is a capacitance layer, an additional layer that is a non-woven fiber web comprising capacitive fibers, an additional layer that is a resinous layer comprising a binder resin with capacitive fibers dispersed within the binder resin) or a stand-alone layer (e.g., a stand-alone layer that is a capacitance layer, a stand-alone layer that is a non-woven fiber web comprising capacitive fibers, a stand-alone layer that is a resinous layer comprising a binder resin with capacitive fibers dispersed within the binder resin), the capacitive fibers may make up any suitable amount of the additional layer or the stand-alone layer. The capacitive fibers may make up greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 70 wt %, greater than or equal to 75 wt %, greater than or equal to 80 wt %, greater than or equal to 85 wt %, or greater than or equal to 85 wt % of the additional layer or the stand-alone layer. The capacitive fibers may make up less than or equal to 95 wt %, less than or equal to 90 wt %, less than or equal to 85 wt %, less than or equal to 80 wt %, less than or equal to 75 wt %, less than or equal to 70 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.2 wt %, or less than or equal to 0.5 wt % of the additional layer or the stand-alone layer. Combinations of the above-referenced ranges are also possible (e.g., greater than or equal to 0.1 wt % and less than or equal to 95 wt % of the additional layer or the stand-alone layer, greater than or equal to 0.1 wt % and less than or equal to 50 wt % of the additional layer or the stand-alone layer, greater than or equal to 1 wt % and less than or equal to 40 wt % of the additional layer or the stand-alone layer, or greater than or equal to 5 wt % and less than or equal to 30 wt % of the additional layer or the stand-alone layer). In some embodiments, the additional layer or the stand-alone layer include 0 wt % capacitive fibers. Other ranges are also possible. The ranges above for weight percentage are based on the total dry weight of the additional layer or the stand-alone layer. For example, the capacitive fibers may be present in an amount of greater than or equal to 0.1 wt % and less than or equal to 50 wt % of the total dry weight of the additional layer or the stand-alone layer.

When present, the capacitive fibers may comprise any suitable types of capacitive fibers. In some embodiments, the capacitive fibers may comprise carbon-containing materials. The carbon-containing materials may include activated carbon. In some embodiments, the capacitive particles may comprise a pseudocapacitive material (i.e., a material that stores charge through both Faradaic processes and non-Faradaic processes). Non-limiting examples of suitable pseudocapacitive materials include metal oxides and conducting polymers. The metal oxides may include NiO, RuO₂, MnO₂, and/or IrO₂. In some embodiments, the metal oxides are mixed with carbon fibers and/or carbon particles. The conducting polymers may comprise poly(aniline), poly(thiophene), poly(pyrrole), and/or poly(acetylene). It should be understood that a plurality of capacitive fibers may comprise one or more of the types of capacitive fibers described herein. The capacitive fibers may comprise one or more of the materials described above throughout the fiber (e.g., the fiber may be formed from one or more of the materials described above), or may comprise one or more of the materials described above as a coating (e.g., on a core of a different composition).

When present, the capacitive fibers may have any suitable average fiber diameter. The average fiber diameter of the capacitive fibers may be greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 30 microns, greater than or equal to 50 microns, or greater than or equal to 75 microns. The average fiber diameter of the capacitive fibers may be less than or equal to 100 microns, less than or equal to 75 microns, less than or equal to 50 microns, less than or equal to 30 microns, less than or equal to 20 microns, less than or equal to 15 microns, less than or equal to 10 microns, less than or equal to 5 microns, less than or equal to 2 microns, less than or equal to 1 micron, less than or equal to 0.5 microns, or less than or equal to 0.2 microns. Combinations of the above-referenced ranges are also possible (e.g., greater than or equal to 0.1 micron and less than or equal to 100 microns, greater than or equal to 2 microns and less than or equal to 30 microns, or greater than or equal to 5 microns and less than or equal to 15 microns). Other ranges are also possible. One of ordinary skill in the art would be familiar with techniques that may be used to determine the average fiber diameter of capacitive fibers in a pasting paper, a capacitance layer, a non-woven fiber web, a resinous layer, an additional layer, or a stand-alone layer. Two examples of suitable techniques are transmission electron microscopy and scanning electron microscopy. Unless otherwise specified, references to an average fiber diameter of the capacitive fibers should be understood to refer to a number average diameter of the capacitive fibers.

When present, the capacitive fibers may have any suitable average length. The average length of the capacitive fibers may be greater than or equal to 0.1 mm, greater than or equal to 0.2 mm, greater than or equal to 0.5 mm, greater than or equal to 1 mm, greater than or equal to 2 mm, greater than or equal to 3 mm, greater than or equal to 5 mm, greater than or equal to 10 mm, greater than or equal to 15 mm, greater than or equal to 20 mm, greater than or equal to 50 mm, greater than or equal to 75 mm, greater than or equal to 100 mm, or greater than or equal to 200 mm. The average length of the capacitive fibers may be less than or equal to 500 mm, less than or equal to 200 mm, less than or equal to 100 mm, less than or equal to 75 mm, less than or equal to 50 mm, less than or equal to 20 mm, less than or equal to 15 mm, less than or equal to 10 mm, less than or equal to 5 mm, less than or equal to 3 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 500 mm, greater than or equal to 1 mm and less than or equal to 20 mm, or greater than or equal to 3 mm and less than or equal to 15 mm). Other ranges are also possible.

When present, the capacitive fibers may have any suitable average specific capacitance. The average specific capacitance of the capacitive fibers may be greater than or equal to 1 F/g, greater than or equal to 2 F/g, greater than or equal to 5 F/g, greater than or equal to 10 F/g, greater than or equal to 20 F/g, greater than or equal to 50 F/g, greater than or equal to 100 F/g, greater than or equal to 200 F/g, greater than or equal to 250 F/g, or greater than or equal to 400 F/g. The average specific capacitance of the capacitive fibers may be less than or equal to 500 F/g, less than or equal to 400 F/g, less than or equal to 250 F/g, less than or equal to 200 F/g, less than or equal to 100 F/g, less than or equal to 50 F/g, less than or equal to 20 F/g, less than or equal to 10 F/g, less than or equal to 5 F/g, or less than or equal to 2 F/g. Combinations of the above-referenced ranges are also possible (e.g., greater than or equal to 1 F/g and less than or equal to 500 F/g, greater than or equal to 10 F/g and less than or equal to 250 F/g, or greater than or equal to 20 F/g and less than or equal to 200 F/g). Other ranges are also possible.

The average specific capacitance of the capacitive fibers may be determined in accordance with IEC 62576:2018. Briefly, this method involves: (1) constructing a symmetric supercapacitor/ultracapacitor device including two identical electrodes comprising the capacitive fibers, a separator, and a 1.28 spg sulfuric acid electrolyte; (2) measuring the voltage as a function of time during a constant current charge-discharge test performed across voltages varying from 0 V to 1 V; (3) identifying a period of time over which the voltage decreases linearly with time; (4) multiplying the slope of the voltage decrease as a function of time in this time period by the discharge current to determine the capacitance of the particles; and (5) multiplying the measured capacitance of the fibers by 4 and dividing this value by the mass of the active material in each electrode. The identical electrodes comprising the capacitive fibers may be formed by a wet laid process comprising: (1) forming a slurry comprising water, the capacitive fibers, conductive carbon fibers with an average fiber diameter of 7 microns and an average fiber length of 6 mm, and 1:1 PE/PET bicomponent fibers with an average fiber diameter of 13 microns and an average fiber length of 6 mm; (2) agitating the slurry until no bundles of fibers can be observed by eye; (3) using a web process to form a 30 gsm handsheet including 90 wt % of the capacitive fibers, 5 wt % of the conductive fibers, and 5 wt % of the PE/PET bicomponent fibers from the slurry; (4) drying the handsheet in an oven at 120° C. for 30 minutes; and (5) heating the dried handsheet at 150° C. for one minute to cure the bicomponent fibers.

When present, the capacitive fibers may have any suitable specific surface area. The specific surface area of the capacitive fibers may be greater than or equal to 100 m²/g, greater than or equal to 200 m²/g, greater than or equal to 300 m²/g, greater than or equal to 500 m²/g, greater than or equal to 750 m²/g, greater than or equal to 1000 m²/g, greater than or equal to 2000 m²/g, or greater than or equal to 3000 m²/g. The specific surface area of the capacitive fibers may be less than or equal to 4000 m²/g, less than or equal to 3000 m²/g, less than or equal to 2000 m²/g, less than or equal to 1000 m²/g, less than or equal to 750 m²/g, less than or equal to 500 m²/g, less than or equal to 300 m²/g, or less than or equal to 200 m²/g. Combinations of the above-referenced ranges are also possible (e.g., greater than or equal to 100 m²/g and less than or equal to 4000 m²/g, or greater than or equal to 500 m²/g and less than or equal to 2000 m²/g). Other ranges are also possible.

The specific surface area of the capacitive fibers may be determined in accordance with section 10 of Battery Council International Standard BCIS-03A (2002), “Recommended Battery Materials Specifications Valve Regulated Recombinant Batteries”, section 10 being “Standard Test Method for Surface Area of Recombinant Battery Separator Mat” as described elsewhere herein.

When present, capacitive fibers configured to scavenge contaminants (e.g., activated carbon fibers) may be configured to scavenge any suitable contaminant. Non-limiting examples of such contaminants include metals and organic contaminants. The metals may include iron, nickel, antimony, silver, platinum, and/or arsenic. Such metals may be in ionic form (e.g., cationic form) and/or may be in elemental form.

In some embodiments, capacitive particles may be positioned in a non-woven fiber web (i.e., a non-woven fiber web may comprise a plurality of capacitive particles, such as a non-woven fiber web that is a pasting paper or a non-woven fiber web that is a capacitance layer), may be positioned in a resinous layer (i.e., a resinous layer may comprise a plurality of capacitive particles dispersed within a binder resin, such as a resinous layer comprising a binder resin with capacitive particles dispersed within the binder resin), may be positioned in an additional layer (e.g., a layer disposed on a non-woven fiber web may comprise a plurality of capacitive particles, an additional layer that is a capacitance layer may comprise a plurality of capacitive particles), and/or may be positioned in a stand-alone layer (e.g., a stand-alone layer that is a capacitance layer may comprise a plurality of capacitive particles).

When present in a non-woven fiber web or a pasting paper, the capacitive particles may make up any suitable amount of the fiber web or the pasting paper. The capacitive particles may make up greater than or equal to 0.1 wt %, greater than or equal to 0.2 wt %, greater than or equal to 0.5 wt %, greater than or equal to 1 wt %, greater than or equal to 2 wt %, greater than or equal to 3 wt %, greater than or equal to 5 wt %, greater than or equal to 10 wt %, greater than or equal to 15 wt %, greater than or equal to 20 wt %, greater than or equal to 30 wt %, greater than or equal to 40 wt %. greater than or equal to 50 wt %, greater than or equal to 70 wt %, greater than or equal to 75 wt %, greater than or equal to 80 wt %, greater than or equal to 85 wt %, or greater than or equal to 90 wt % of the non-woven fiber web or the pasting paper. The capacitive particles may make up less than or equal to 95 wt %, less than or equal to 90 wt %, less than or equal to 85 wt %, less than or equal to 80 wt %, less than or equal to 70 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 5 wt %, less than or equal to 3 wt %, less than or equal to 2 wt %, less than or equal to 1 wt %, less than or equal to 0.5 wt %, or less than or equal to 0.2 wt % of the non-woven fiber web or the pasting paper. Combinations of the above-referenced ranges are also possible (e.g., greater than or equal to 0.1 wt % and less than or equal to 95 wt % of the non-woven fiber web or the pasting paper, greater than or equal to 0.1 wt % and less than or equal to 50 wt % of the non-woven fiber web or the pasting paper, greater than or equal to 1 wt % and less than or equal to 30 wt % of the non-woven fiber web or the pasting paper, or greater than or equal to 3 wt % and less than or equal to 10 wt % of the non-woven fiber web or the pasting paper). In some embodiments, the non-woven fiber web or the pasting paper include 0 wt % capacitive particles. Other ranges are also possible. In some embodiments, the ranges above for weight percentage are based on the total weight of the non-woven fiber web or the pasting paper. For example, the capacitive particles may be present in an amount of greater than or equal to 0.1 wt % and less than or equal to 50 wt % of the total weight of the non-woven fiber web or the pasting paper.

In some embodiments, a pasting paper may comprise a non-woven fiber web with an amount of capacitive particles in one or more of the ranges described above with respect to the total weight of the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising capacitive particles and an additional layer, and the pasting paper as a whole may have an amount of capacitive particles in one or more of the ranges described above with respect to the total weight of the pasting paper. In some embodiments, a pasting paper may comprise a non-woven fiber web and an additional layer, the additional layer may comprise capacitive particles, and the pasting paper as a whole may have an amount of capacitive particles in one or more of the ranges described above with respect to the total weight of the pasting paper. In some embodiments, a stand-alone layer comprising capacitive particles is provided, such as a stand-alone capacitance layer. In some embodiments, the additional layer or the stand-alone layer may be a resinous layer comprising a binder resin with the capacitive particles dispersed within the binder resin.

When present in an additional layer (e.g., a layer disposed on a non-woven fiber web, an additional layer that is a capacitance layer, an additional layer that is a non-woven fiber web comprising capacitive particles, an additional layer that is a resinous layer comprising a binder resin with capacitive particles dispersed within the binder resin) or a stand-alone layer (e.g., a stand-alone layer that is a capacitance layer, a stand-alone layer that is a non-woven fiber web comprising capacitive particles, a stand-alone layer that is a resinous layer comprising a binder resin with capacitive particles dispersed within the binder resin), the capacitive particles may make up any suitable amount of the additional layer or the stand-alone layer. The capacitive particles may make up greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 70 wt %, greater than or equal to 75 wt %, greater than or equal to 80 wt %, greater than or equal to 85 wt %, or greater than or equal to 90 wt % of the additional layer or the stand-alone layer. The capacitive particles may make up less than or equal to 95 wt %, less than or equal to 90 wt %, less than or equal to 85 wt %, less than or equal to 80 wt %, less than or equal to 75 wt %, less than or equal to 70 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, less than or equal to 1 wt %, less than or equal to 0.2 wt %, or less than or equal to 0.5 wt % of the additional layer or the stand-alone layer. Combinations of the above-referenced ranges are also possible (e.g., greater than or equal to 0.1 wt % and less than or equal to 95 wt % of the additional layer or the stand-alone layer, greater than or equal to 0.1 wt % and less than or equal to 50 wt % of the additional layer or the stand-alone layer, greater than or equal to 1 wt % and less than or equal to 40 wt % of the additional layer or the stand-alone layer, greater than or equal to 5 wt % and less than or equal to 30 wt % of the additional layer or the stand-alone layer, greater than or equal to 70 wt % and less than or equal to 90 wt % of the additional layer or the stand-alone layer, or greater than or equal to 75 wt % and less than or equal to 85 wt % of the additional layer or the stand-alone layer). In some embodiments, the additional layer or the stand-alone layer include 0 wt % capacitive particles. Other ranges are also possible. The ranges above for weight percentage are based on the total dry weight of the additional layer or the stand-alone layer. For example, the capacitive particles may be present in an amount of greater than or equal to 0.1 wt % and less than or equal to 50 wt % of the total dry weight of the additional layer or the stand-alone layer.

In some embodiments, an additional layer (e.g., a layer disposed on a non-woven fiber web, an additional layer that is a capacitance layer) or a stand-alone layer (e.g., a stand-alone layer that is a capacitance layer) comprises a plurality of capacitive fibers and a plurality of capacitive particles, and the plurality of capacitive fibers and plurality of capacitive particles together make up an amount of the additional layer or the stand-alone layer in one or more of the ranges above. For example, the additional layer or the stand-alone layer may comprise a plurality of capacitive species that is present in an amount of greater than or equal to 0.1 wt % and less than or equal to 50 wt % of the total dry weight of the additional layer or the stand-alone layer, and the plurality of capacitive species may comprise capacitive fibers and capacitive particles.

When present, the capacitive particles may comprise any suitable types of capacitive particles. In some embodiments, the capacitive particles may comprise carbon-containing materials. The carbon-containing materials may include activated carbon (e.g., activated charcoal) and graphene. In some embodiments, the capacitive particles may comprise a pseudocapacitive material. Non-limiting examples of suitable pseudocapacitive materials include metal oxides, metal hydroxides, metal sulfides, and metal nitrides. The metal oxides may include NiO, RuO₂, MnO₂, IrO₂, and Fe₃O₄. In some embodiments, the metal oxides are mixed with carbon fibers and/or carbon particles. The metal sulfides may include TiS₂. It should be understood that a plurality of capacitive particles may comprise one or more of the types of capacitive particles described herein. The capacitive particles may comprise one or more of the materials described above throughout the particle (e.g., the particle may be formed from one or more of the materials described above), or may comprise one or more of the materials described above as a coating (e.g., on a core of a different composition).

When present, the capacitive particles may have any suitable average diameter. The average diameter of the capacitive particles may be greater than or equal to 0.01 micron, greater than or equal to 0.02 microns, greater than or equal to 0.05 microns, greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 20 microns, greater than or equal to 30 microns, greater than or equal to 50 microns, greater than or equal to 200 microns, or greater than or equal to 300 microns. The average diameter of the capacitive particles may be less than or equal to 400 microns, less than or equal to 300 microns, less than or equal to 200 microns, less than or equal to 100 microns, less than or equal to 50 microns, less than or equal to 30 microns, less than or equal to 20 microns, less than or equal to 10 microns, less than or equal to 5 microns, less than or equal to 2 microns, less than or equal to 1 micron, less than or equal to 0.5 microns, less than or equal to 0.2 microns, less than or equal to 0.1 micron, less than or equal to 0.05 microns, or less than or equal to 0.02 microns. Combinations of the above-referenced ranges are also possible (e.g., greater than or equal to 0.01 micron and less than or equal to 400 microns, greater than or equal to 0.1 micron and less than or equal to 100 microns, or greater than or equal to 1 micron and less than or equal to 30 microns). Other ranges are also possible. The average diameter of the capacitive particles may be measured by transmission electron microscopy and/or by scanning electron microscopy. Unless otherwise specified, references to an average diameter of the capacitive particles should be understood to refer to a number average diameter of the capacitive particles. For the purpose of calculating the average diameter of the capacitive particles, capacitive particles that are not spherical are considered to have a diameter that is the average of their shortest diameter and their longest diameter.

When present, the capacitive particles may have any suitable average aspect ratio. The average aspect ratio of the capacitive particles may be less than or equal to 1000:1, less than or equal to 500:1, less than or equal to 200:1, less than or equal to 100:1, less than or equal to 50:1, less than or equal to 20:1, less than or equal to 10:1, less than or equal to 5:1, less than or equal to 3:1, less than or equal to 2:1, or less than or equal to 1.5:1 and greater than or equal to 1:1. It should be understood that different types of capacitive particles may have different suitable average aspect ratios. For instance, capacitive particles comprising graphene may have a relatively large average aspect ratio (e.g., up to 1000:1), while other types of capacitive particles may have a relatively smaller average aspect ratio (e.g., up to 3:1). As used herein, the aspect ratio of a capacitive particle is the ratio of the longest line segment that may be drawn from one surface of the capacitive particle through the center of mass of the capacitive particle to an opposing surface of the capacitive particle to the shortest line segment that may be drawn from one surface of the capacitive particle through the center of mass of the capacitive particle to an opposing surface of the capacitive particle. The average aspect ratio of the capacitive particles is the average of the aspect ratios of the capacitive particles in the plurality of capacitive particles. The average aspect ratio of the capacitive particles may be measured by transmission electron microscopy and/or by scanning electron microscopy.

When present, the capacitive particles may have any suitable average specific capacitance. The average specific capacitance of the capacitive particles may be greater than or equal to 1 F/g, greater than or equal to 2 F/g, greater than or equal to 5 F/g, greater than or equal to 10 F/g, greater than or equal to 20 F/g, greater than or equal to 50 F/g, greater than or equal to 100 F/g, greater than or equal to 200 F/g, greater than or equal to 250 F/g, greater than or equal to 400 F/g, greater than or equal to 500 F/g, greater than or equal to 750 F/g, greater than or equal to 1,000 F/g, greater than or equal to 1,500 F/g, greater than or equal to 2,000 F/g, greater than or equal to 2,600 F/g, greater than or equal to 3,000 F/g, or greater than or equal to 4,000 F/g. The average specific capacitance of the capacitive particles may be less than or equal to 5,000 F/g, less than or equal to 4,000 F/g, less than or equal to 3,0000 F/g, less than or equal to 2,600 F/g, less than or equal to 2,000 F/g, less than or equal to 1,500 F/g, less than or equal to 1,000 F/g, less than or equal to 750 F/g, than or equal to 500 F/g, less than or equal to 400 F/g, less than or equal to 250 F/g, less than or equal to 200 F/g, less than or equal to 100 F/g, less than or equal to 50 F/g, less than or equal to 20 F/g, less than or equal to 10 F/g, less than or equal to 5 F/g, or less than or equal to 2 F/g. Combinations of the above-referenced ranges are also possible (e.g., greater than or equal to 1 F/g and less than or equal to 5,000 F/g, greater than or equal to 1 F/g and less than or equal to 3,000 F/g, greater than or equal to 1 F/g and less than or equal to 500 F/g, greater than or equal to 10 F/g and less than or equal to 250 F/g, or greater than or equal to 20 F/g and less than or equal to 200 F/g). Other ranges are also possible.

The average specific capacitance of the capacitive particles may be determined in accordance with IEC 62576:2018 as described elsewhere herein in relation to capacitive fibers but performed on a symmetric supercapacitor/ultracapacitor device including two identical electrodes comprising the capacitive particles instead of capacitive fibers. The identical electrodes comprising the capacitive particles may be formed and prepared for use in the symmetric supercapacitor/ultracapacitor device by a process comprising: (1) mixing together the capacitive particles and carbon black particles with an average diameter of 200 nm at a weight ratio of 18:1; (2) diluting a dispersion of 60 wt % PTFE solids (average solids diameter 50 nm; dispersion density 1.50 g/cm³) in water to form a 5 wt % dispersion of PTFE solids in water; (3) mixing the 5 wt % PTFE dispersion with the mixture of capacitive particles and carbon black particles to form an electrode precursor with a ratio of capacitive particles:carbon black particles:PTFE of 90:5:5; (4) rolling the electrode precursor to form a layer of the electrode precursor with a thickness of 150 microns and a density of 1 mg/mm³; (5) drying the layer of the electrode precursor in an oven at 75° C. for 12 hours; (6) cutting 4 cm×4 cm square electrodes from the dried electrode precursor; and (7) attaching 316 stainless steel sheets with a thickness of 0.018 cm to the square electrodes.

When present, the capacitive particles may have any suitable specific surface area. The specific surface area of the capacitive particles may be greater than or equal to 100 m²/g, greater than or equal to 200 m²/g, greater than or equal to 300 m²/g, greater than or equal to 500 m²/g, greater than or equal to 750 m²/g, greater than or equal to 1000 m²/g, greater than or equal to 2000 m²/g, or greater than or equal to 3000 m²/g. The specific surface area of the capacitive particles may be less than or equal to 4000 m²/g, less than or equal to 3000 m²/g, less than or equal to 2000 m²/g, less than or equal to 1000 m²/g, less than or equal to 750 m²/g, less than or equal to 500 m²/g, less than or equal to 300 m²/g, or less than or equal to 200 m²/g. Combinations of the above-referenced ranges are also possible (e.g., greater than or equal to 100 m²/g and less than or equal to 4000 m²/g, or greater than or equal to 500 m²/g and less than or equal to 3000 m²/g). Other ranges are also possible.

The specific surface area of the capacitive particles may be determined in accordance with section 10 of Battery Council International Standard BCIS-03A (2002), “Recommended Battery Materials Specifications Valve Regulated Recombinant Batteries”, section 10 being “Standard Test Method for Surface Area of Recombinant Battery Separator Mat” as described elsewhere herein.

When present, capacitive particles configured to scavenge contaminants (e.g., activated carbon) may be configured to scavenge any suitable contaminant. Non-limiting examples of such contaminants include metals and organic contaminants. The metals may include iron, nickel, antimony, silver, platinum, and/or arsenic. Such metals may be in ionic form (e.g., cationic form) and/or may be in elemental form.

In some embodiments, a pasting paper or capacitance layer as described herein may comprise a non-woven fiber web comprising non-woven web comprising both a plurality of conductive species and a plurality of capacitive species. In some embodiments, an additional layer (e.g., a layer disposed on a non-woven fiber web, an additional layer that is a capacitance layer) or a stand-alone layer (e.g., a stand-alone layer that is a capacitance layer) comprises a plurality of conductive species and a plurality of capacitive species. One or both of the conductive species and the capacitive species may comprise fibers. One or both of the capacitive species and the conductive species may comprise particles.

When both a plurality of conductive species and a plurality of capacitive species are present in a pasting paper, a capacitance layer, an additional layer (e.g., a layer disposed on a non-woven fiber web, an additional layer that is a capacitance layer), or a stand-alone layer (e.g., a stand-alone layer that is a capacitance layer), the ratio of the weight of the plurality of conductive species to the weight of the plurality of capacitive species in the pasting paper, the capacitance layer, the additional layer, or the stand-alone layer may be any suitable value. The ratio of the weight of the plurality of conductive species to the weight of the plurality of capacitive species in the pasting paper, the additional layer, or the stand-alone layer may be greater than or equal to 5:95, greater than or equal to 7:93, greater than or equal to 10:90, greater than or equal to 15:85, greater than or equal to 20:80, or greater than or equal to 25:75. The ratio of the weight of the plurality of conductive species to the weight of the plurality of capacitive species in the pasting paper, the additional layer, or the stand-alone layer may be less than or equal to 30:70, less than or equal to 25:75, less than or equal to 20:80, less than or equal to 15:85, less than or equal to 10:90, or less than or equal to 7:93. Combinations of the above-referenced ranges are also possible (e.g., greater than or equal to 5:95 and less than or equal to 30:70, greater than or equal to 7:93 and less than or equal to 25:75, or greater than or equal to 10:90 and less than or equal to 20:80). Other ranges are also possible.

When a pasting paper, a capacitance layer, an additional layer, or a stand-alone layer comprises a species that is both conductive and capacitive, that species should be understood to contribute to both the weight of the conductive species and the weight of the capacitive species for the weight ratios described above. By way of example, a pasting paper, a capacitance layer, an additional layer, or a stand-alone layer that includes only species that are both conductive and capacitive would have a weight ratio of the weight of the plurality of conductive species to the weight of the plurality of capacitive species of 50:50. As another example, a pasting paper, a capacitance layer, an additional layer, or a stand-alone layer that includes equal amounts of species that are conductive but not capacitive and species that are both conductive and capacitive would have a weight ratio of the weight of the plurality of conductive species to the weight of the plurality of capacitive species of 2:1.

In some embodiments, a pasting paper as described herein, a capacitance layer, an additional layer (e.g., a layer disposed on a non-woven fiber web, an additional layer that is a capacitance layer), or a stand-alone layer (e.g., a stand-alone layer that is a capacitance layer) is configured to be disposed on a battery plate and/or is disposed on a battery plate. In some such embodiments, the pasting paper, the capacitance layer, the additional layer, or the stand-alone layer may include relatively little conductive and/or capacitive species in comparison to the active mass in the battery plate. A ratio of a sum of a weight of the plurality of conductive species and a weight of the plurality of capacitive species to a weight of the active mass in the battery plate may be less than 1:100, less than or equal to 1:110, less than or equal to 1:150, less than or equal to 1:200, less than or equal to 1:500, or less than or equal to 1:700. The ratio of the sum of the weight of the plurality of conductive species and the weight of the plurality of capacitive species to the weight of the active mass in the battery plate may be greater than or equal to 1:1000, greater than or equal to 1:700, greater than or equal to 1:500, greater than or equal to 1:200, greater than or equal to 1:150, or greater than or equal to 1:110. Combinations of the above-referenced ranges are also possible (e.g., less than 1:100 and greater than or equal to 1:1000). Other ranges are also possible.

As described above, in some embodiments, a pasting paper or a capacitance layer may comprise a non-woven fiber web or a resinous layer comprising a plurality of inorganic particles. In some embodiments, an additional layer (e.g., a layer disposed on a non-woven fiber web) and/or a stand-alone layer (e.g., a stand-alone layer that is a capacitance layer) comprise a plurality of inorganic particles. When present in a non-woven fiber web, a pasting paper, or a capacitance layer, the inorganic particles may be positioned in a non-woven fiber web (i.e., a non-woven fiber web may comprise a plurality of inorganic particles), may be positioned in a resinous layer (i.e., a resinous layer may comprise a plurality of inorganic particles), and/or may be positioned in an additional layer (e.g., a layer disposed on a non-woven fiber web may comprise a plurality of inorganic particles). In some embodiments, a pasting paper, a capacitance layer, an additional layer, or a stand-alone layer comprises inorganic particles that also have one or more of the physical properties described elsewhere herein. For instance, some inorganic particles may also be conductive, some inorganic particles may also be configured to scavenge contaminants (e.g., in the case of particles comprising precipitated silica), and some inorganic particles may also be configured to reduce hydrogen generation in the battery (e.g., in the case of barium sulfate, in the case of particles comprising a metal oxide). In such cases, the species that both is inorganic and has the relevant physical property should be understood to contribute to the amounts of inorganic species and amounts of species having the relevant physical property, should be understood to possibly have some or all of the features described herein for inorganic particles, and should be understood to possibly have some or all of the features described elsewhere herein for species having the relevant physical property.

In some embodiments, inorganic particles may be positioned in a non-woven fiber web (i.e., a non-woven fiber web may comprise a plurality of inorganic particles), may be positioned in a resinous layer (i.e., a resinous layer may comprise a plurality of inorganic particles dispersed within a binder resin, such as a resinous layer comprising a binder resin with inorganic particles dispersed within the binder resin), may be positioned in an additional layer (e.g., a layer disposed on a non-woven fiber web may comprise a plurality of inorganic particles, an additional layer that is a capacitance layer may comprise a plurality of inorganic particles), and/or may be positioned in a stand-alone layer (e.g., a stand-alone layer that is a capacitance layer may comprise a plurality of inorganic particles).

When present in a non-woven fiber web or a pasting paper, the inorganic particles may make up any suitable amount of the non-woven fiber web or the pasting paper. The inorganic particles may make up greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 1 wt %, greater than or equal to 2 wt %, greater than or equal to 4 wt %, greater than or equal to 5 wt %, greater than or equal to 7 wt %, greater than or equal to 10 wt %, greater than or equal to 15 wt %, greater than or equal to 20 wt %, greater than or equal to 30 wt %, greater than or equal to 40 wt %, or greater than or equal to 50 wt % of the non-woven fiber web or the pasting paper. The inorganic particles may make up less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7 wt %, less than or equal to 5 wt %, less than or equal to 4 wt %, less than or equal to 2 wt %, less than or equal to 1 wt %, less than or equal to 0.5 wt %, less than or equal to 0.2 wt %, less than or equal to 0.1 wt %, less than or equal to 0.075 wt %, less than or equal to 0.05 wt %, or less than or equal to 0.02 wt % of the non-woven fiber web or the pasting paper. Combinations of the above-referenced ranges are also possible (e.g., greater than or equal to 0.1 wt % and less than or equal to 60 wt % of the non-woven fiber web or the pasting paper, greater than or equal to 0.1 wt % and less than or equal to 10 wt % of the non-woven fiber web or the pasting paper, greater than or equal to 0.2 wt % and less than or equal to 40 wt % of the non-woven fiber web or the pasting paper, greater than or equal to 0.2 wt % and less than or equal to 7 wt % of the non-woven fiber web or the pasting paper, greater than or equal to 0.3 wt % and less than or equal to 4 wt % of the non-woven fiber web or the pasting paper, or greater than or equal to 0.5 wt % and less than or equal to 30 wt % of the non-woven fiber web or the pasting paper). In some embodiments, the non-woven fiber web or the pasting paper include 0 wt % inorganic particles. Other ranges are also possible. In some embodiments, the ranges above for weight percentage are based on the total weight of the non-woven fiber web or the pasting paper. For example, the inorganic particles may be present in an amount of greater than or equal to 0.1 wt % and less than or equal to 60 wt % of the total weight of the non-woven fiber web or the pasting paper.

In some embodiments, a pasting paper may comprise a non-woven fiber web with an amount of inorganic particles in one or more of the ranges described above with respect to the total weight of the non-woven fiber web. Such pasting papers may further comprise an additional layer, such as a layer disposed on (e.g., adjacent) the non-woven fiber web. In some embodiments, a pasting paper may comprise a non-woven fiber web comprising inorganic particles and an additional layer, and the pasting paper as a whole may have an amount of inorganic particles in one or more of the ranges described above with respect to the total weight of the pasting paper. In some embodiments, a pasting paper may comprise a non-woven fiber web and an additional layer, the additional layer may comprise inorganic particles, and the pasting paper as a whole may have an amount of inorganic particles in one or more of the ranges described above with respect to the total weight of the pasting paper. In some embodiments, a stand-alone layer comprising inorganic particles is provided, such as a stand-alone capacitance layer. In some embodiments, the additional layer or the stand-alone layer may be a resinous layer comprising a binder resin with the inorganic particles dispersed within the binder resin.

When present in an additional layer (e.g., a layer disposed on a non-woven fiber web, an additional layer that is a capacitance layer, an additional layer that is a non-woven fiber web comprising inorganic particles, an additional layer that is a resinous layer comprising a binder resin with inorganic particles dispersed within the binder resin) or a stand-alone layer (e.g., a stand-alone layer that is a capacitance layer, a stand-alone layer that is a non-woven fiber web comprising inorganic particles, a stand-alone layer that is a resinous layer comprising a binder resin with inorganic particles dispersed within the binder resin), the inorganic particles may make up any suitable amount of the additional layer or the stand-alone layer. The inorganic particles may make up greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 1 wt %, greater than or equal to 2 wt %, greater than or equal to 4 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, or greater than or equal to 50 wt % of the additional layer or the stand-alone layer. The inorganic particles may make up less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7 wt %, less than or equal to 5 wt %, less than or equal to 4 wt %, less than or equal to 2 wt %, less than or equal to 1 wt %, less than or equal to 0.5 wt %, less than or equal to 0.2 wt %, less than or equal to 0.1 wt %, less than or equal to 0.075 wt %, less than or equal to 0.05 wt %, or less than or equal to 0.02 wt % of the additional layer or the stand-alone layer. Combinations of the above-referenced ranges are also possible (e.g., greater than or equal to 0.01 wt % and less than or equal to 10 wt %, greater than or equal to 0.1 wt % and less than or equal to 60 wt %, greater than or equal to 0.1 wt % and less than or equal to 5 wt %, greater than or equal to 0.2 wt % and less than or equal to 2 wt %, greater than or equal to 2 wt % and less than or equal to 30 wt %, greater than or equal to 5 wt % and less than or equal to 30 wt %, or greater than or equal to 5 wt % and less than or equal to 15 wt %). In some embodiments, the additional layer or the stand-alone layer includes 0 wt % inorganic particles. Other ranges are also possible. The ranges above for weight percentage are based on the total dry weight of the additional layer or the stand-alone layer. For example, the inorganic particles may be present in an amount of greater than or equal to 5 wt % and less than or equal to 30 wt % of the total dry weight of the additional layer or the stand-alone layer.

When present, the inorganic particles may comprise any suitable types of inorganic particles. In some embodiments, the inorganic particles comprise oxides. The oxides may include silica (e.g., SiO₂, fumed silica, precipitated silica), alumina, titania, zirconia, bismuth (IV) oxide, tin (IV) oxide, copper (IV) oxide, nickel (IV) oxide, and/or zinc (IV) oxide. In some embodiments, the inorganic particles comprise barium sulfate. Other examples of inorganic particles include zeolite particles and silicate particles. In some embodiments, the inorganic particles may be functionalized (e.g., silica may be functionalized with an organic functional group and/or with an acidic functional group). It should be understood that a plurality of inorganic particles may comprise one or more of the types of inorganic particles described herein.

When present, the inorganic particles may have any suitable average diameter. The average diameter of the inorganic particles may be greater than or equal to 0.001 micron, greater than or equal to 0.002 microns, greater than or equal to 0.005 microns, greater than or equal to 0.01 micron, greater than or equal to 0.02 microns, greater than or equal to 0.05 microns, greater than or equal to 0.1 micron, greater than or equal to 0.2 microns, greater than or equal to 0.4 microns, greater than or equal to 0.5 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 30 microns, or greater than or equal to 40 microns. The average diameter of the inorganic particles may be less than or equal to 50 microns, less than or equal to 40 microns, less than or equal to 30 microns, less than or equal to 20 microns, less than or equal to 15 microns, less than or equal to 10 microns, less than or equal to 5 microns, less than or equal to 2 microns, less than or equal to 1 micron, less than or equal to 0.5 microns, less than or equal to 0.4 microns, less than or equal to 0.2 microns, less than or equal to 0.1 micron, less than or equal to 0.05 microns, less than or equal to 0.02 microns, less than or equal to 0.01 micron, less than or equal to 0.005 microns, or less than or equal to 0.002 microns. Combinations of the above-referenced ranges are also possible (e.g., greater than or equal to 0.001 micron and less than or equal to 10 microns, greater than or equal to 0.01 micron and less than or equal to 50 microns, greater than or equal to 0.01 micron and less than or equal to 5 microns, greater than or equal to 0.05 microns and less than or equal to 2 microns, greater than or equal to 0.1 micron and less than or equal to 20 microns, greater than or equal to 0.4 microns and less than or equal to 15 microns, greater than or equal to 1 micron and less than or equal to 50 microns, greater than or equal to 5 microns and less than or equal to 40 microns, or greater than or equal to 10 microns and less than or equal to 30 microns). Other ranges are also possible. The average diameter of the inorganic particles may be measured by transmission electron microscopy and/or by scanning electron microscopy. Unless otherwise specified, references to an average diameter of the inorganic particles should be understood to refer to a number average diameter of the inorganic particles. For the purpose of calculating the average diameter of the inorganic particles, inorganic particles that are not spherical are considered to have a diameter that is the average of their shortest diameter and their longest diameter.

When present, the inorganic particles may have any suitable average aspect ratio. The average aspect ratio of the inorganic particles may be less than or equal to 3:1, less than or equal to 2:1, or less than or equal to 1.5:1 and greater than or equal to 1:1. As used herein, the aspect ratio of an inorganic particle is the ratio of the longest line segment that may be drawn from one surface of the inorganic particle through the center of mass of the inorganic particle to an opposing surface of the inorganic particle to the shortest line segment that may be drawn from one surface of the inorganic particle through the center of mass of the inorganic particle to an opposing surface of the inorganic particle. The average aspect ratio of the inorganic particles is the average of the aspect ratios of the inorganic particles in the plurality of inorganic particles. The average aspect ratio of the inorganic particles may be measured by transmission electron microscopy and/or by scanning electron microscopy.

When present, inorganic particles configured to scavenge contaminants (e.g., precipitated silica, functionalized silica) may be configured to scavenge any suitable contaminant. Non-limiting examples of such contaminants include metals such as lead, tin, ruthenium, platinum, copper, thorium, cadmium, and scandium. Such metals may be in ionic form (e.g., cationic form) and/or may be in elemental form.

As described above, in some embodiments, a pasting paper or a capacitance layer may comprise a non-woven fiber web or a resinous layer comprising a plurality of diatomite particles. In some embodiments, an additional layer (e.g., a layer disposed on a non-woven fiber web) and/or a stand-alone layer (e.g., a stand-alone layer that is a capacitance layer) comprise a plurality of diatomite particles. When present in a non-woven fiber web, a pasting paper, or a capacitance layer, the diatomite particles may be positioned in a non-woven fiber web (i.e., a non-woven fiber web may comprise a plurality of diatomite particles), may be positioned in a resinous layer (i.e., a resinous layer may comprise a plurality of diatomite particles), and/or may be positioned in an additional layer (e.g., a layer disposed on a non-woven fiber web may comprise a plurality of diatomite particles).

In some embodiments, diatomite particles may be positioned in a non-woven fiber web (i.e., a non-woven fiber web may comprise a plurality of diatomite particles, such as a non-woven fiber web that is a pasting paper or a non-woven fiber web that is a capacitance layer), may be positioned in a resinous layer (i.e., a resinous layer may comprise a plurality of diatomite particles dispersed within a binder resin, such as a resinous layer comprising a binder resin with diatomite particles dispersed within the binder resin), may be positioned in an additional layer (e.g., a layer disposed on a non-woven fiber web may comprise a plurality of diatomite particles, an additional layer that is a capacitance layer may comprise a plurality of diatomite particles), and/or may be positioned in a stand-alone layer (e.g., a stand-alone layer that is a capacitance layer may comprise a plurality of diatomite particles).

When present in a non-woven fiber web or a pasting paper, the diatomite particles may make up any suitable amount of the non-woven fiber web or the pasting paper. The diatomite particles may make up greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, or greater than or equal to 9 wt % of the non-woven fiber web or the pasting paper. The diatomite particles may make up less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, less than or equal to 0.75 wt %, less than or equal to 0.5 wt %, or less than or equal to 0.2 wt % of the non-woven fiber web or the pasting paper. Combinations of the above-referenced ranges are also possible (e.g., greater than or equal to 0.1 wt % and less than or equal to 10 wt %, greater than or equal to 0.5 wt % and less than or equal to 8 wt %, or greater than or equal to 1 wt % and less than or equal to 5 wt %). Other ranges are also possible. In some embodiments, the ranges above for weight percentage are based on the total weight of the non-woven fiber web or the pasting paper. For example, the diatomite particles may be present in an amount of greater than or equal to 0.1 wt % and less than or equal to 10 wt % of the total weight of the non-woven fiber web or the pasting paper.

In some embodiments, a pasting paper may comprise a non-woven fiber web with an amount of diatomite particles in one or more of the ranges described above with respect to the total weight of the non-woven fiber web. Such pasting papers may further comprise an additional layer, such as a layer disposed on (e.g., adjacent) the non-woven fiber web. In some embodiments, a pasting paper may comprise a non-woven fiber web comprising diatomite particles and an additional layer, and the pasting paper as a whole may have an amount of diatomite particles in one or more of the ranges described above with respect to the total weight of the pasting paper. In some embodiments, a pasting paper may comprise a non-woven fiber web and an additional layer, the additional layer may comprise diatomite particles, and the pasting paper as a whole may have an amount of diatomite particles in one or more of the ranges described above with respect to the total weight of the pasting paper. In some embodiments, a stand-alone layer comprising diatomite particles is provided, such as a stand-alone capacitance layer. In some embodiments, the additional layer or the stand-alone layer may be a resinous layer comprising a binder resin with the diatomite particles dispersed within the binder resin.

When present in an additional layer (e.g., a layer disposed on a non-woven fiber web, an additional layer that is a capacitance layer, an additional layer that is a non-woven fiber web comprising diatomite particles, an additional layer that is a resinous layer comprising a binder resin with diatomite particles dispersed within the binder resin) or a stand-alone layer (e.g., a stand-alone layer that is a capacitance layer, a stand-alone layer that is a non-woven fiber web comprising diatomite particles, a stand-alone layer that is a resinous layer comprising a binder resin with diatomite particles dispersed within the binder resin), the diatomite particles may make up any suitable amount of the additional layer or the stand-alone layer. The diatomite particles may make up greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, or greater than or equal to 9 wt % of the additional layer or the stand-alone layer. The diatomite particles may make up less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, less than or equal to 0.75 wt %, less than or equal to 0.5 wt %, or less than or equal to 0.2 wt % of the additional layer or the stand-alone layer. Combinations of the above-referenced ranges are also possible (e.g., greater than or equal to 0.1 wt % and less than or equal to 10 wt %, greater than or equal to 0.5 wt % and less than or equal to 8 wt %, or greater than or equal to 1 wt % and less than or equal to 5 wt %). Other ranges are also possible. The ranges above for weight percentage are based on the total dry weight of the additional layer or the stand-alone layer. For example, the diatomite particles may be present in an amount of greater than or equal to 0.1 wt % and less than or equal to 10 wt % of the total dry weight of the additional layer or the stand-alone layer.

When present, the diatomite particles may comprise any suitable type of diatomite. In some embodiments, the diatomite particles comprise diatomite formed from salt water diatoms. In some embodiments, the diatomite particles comprise diatomite formed from fresh water diatoms. Both of these types of diatomite particle include crystalline silica. One example of a suitable type of diatomite particles is Celatom supplied by Eagle-Picher. It should be understood that a plurality of diatomite particles may comprise one or more of the types of diatomite particles described herein.

When present, the diatomite particles may have any suitable average diameter. The average diameter of the diatomite particles may be greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, or greater than or equal to 80 microns. The average diameter of the diatomite particles may be less than or equal to 100 microns, less than or equal to 80 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, or less than or equal to 2 microns. Combinations of the above-referenced ranges are also possible (e.g., greater than or equal to 1 micron and less than or equal to 100 microns, greater than or equal to 5 microns and less than or equal to 80 microns, or greater than or equal to 10 microns and less than or equal to 30 microns). Other ranges are also possible. The average diameter of the diatomite particles may be measured by transmission electron microscopy and/or by scanning electron microscopy. Unless otherwise specified, references to an average diameter of the diatomite particles should be understood to refer to a number average diameter of the diatomite particles. For the purpose of calculating the average diameter of the diatomite particles, diatomite particles that are not spherical are considered to have a diameter that is the average of their shortest diameter and their longest diameter.

When present, the diatomite particles may have any suitable specific surface area. The specific surface area of the diatomite particles may be greater than or equal to 0.5 m²/g, greater than or equal to 0.75 m²/g, greater than or equal to 1 m²/g, greater than or equal to 1.5 m²/g, greater than or equal to 2 m²/g, greater than or equal to 2.5 m²/g, greater than or equal to 3 m²/g, greater than or equal to 3.5 m²/g, greater than or equal to 4 m²/g, greater than or equal to 5 m²/g, greater than or equal to 7.5 m²/g, greater than or equal to 10 m²/g, greater than or equal to 12.5 m²/g, greater than or equal to 15 m²/g, greater than or equal to 17.5 m²/g, greater than or equal to 20 m²/g, greater than or equal to 25 m²/g, greater than or equal to 30 m²/g, greater than or equal to 50 m²/g, greater than or equal to 75 m²/g, greater than or equal to 100 m²/g, greater than or equal to 125 m²/g, greater than or equal to 150 m²/g, or greater than or equal to 175 m²/g. The specific surface area of the diatomite particles may be less than or equal to 200 m²/g, less than or equal to 175 m²/g, less than or equal to 150 m²/g, less than or equal to 125 m²/g, less than or equal to 100 m²/g, less than or equal to 75 m²/g, less than or equal to 50 m²/g, less than or equal to 30 m²/g, less than or equal to 25 m²/g, less than or equal to 20 m²/g, less than or equal to 17.5 m²/g, less than or equal to 15 m²/g, less than or equal to 12.5 m²/g, less than or equal to 10 m²/g, less than or equal to 7.5 m²/g, less than or equal to 5 m²/g, less than or equal to 4 m²/g, less than or equal to 3.5 m²/g, less than or equal to 3 m²/g, less than or equal to 2.5 m²/g, less than or equal to 2 m²/g, less than or equal to 1.5 m²/g, less than or equal to 1 m²/g, or less than or equal to 0.75 m²/g. Combinations of the above-referenced ranges are also possible (e.g., greater than or equal to 0.5 m²/g and less than or equal to 200 m²/g, greater than or equal to 0.5 m²/g and less than or equal to 20 m²/g, greater than or equal to 1 m²/g and less than or equal to 10 m²/g, or greater than or equal to 2 m²/g and less than or equal to 4 m²/g,). Other ranges are also possible.

The specific surface area of the diatomite particles may be determined in accordance with section 10 of Battery Council International Standard BCIS-03A (2002), “Recommended Battery Materials Specifications Valve Regulated Recombinant Batteries”, section 10 being “Standard Test Method for Surface Area of Recombinant Battery Separator Mat” as described elsewhere herein.

When present, the diatomite particles may be configured to scavenge any suitable contaminant. Non-limiting examples of such contaminants include iron, nickel, chromium, silver, antimony, cobalt, copper, chlorine, manganese, and molybdenum. Such metals may be in ionic form (e.g., cationic form) and/or may be in elemental form. In some embodiments, the diatomite particles are configured to scavenge contaminants such that the amount of the contaminant within the electrolyte is below a certain amount. For instance, the diatomite particles may be configured to scavenge one or more of the above-referenced contaminants in an amount such that the amount of the above-referenced contaminant(s) in the electrolyte is less than or equal to 150 ppm, less than or equal to 125 ppm, less than or equal to 100 ppm, less than or equal to 80 ppm, less than or equal to 60 ppm, less than or equal to 50 ppm, less than or equal to 40 ppm, less than or equal to 30 ppm, less than or equal to 20 ppm, less than or equal to 15 ppm, less than or equal to 10 ppm, less than or equal to 8 ppm, less than or equal to 6 ppm, less than or equal to 5 ppm, less than or equal to 4 ppm, less than or equal to 3 ppm, or less than or equal to 2 ppm. In some embodiments, the diatomite particles are configured to scavenge one or more of the above-referenced contaminants in an amount such that the amount of the above-referenced contaminant(s) in the electrolyte is greater than or equal to 1 ppm, greater than or equal to 2 ppm, greater than or equal to 3 ppm, greater than or equal to 4 ppm, greater than or equal to 5 ppm, greater than or equal to 6 ppm, greater than or equal to 8 ppm, greater than or equal to 10 ppm, greater than or equal to 15 ppm, greater than or equal to 20 ppm, greater than or equal to 30 ppm, greater than or equal to 40 ppm, greater than or equal to 50 ppm, greater than or equal to 60 ppm, greater than or equal to 80 ppm, greater than or equal to 100 ppm, or greater than or equal to 125 ppm. Combinations of the above-referenced ranges are also possible (e.g., less than or equal to 150 ppm and greater than or equal to 10 ppm, less than or equal to 100 ppm and greater than or equal to 10 ppm, less than or equal to 100 ppm and greater than or equal to 20 ppm, less than or equal to 80 ppm and greater than or equal to 20 ppm, less than or equal to 80 ppm and greater than or equal to 30 ppm, less than or equal to 60 ppm and greater than or equal to 30 ppm, less than or equal to 50 ppm and greater than or equal to 1 ppm, less than or equal to 30 ppm and greater than or equal to 2 ppm, less than or equal to 20 ppm and greater than or equal to 1 ppm, less than or equal to 20 ppm and greater than or equal to 2 ppm, less than or equal to 20 ppm and greater than or equal to 3 ppm, less than or equal to 15 ppm and greater than or equal to 2 ppm, less than or equal to 10 ppm and greater than or equal to 1 ppm, less than or equal to 10 ppm and greater than or equal to 3 ppm, less than or equal to 10 ppm and greater than or equal to 5 ppm, less than or equal to 8 ppm and greater than or equal to 2 ppm, or less than or equal to 6 ppm and greater than or equal to 3 ppm), Other ranges are also possible.

The amount of a particular type of contaminant in the electrolyte may be determined by assembling a lead-acid battery including the diatomite particles, performing a formation step, and then cycling the lead-acid battery for 50 cycles to 100% depth of discharge at a 2 hour discharge rate. The cycling may be performed according to the procedure described in BCIS 06, Rev. December 2002. After cycling, the lead-acid battery may be disassembled and the electrolyte analyzed to assess the amount of contaminant by following the procedure described in BCIS 03A, Rev. December 2015.

As described elsewhere herein, in some embodiments, a pasting paper as described herein, an additional layer (e.g., a layer disposed on a non-woven fiber web, an additional layer that is a capacitance layer), or a stand-alone layer (e.g., a stand-alone layer that is a capacitance layer) is configured to be disposed on a battery plate and/or is disposed on a battery plate. In some such embodiments, the pasting paper, the additional layer, or the stand-alone layer may include a relatively low amount of diatomite particles in comparison to the active mass in the battery plate. A ratio of a weight of the plurality of diatomite particles to a weight of the active mass in the battery plate may be less than or equal to 1:5, less than or equal to 1:7.5, less than or equal to 1:10, less than or equal to 1:15, less than or equal to 1:20, less than or equal to 1:30, less than or equal to 1:40, less than or equal to 1:50, less than or equal to 1:75, less than or equal to 1:100, or less than or equal to 1:150. The ratio of the weight of the plurality of diatomite particles to the weight of the active mass in the battery plate may be greater than or equal to 1:200, greater than or equal to 1:150, greater than or equal to 1:100, greater than or equal to 1:75, greater than or equal to 1:50, greater than or equal to 1:40, greater than or equal to 1:30, greater than or equal to 1:20, greater than or equal to 1:15, greater than or equal to 1:10, or greater than or equal to 1:7.5. Combinations of the above-referenced ranges are also possible (e.g., less than or equal to 1:5 and greater than or equal to 1:200, or less than or equal to 1:10 and greater than or equal to 1:50). Other ranges are also possible.

As described above, in some embodiments, a pasting paper or a capacitance layer may comprise a non-woven fiber web or a resinous layer comprising a plurality of rubber particles. In some embodiments, an additional layer (e.g., a layer disposed on a non-woven fiber web) and/or a stand-alone layer (e.g., a stand-alone layer that is a capacitance layer) comprise a plurality of rubber particles. When present in a non-woven fiber web, a pasting paper, or a capacitance layer, the rubber particles may be positioned in a non-woven fiber web (i.e., a non-woven fiber web may comprise a plurality of rubber particles) and/or may be positioned in an additional layer (e.g., a layer disposed on a non-woven fiber web may comprise a plurality of rubber particles).

In some embodiments, rubber particles may be positioned in a non-woven fiber web (i.e., a non-woven fiber web may comprise a plurality of rubber particles, such as a non-woven fiber web that is a pasting paper or a non-woven fiber web that is a capacitance layer), may be positioned in a resinous layer (i.e., a resinous layer may comprise a plurality of rubber particles dispersed within a binder resin, such as a resinous layer comprising a binder resin with rubber particles dispersed within the binder resin), may be positioned in an additional layer (e.g., a layer disposed on a non-woven fiber web may comprise a plurality of rubber particles, an additional layer that is a capacitance layer may comprise a plurality of rubber particles), and/or may be positioned in a stand-alone layer (e.g., a stand-alone layer that is a capacitance layer may comprise a plurality of rubber particles).

When present in a non-woven fiber web or a pasting paper (e.g., a layer disposed on a non-woven fiber web, an additional layer that is a resinous layer comprising a binder resin with rubber particles dispersed within the binder resin), the rubber particles may make up any suitable amount of the non-woven fiber web or the pasting paper. The rubber particles may make up greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, or greater than or equal to 30 wt % of the non-woven fiber web or the pasting paper. The rubber particles may make up less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, or less than or equal to 0.2 wt % of the non-woven fiber web or the pasting paper. Combinations of the above-referenced ranges are also possible (e.g., greater than or equal to 0.1 wt % and less than or equal to 40 wt %, greater than or equal to 0.5 wt % and less than or equal to 10 wt %, or greater than or equal to 1 wt % and less than or equal to 5 wt %). Other ranges are also possible. In some embodiments, the ranges above for weight percentage are based on the total weight of the non-woven fiber web or the pasting paper. For example, the rubber particles may be present in an amount of greater than or equal to 0.1 wt % and less than or equal to 40 wt % of the total weight of the non-woven fiber web or the pasting paper.

In some embodiments, a pasting paper may comprise a non-woven fiber web with an amount of rubber particles in one or more of the ranges described above with respect to the total weight of the non-woven fiber web. Such pasting papers may further comprise an additional layer, such as a layer disposed on (e.g., adjacent) the non-woven fiber web. In some embodiments, a pasting paper may comprise a non-woven fiber web comprising rubber particles and an additional layer, and the pasting paper as a whole may have an amount of rubber particles in one or more of the ranges described above with respect to the total weight of the pasting paper. In some embodiments, a pasting paper may comprise a non-woven fiber web and an additional layer, the additional layer may comprise rubber particles, and the pasting paper as a whole may have an amount of rubber particles in one or more of the ranges described above with respect to the total weight of the pasting paper. In some embodiments, a stand-alone layer comprising rubber particles is provided, such as a stand-alone layer capacitance layer. In some embodiments, the additional layer or the stand-alone layer may be a resinous layer comprising a binder resin with the rubber particles dispersed within the binder resin.

When present in an additional layer (e.g., a layer disposed on a non-woven fiber web, an additional layer that is a capacitance layer, an additional layer that is a non-woven fiber web comprising rubber particles, an additional layer that is a resinous layer comprising a binder resin with rubber particles dispersed within the binder resin) or a stand-alone layer (e.g., a stand-alone layer that is a capacitance layer, a stand-alone layer that is a non-woven fiber web comprising rubber particles, a stand-alone layer that is a resinous layer comprising a binder resin with rubber particles dispersed within the binder resin), the rubber particles may make up any suitable amount of the additional layer or the stand-alone layer. The rubber particles may make up greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, or greater than or equal to 30 wt % of the additional layer or the stand-alone layer. The rubber particles may make up less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, or less than or equal to 0.2 wt % of the additional layer or the stand-alone layer. Combinations of the above-referenced ranges are also possible (e.g., greater than or equal to 0.1 wt % and less than or equal to 40 wt %, greater than or equal to 0.5 wt % and less than or equal to 10 wt %, or greater than or equal to 1 wt % and less than or equal to 5 wt %). Other ranges are also possible. The ranges above for weight percentage are based on the total dry weight of the additional layer or the stand-alone layer. For example, the rubber particles may be present in an amount of greater than or equal to 0.1 wt % and less than or equal to 40 wt % of the total dry weight of the additional layer or the stand-alone layer.

When present, the rubber particles may comprise any suitable types of rubber particles. In some embodiments, the rubber particles comprise natural rubber. The natural rubber may include smoked sheet rubber, pale crepe rubber, blanket crepe rubber, brown crepe rubber, amber crepe rubber, flat bark crepe rubber, Hevea brasiliensis rubber, and/or a latex of natural rubber. In some embodiments, the rubber particles comprise synthetic rubber. The synthetic rubber may include styrene-butadiene rubber, acrylonitrile butadiene rubber, poly(butyldiene) rubber, poly(isoprene) rubber, nitrile rubber, butyl rubber, ethylene-propylene rubber, silicone rubber, poly(sulfide) rubber, and/or poly(acrylate) rubber. Rubber particles may comprise cured rubber and/or uncured rubber. It should be understood that a plurality of rubber particles may comprise one or more of the types of rubber particles described herein.

When present, the rubber particles may have any suitable average diameter. The average diameter of the rubber particles may be greater than or equal to 1 micron, greater than or equal to 2 microns, greater than or equal to 3 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, or greater than or equal to 80 microns. The average diameter of the rubber particles may be less than or equal to 100 microns, less than or equal to 80 microns, less than or equal to 70 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 3 microns, or less than or equal to 2 microns. Combinations of the above-referenced ranges are also possible (e.g., greater than or equal to 1 micron and less than or equal to 100 microns, greater than or equal to 2 microns and less than or equal to 40 microns, or greater than or equal to 3 microns and less than or equal to 20 microns). Other ranges are also possible. The average diameter of the rubber particles may be measured by transmission electron microscopy and/or by scanning electron microscopy. Unless otherwise specified, references to an average diameter of the rubber particles should be understood to refer to a number average diameter of the rubber particles. For the purpose of calculating the average diameter of the rubber particles, rubber particles that are not spherical are considered to have a diameter that is the average of their shortest diameter and their longest diameter.

In some embodiments, a pasting paper or a capacitance layer may comprise a non-woven fiber web comprising a plurality of species comprising barium oxide. In some embodiments, an additional layer (e.g., a layer disposed on a non-woven fiber web) and/or a stand-alone layer (e.g., a stand-alone layer that is a capacitance layer) comprises a plurality of species comprising barium oxide. When present in a non-woven fiber web, a pasting paper, or a capacitance layer, the species comprising barium oxide may be positioned in a non-woven fiber web (i.e., a non-woven fiber web may comprise a plurality of species comprising barium oxide) and/or may be positioned in an additional layer (e.g., a layer disposed on a non-woven fiber web may comprise a plurality of species comprising barium oxide). The species comprising barium oxide may include fibers comprising barium oxide and/or particles comprising barium oxide. Species comprising barium oxide, if present, may leach barium ions into an electrolyte (e.g., sulfuric acid, such as 1.28 spg sulfuric acid) when the pasting paper, non-woven fiber web, and/or additional layer is positioned within a battery. The leached barium ions may advantageously react in the electrolyte to form barium sulfate.

In some embodiments, species comprising barium oxide may be positioned in a non-woven fiber web (i.e., a non-woven fiber web may comprise a plurality of species comprising barium oxide, such as a non-woven fiber web that is a pasting paper or a non-woven fiber web that is a capacitance layer), may be positioned in a resinous layer (i.e., a resinous layer may comprise a plurality of species comprising barium oxide dispersed within a binder resin, such as a resinous layer comprising a binder resin with the species comprising barium oxide dispersed within the binder resin), may be positioned in an additional layer (e.g., a layer disposed on a non-woven fiber web may comprise a plurality of species comprising barium oxide, an additional layer that is a capacitance layer may comprise a plurality of species comprising barium oxide), and/or may be positioned in a stand-alone layer (e.g., a stand-alone layer that is a capacitance layer may comprise a plurality of species comprising barium oxide).

In some embodiments, one or more of a pasting paper, a capacitance layer, a non-woven fiber web, a resinous layer, an additional layer (e.g., a layer disposed on a non-woven fiber web), and/or a stand-alone layer (e.g., a stand-alone layer that is a capacitance layer) may, as a whole, comprise an advantageous amount of barium oxide. The pasting paper, the capacitance layer, the non-woven fiber web, the resinous layer, the additional layer, and/or the stand-alone layer may each independently comprise barium oxide in an amount of greater than or equal to 0.1 wt %, greater than or equal to 0.2 wt %, greater than or equal to 0.5 wt %, greater than or equal to 0.7 wt %, greater than or equal to 1 wt %, greater than or equal to 2 wt %, greater than or equal to 5 wt %, or greater than or equal to 7 wt % of the pasting paper, the capacitance layer, the non-woven fiber web, the resinous layer, the additional layer, and/or the stand-alone layer. The pasting paper, the capacitance layer, the non-woven fiber web, the resinous layer, the additional layer, and/or the stand-alone layer may each independently comprise barium oxide in an amount of less than or equal to 10 wt %, less than or equal to 7 wt %, less than or equal to 5 wt %, less than or equal to 2 wt %, less than or equal to 1 wt %, less than or equal to 0.7 wt %, less than or equal to 0.5 wt %, or less than or equal to 0.2 wt % of the pasting paper, the capacitance layer the non-woven fiber web, the resinous layer, the additional layer, and/or the stand-alone layer. Combinations of the above-referenced ranges are also possible (e.g., greater than or equal to 0.1 wt % and less than or equal to 10 wt % of the pasting paper, the capacitance layer, the non-woven fiber web, the resinous layer, the additional layer, and/or the stand-alone layer). In some embodiments, the pasting paper, the capacitance layer, the non-woven fiber web, the resinous layer, the additional layer, and/or the stand-alone layer comprise barium oxide in an amount of 0 wt %. Other ranges are also possible. In some embodiments, the ranges above for weight percentage are based on the total weight of the non-woven fiber web or the pasting paper. For example, the barium oxide may be present in an amount of greater than or equal to 0.1 wt % and less than or equal to 10 wt % of the total weight of the non-woven fiber web or the pasting paper. In some embodiments, the ranges above for weight percentage are based on the total dry weight of the capacitance layer, the resinous layer, the additional layer, or the stand-alone layer. For example, the barium oxide may be present in an amount of greater than or equal to 0.1 wt % and less than or equal to 10 wt % of the total dry weight of the capacitance layer, the resinous layer, the additional layer, or the stand-alone layer.

In some embodiments, one or more of a pasting paper, a capacitance layer, a non-woven fiber web, a resinous layer, an additional layer (e.g., a layer disposed on a non-woven fiber web), and a stand-alone layer (e.g., a stand-alone layer that is a capacitance layer) may comprise a plurality of fibers comprising barium oxide. The fibers comprising barium oxide may make up greater than or equal to 1%, greater than or equal to 2%, greater than or equal to 5%, greater than or equal to 10%, greater than or equal to 20%, greater than or equal to 50%, greater than or equal to 75%, greater than or equal to 90%, greater than or equal to 95%, greater than or equal to 99%, or greater than or equal to 99.9% of the pasting paper, the capacitance layer, the non-woven fiber web, the resinous layer, the additional layer, and/or the stand-alone layer. In some embodiments, the fibers comprising barium oxide may make up less than or equal to 100%, less than or equal to 99.9%, less than or equal to 99%, less than or equal to 95%, less than or equal to 90%, less than or equal to 75%, less than or equal to 50%, less than or equal to 20%, less than or equal to 10%, less than or equal to 5%, or less than or equal to 2% of the pasting paper, the capacitance layer, the non-woven fiber web, the resinous layer, the additional layer, and/or the stand-alone layer. Combinations of the above-referenced ranges are also possible (e.g., greater than or equal to 1% and less than or equal to 100% of the total amount of fibers). In some embodiments, fibers comprising barium oxide make up 0 wt % of the pasting paper, the capacitance layer, the non-woven fiber web, the resinous layer, and/or the additional layer. Other ranges are also possible. In some embodiments, the ranges above for weight percentage are based on the total weight of the non-woven fiber web or the pasting paper. For example, the fibers comprising barium oxide may be present in an amount of greater than or equal to 0.1 wt % and less than or equal to 10 wt % of the total weight of the non-woven fiber web or the pasting paper. In some embodiments, the ranges above for weight percentage are based on the total amount of fibers in the non-woven fiber web or the pasting paper. For example, the fibers comprising barium oxide may be present in an amount of greater than or equal to 0.1 wt % and less than or equal to 10 wt % of the total amount of fibers in the non-woven fiber web or the pasting paper. In some embodiments, the ranges above for weight percentage are based on the total dry weight of the capacitance layer, the resinous layer, the additional layer, or the stand-alone layer. For example, the fibers comprising barium oxide may be present in an amount of greater than or equal to 0.1 wt % and less than or equal to 10 wt % of the total dry weight of the capacitance layer, the resinous layer, the additional layer, or the stand-alone layer.

In some embodiments, one or more of a pasting paper, a capacitance layer, a non-woven fiber web, a resinous layer, an additional layer (e.g., a layer disposed on a non-woven fiber web, a stand-alone additional layer, a capacitance layer), and/or a stand-alone layer (e.g., a capacitance layer) may comprise a plurality of fibers. The plurality of fibers may comprise an advantageous amount of barium oxide. In some embodiments, the fibers comprise barium oxide in an amount of greater than or equal to 0.1 wt %, greater than or equal to 0.2 wt %, greater than or equal to 0.5 wt %, greater than or equal to 0.7 wt %, greater than or equal to 1 wt %, greater than or equal to 2 wt %, greater than or equal to 5 wt %, or greater than or equal to 7 wt % of the fibers. In some embodiments, the fibers comprise barium oxide in an amount of less than or equal to 10 wt %, less than or equal to 7 wt %, less than or equal to 5 wt %, less than or equal to 2 wt %, less than or equal to 1 wt %, less than or equal to 0.7 wt %, less than or equal to 0.5 wt %, or less than or equal to 0.2 wt % of the fibers. Combinations of the above-referenced ranges are also possible (e.g., greater than or equal to 0.1 wt % and less than or equal to 10 wt % of the fibers). In some embodiments, the plurality of fibers in the pasting paper, the plurality of fibers in the non-woven fiber web, the plurality of fibers in the resinous layer, the plurality of fibers in the additional layer, the plurality of fibers in the capacitance layer, and/or the plurality of the fibers in the stand-alone layer include comprise 0 wt % barium oxide. Other ranges are also possible.

When present, the fibers comprising barium oxide may be glass fibers comprising barium oxide. For example, the fibers comprising barium oxide may be glass fibers that are suitable for a battery environment, such as C glass fibers (e.g., Lauscha C glass fibers, JM 253 C glass fibers). In some embodiments, glass fibers comprising barium oxide further comprise one or more additional oxides, non-limiting examples of which include SiO₂ (e.g., in an amount of greater than or equal to 62 wt % and less than or equal to 70 wt %), Al₂O₃ (e.g., in an amount of greater than or equal to 2 wt % and less than or equal to 5 wt %), B₂O₃ (e.g., in an amount of greater than or equal to 3 wt % and less than or equal to 6 wt %), and NaO (e.g., in an amount of greater than or equal to 10 wt % and less than or equal to 15 wt %). Other types of oxides may be present, and the above-referenced oxides may be present in other amounts.

As described elsewhere herein, in some embodiments a pasting paper, a capacitance layer, a non-woven fiber web, a resinous layer, an additional layer (e.g., a layer disposed on a non-woven fiber web, an additional layer that is a capacitance layer), or a stand-alone layer (e.g., a stand-alone layer that is a capacitance layer) comprise both particles and fibers. The relative amounts of all of the particles and all of the fibers in the pasting paper, the capacitance layer, the non-woven fiber web, the resinous layer, the additional layer, or and the stand-alone layer may generally be selected as desired. In other words, the relative amounts of the total amount of particles (e.g., the total amount of particles that are conductive particles, capacitive particles, inorganic particles, and/or any other type of particle) and the total amount of fibers (e.g., glass fibers, multicomponent fibers, cellulose fibers, conductive fibers, capacitive fibers, and/or any other type of fiber) may be selected as desired.

For instance, the ratio of the weight of the particles in the pasting paper to the weight of the fibers in the pasting paper, the ratio of the weight of the particles in the capacitance layer to the weight of the fibers in the capacitance layer, the ratio of the weight of the particles in the non-woven fiber web to the weight of the fibers in the non-woven fiber web, the ratio of the weight of the particles in the resinous layer to the weight of the fibers in the resinous layer, the ratio of the weight of the particles in the additional layer to the weight of the fibers in the additional layer, and/or the ratio of the weight of the particles in the stand-alone layer to the weight of the fibers in the stand-alone layer may each independently be greater than or equal to 1:99, greater than or equal to 2:98, greater than or equal to 5:95, greater than or equal to 10:90, greater than or equal to 20:80, greater than or equal to 50:50, greater than or equal to 80:20, greater than or equal to 90:10, greater than or equal to 95:5, or greater than or equal to 98:2. The ratio of the weight of the particles in the pasting paper to the weight of the fibers in the pasting paper, the ratio of the weight of the particles in the capacitance layer to the weight of the fibers in the capacitance layer, the ratio of the weight of the particles in the non-woven fiber web to the weight of the fibers in the non-woven fiber web, the ratio of the weight of the particles in the resinous layer to the weight of the fibers in the resinous layer, the ratio of the weight of the particles in the additional layer to the weight of the fibers in the additional layer, and/or the ratio of the weight of the particles in the stand-alone layer to the weight of the fibers in the stand-alone layer may each independently be less than or equal to 99:1, less than or equal to 98:2, less than or equal to 95:5, less than or equal to 90:10, less than or equal to 80:20, less than or equal to 50:50, less than or equal to 20:80, less than or equal to 10:90, less than or equal to 5:95, or less than or equal to 2:98. Combinations of the above-referenced ranges are also possible (e.g., greater than or equal to 1:99 and less than or equal to 99:1). In some embodiments, the non-woven fiber web and/or the pasting paper may include 0 wt % particles. In some embodiments, the capacitance layer, the resinous layer, the additional layer, and/or the stand-alone layer may include 0 wt % fibers. Other ranges are also possible. A pasting paper may comprise a non-woven fiber web and an additional layer, and the ratio of the weight of the particles in the non-woven fiber web to the weight of the fibers in the non-woven fiber web may be greater than the ratio of the weight of the particles in the additional layer to the weight of the fibers in the additional layer.

As described above, in some embodiments, a pasting paper or a capacitance layer may comprise a non-woven fiber web comprising a plurality of microcapsules. In some embodiments, an additional layer (e.g., a layer disposed on a non-woven fiber web) and/or a stand-alone layer (e.g., a stand-alone layer that is a capacitance layer) comprise a plurality of microcapsules. When present in a non-woven fiber web, a pasting paper, or a capacitance layer, microcapsules may be positioned in a non-woven fiber web (i.e., a non-woven fiber web may comprise a plurality of microcapsules) and/or may be positioned in an additional layer (e.g., a layer disposed on a non-woven fiber web may comprise a plurality of microcapsules).

In some embodiments, microcapsules may be positioned in a non-woven fiber web (i.e., a non-woven fiber web may comprise a plurality of microcapsules, such as a non-woven fiber web that is a pasting paper or a non-woven fiber web that is a capacitance layer), may be positioned in a resinous layer (i.e., a resinous layer may comprise a plurality of microcapsules dispersed within a binder resin, such as a resinous layer comprising a binder resin with microcapsules dispersed within the binder resin), may be positioned in an additional layer (e.g., a layer disposed on a non-woven fiber web may comprise a plurality of microcapsules, an additional layer that is a capacitance layer may comprise a plurality of microcapsules), and/or may be positioned in a stand-alone layer (e.g., a stand-alone layer that is a capacitance layer may comprise a plurality of microcapsules).

When present in a non-woven fiber web or a pasting paper, the microcapsules may make up any suitable amount of the non-woven fiber web or the pasting paper. The microcapsules may make up greater than or equal to 0.001 wt %, greater than or equal to 0.002 wt %, greater than or equal to 0.005 wt %, greater than or equal to 0.0075 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, or greater than or equal to 40 wt % of the non-woven fiber web or the pasting paper. The microcapsules may make up less than or equal to 50 wt %, less than or equal to 40 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.02 wt %, less than or equal to 0.01 wt %, less than or equal to 0.0075 wt %, less than or equal to 0.005 wt %, or less than or equal to 0.002 wt % of the non-woven fiber web or the pasting paper. Combinations of the above-referenced ranges are also possible (e.g., greater than or equal to 0.001 wt % and less than or equal to 50 wt %, greater than or equal to 0.01 wt % and less than or equal to 20 wt %, or greater than or equal to 0.1 wt % and less than or equal to 10 wt %). Other ranges are also possible. In some embodiments, the ranges above for weight percentage are based on the total weight of the non-woven fiber web or the pasting paper. For example, the microcapsules may be present in an amount of greater than or equal to 0.001 wt % and less than or equal to 50 wt % of the total weight of the non-woven fiber web or the pasting paper.

In some embodiments, a pasting paper may comprise a non-woven fiber web with an amount of microcapsules in one or more of the ranges described above with respect to the total weight of the non-woven fiber web. Such pasting papers may further comprise an additional layer, such as a layer disposed on (e.g., adjacent) the non-woven fiber web. In some embodiments, a pasting paper may comprise a non-woven fiber web comprising microcapsules and an additional layer, and the pasting paper as a whole may have an amount of microcapsules in one or more of the ranges described above with respect to the total weight of the pasting paper. In some embodiments, a pasting paper may comprise a non-woven fiber web and an additional layer, the additional layer may comprise microcapsules, and the pasting paper as a whole may have an amount of microcapsules in one or more of the ranges described above with respect to the total weight of the pasting paper. In some embodiments, a stand-alone layer comprising capacitive particles is provided, such as a stand-alone capacitance layer. In some embodiments, the additional layer may be a resinous layer comprising a binder resin with the diatomite particles dispersed within the binder resin.

When present in an additional layer (e.g., a layer disposed on a non-woven fiber web, an additional layer that is a capacitance layer, an additional layer that is a non-woven fiber web comprising microcapsules, an additional layer that is a resinous layer comprising a binder resin with microcapsules dispersed within the binder resin) or a stand-alone layer (e.g., a stand-alone layer that is a capacitance layer, a stand-alone layer that is a non-woven fiber web comprising microcapsules, a stand-alone layer that is a resinous layer comprising a binder resin with rubber particles dispersed within the binder resin), the microcapsules may make up any suitable amount of the additional layer or the stand-alone layer. The microcapsules may make up greater than or equal to 0.001 wt %, greater than or equal to 0.002 wt %, greater than or equal to 0.005 wt %, greater than or equal to 0.0075 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, or greater than or equal to 40 wt % of the additional layer or the stand-alone layer. The microcapsules may make up less than or equal to 50 wt %, less than or equal to 40 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.02 wt %, less than or equal to 0.01 wt %, less than or equal to 0.0075 wt %, less than or equal to 0.005 wt %, or less than or equal to 0.002 wt % of the additional layer or the stand-alone layer. Combinations of the above-referenced ranges are also possible (e.g., greater than or equal to 0.001 wt % and less than or equal to 50 wt %, greater than or equal to 0.01 wt % and less than or equal to 20 wt %, or greater than or equal to 0.1 wt % and less than or equal to 10 wt %). Other ranges are also possible. The ranges above for weight percentage are based on the total dry weight of the additional layer or the stand-alone layer. For example, the microcapsules may be present in an amount of greater than or equal to 0.001 wt % and less than or equal to 50 wt % of the total dry weight of the additional layer or the stand-alone layer.

When present, the microcapsules may have any suitable design. In some embodiments, the microcapsules comprise a coating that encapsulates an active agent. The coating may be configured to allow the active agent to be transported out of the microcapsule and into an electrolyte to which the microcapsule is exposed over a period of time (e.g., it may comprise pores through which the active agent may be transported; it may be configured to undergo degradation and/or dissolution over a period of time, after which the active agent is transported therethrough). In some embodiments, the coating comprises a polymer, such as ethyl cellulose, poly(vinyl alcohol), gelatin, and/or sodium alginate. The coating may encapsulate any suitable active agent, including compositions described elsewhere herein as suitable for inclusion in a pasting paper, non-woven fiber web, additional layer, or stand-alone layer. For instance, a microcapsule may comprise a rubber (e.g., natural rubber, a latex of natural rubber), a metal oxide, and/or glass. Further examples of suitable active agents that may be encapsulated in a microcapsule include metal sulfates (e.g., sodium sulfate, magnesium sulfate, potassium sulfate, copper sulfate, tin sulfate, bismuth sulfate) and phosphoric acid. It should be understood that a plurality of microcapsules may comprise one or more of the types of microcapsules described herein.

When present, the microcapsules may include a coating any suitable amount. In some embodiments, the microcapsules include a coating that makes up greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 75 wt %, greater than or equal to 90 wt %, or greater than or equal to 95 wt % of the microcapsules. In some embodiments, the microcapsules include a coating that makes up less than or equal to 99 wt %, less than or equal to 95 wt %, less than or equal to 90 wt %, less than or equal to 75 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, or less than or equal to 0.2 wt %. Combinations of the above-referenced ranges are also possible (e.g., greater than or equal to 0.1 wt % and less than or equal to 90 wt %, greater than or equal to 0.5 wt % and less than or equal to 50 wt %, or greater than or equal to 1 wt % and less than or equal to 10 wt %). Other ranges are also possible.

When present, the microcapsules may have any suitable average diameter. The average diameter of the microcapsules may be greater than or equal to 0.5 microns, greater than or equal to 0.75 microns, greater than or equal to 1 micron, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, or greater than or equal to 8 microns. The average diameter of the microcapsules may be less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, or less than or equal to 0.75 microns. Combinations of the above-referenced ranges are also possible (e.g., greater than or equal to 0.5 micron and less than or equal to 10 microns, greater than or equal to 0.5 microns and less than or equal to 5 microns, or greater than or equal to 0.1 micron and less than or equal to 2 microns). Other ranges are also possible. The average diameter of the microcapsules may be measured by transmission electron microscopy and/or by scanning electron microscopy. Unless otherwise specified, references to an average diameter of the microcapsules should be understood to refer to a number average diameter of the microcapsules. For the purpose of calculating the average diameter of the microcapsules, microcapsules that are not spherical are considered to have a diameter that is the average of their shortest diameter and their longest diameter.

When present, the microcapsules may comprise a coating have any suitable average pore size. The mean flow pore size of the coating may be greater than or equal to 20 nm, greater than or equal to 50 nm, greater than or equal to 75 nm, greater than or equal to 100 nm, greater than or equal to 150 nm, greater than or equal to 200 nm, greater than or equal to 250 nm, greater than or equal to 300 nm, greater than or equal to 350 nm, greater than or equal to 400 nm, or greater than or equal to 450 nm. The average pore size of the coating may be less than or equal to 500 nm, less than or equal to 450 nm, less than or equal to 400 nm, less than or equal to 350 nm, less than or equal to 300 nm, less than or equal to 250 nm, less than or equal to 200 nm, less than or equal to 150 nm, less than or equal to 100 nm, less than or equal to 75 nm, or less than or equal to 50 nm. Combinations of the above-referenced ranges are also possible (e.g., greater than or equal to 20 nm and less than or equal to 500 nm). Other ranges are also possible. The average pore size of the coating may be measured by transmission electron microscopy and/or by scanning electron microscopy. Unless otherwise specified, references to an average diameter of the coating should be understood to refer to a number average pore size of the coating. For the purpose of calculating the average pore size of the coating, pores that are open pores (i.e., pores fluidically connected to an environment external to the coating) are considered to have a pore size equivalent to the longest line segment that may be drawn through the pore that is perpendicular to the surface of the coating. Pores that are closed pores (i.e., pores not fluidically connected to an environment external to the coating) are considered to have a pore size that is the average of their shortest diameter and their longest diameter.

As described above, in some embodiments, a non-woven fiber web, a pasting paper, or a capacitance layer as described herein may contain a relatively low amount of binder resin; however, other embodiments are also possible. When present, binder resin may be positioned in a non-woven fiber web (i.e., a non-woven fiber web may comprise a binder resin, such as a non-woven fiber web that is a pasting paper or a non-woven fiber web that is a capacitance layer), may be positioned in an additional (e.g., as described in further detail below, a layer disposed on a non-woven fiber web may comprise a binder resin, an additional layer that is a capacitance layer may comprise a binder resin), and/or may be positioned in a stand-alone layer (e.g., a stand-alone layer that is a capacitance layer may comprise a binder resin).

When present in a non-woven fiber web or a pasting paper, the binder resin may make up less than or equal to 30 wt %, less than or equal to 20 wt %, less than or equal to 15 wt %, less than or equal to 10 wt %, less than or equal to 7 wt %, less than or equal to 5 wt %, less than or equal to 3 wt %, less than or equal to 2 wt %, less than or equal to 1 wt %, less than or equal to 0.5 wt %, or less than or equal to 0.2 wt % of the non-woven fiber web or the pasting paper. In some embodiments, the binder resin may make up greater than or equal to 0.1 wt %, greater than or equal to 0.2 wt %, greater than or equal to 0.5 wt %, greater than or equal to 1 wt %, greater than or equal to 2 wt %, greater than or equal to 3 wt %, greater than or equal to 5 wt %, greater than or equal to 7 wt %, greater than or equal to 10 wt %, greater than or equal to 15 wt %, or greater than or equal to 20 wt % of the non-woven fiber web or the pasting paper. Combinations of the above-referenced ranges are also possible (e.g., greater than or equal to 0.1 wt % and less than or equal to 10 wt % of the non-woven fiber web or the pasting paper, greater than or equal to 0.5 wt % and less than or equal to 30 wt % of the non-woven fiber web or the pasting paper, greater than or equal to 0.5 wt % and less than or equal to 5 wt % of the non-woven fiber web or the pasting paper, greater than or equal to 1 wt % and less than or equal to 15 wt % of the non-woven fiber web or the pasting paper, greater than or equal to 1 wt % and less than or equal to 2 wt % of the non-woven fiber web or the pasting paper, or greater than or equal to 3 wt % and less than or equal to 10 wt % of the non-woven fiber web or the pasting paper). In some embodiments, the non-woven fiber web or the pasting paper includes 0 wt % binder resin. Other ranges are also possible. The ranges above for weight percentage are based on the total weight of the non-woven fiber web or the pasting paper. For example, the binder resin may be present in an amount of greater than or equal to 0.1 wt % and less than or equal to 10 wt % of the total weight of the non-woven fiber web or the pasting paper.

In some embodiments, a pasting paper may comprise a non-woven fiber web with an amount of binder resin in one or more of the ranges described above with respect to the total weight of the non-woven fiber web. Such pasting papers may further comprise an additional layer, such as a layer disposed on (e.g., adjacent) the non-woven fiber web and/or an additional layer that is a capacitance layer. In some embodiments, a pasting paper may comprise a non-woven fiber web comprising a binder resin and an additional layer (e.g., comprising the same or a different binder resin, lacking a binder resin), and the pasting paper as a whole may have an amount of binder resin in one or more of the ranges described above with respect to the total weight of the pasting paper. In some embodiments, a pasting paper may comprise a non-woven fiber web and an additional layer, the additional layer may comprise a binder resin, and the pasting paper as a whole may have an amount of binder resin in one or more of the ranges described above with respect to the total weight of the pasting paper. In some embodiments, a stand-alone layer comprising a binder resin is provided (e.g., a stand-alone layer that is a capacitance layer)

When present in an additional layer (e.g., a layer disposed on a non-woven fiber web, an additional layer that is a capacitance layer, an additional layer that is a non-woven fiber web comprising the binder resin, an additional layer that is a resinous layer comprising the binder resin with one or more species dispersed within the binder resin) or a stand-alone layer (e.g., a stand-alone layer that is a capacitance layer, a stand-alone layer that is a non-woven fiber web comprising the binder resin, a stand-alone layer that is a resinous layer comprising the binder resin with one or more species dispersed within the binder resin), the binder resin may make up any suitable amount of the additional layer or the stand-alone layer. The binder resin may make up greater than or equal to 0.5 wt %, greater than or equal to 1 wt %, greater than or equal to 2 wt %, greater than or equal to 5 wt %, greater than or equal to 8 wt %, greater than or equal to 10 wt %, greater than or equal to 15 wt %, greater than or equal to 20 wt %, or greater than or equal to 25 wt % of the additional layer or the stand-alone layer. The binder resin may make up less than or equal to 30 wt %, less than or equal to 25 wt %, less than or equal to 20 wt %, less than or equal to 15 wt %, less than or equal to 10 wt %, less than or equal to 8 wt %, less than or equal to 5 wt %, less than or equal to 2 wt %, or less than or equal to 1 wt % of the additional layer or the stand-alone layer. Combinations of the above-referenced ranges are also possible (e.g., greater than or equal to 0.5 wt % and less than or equal to 30 wt % of the additional layer or the stand-alone layer, or greater than or equal to 5 wt % and less than or equal to 8 wt % of the additional layer or the stand-alone layer). Other ranges are also possible. The ranges above for weight percentage are based on the total dry weight of the additional layer or the stand-alone layer. For example, the binder resin may be present in an amount of greater than or equal to 0.5 wt % and less than or equal to 30 wt % of the additional layer or the stand-alone layer.

As described above, a pasting paper may comprise a resinous layer comprising a binder resin and one or more species dispersed within the binder resin. The resinous layer may be disposed on a non-woven fiber web (i.e., it may be a layer positioned on an outer surface of the non-woven fiber web) and/or may be a non-woven fiber web. In some embodiments, a stand-alone layer comprises a binder resin and one or more species dispersed within the binder resin. The one or more species dispersed within the binder resin may include a plurality of conductive species (e.g., a plurality of conductive fibers, a plurality of conductive particles), a plurality of capacitive species (e.g., a plurality of capacitive fibers, a plurality of capacitive particles), a plurality of inorganic particles (e.g., silica particles, barium sulfate particles), a plurality of diatomite particles, a plurality of particles configured to reduce hydrogen generation (e.g., a plurality of rubber particles), a plurality of microcapsules, a plurality of cellulose fibers, a plurality of synthetic fibers, a plurality of multicomponent fibers, and/or a plurality of glass fibers. The resinous layer may comprise one or more of these species in one or more of the ranges described above with respect to the weight of the resinous layer.

When present, the binder resin may comprise any suitable materials. In some embodiments, a binder resin may comprise a polymer, such as a synthetic polymer and/or a natural polymer. Non-limiting examples of suitable synthetic polymers include fluoropolymers (e.g., poly(tetrafluoroethylene), poly(vinylidene difluoride)), styrene-butadiene, acrylic polymers (e.g., poly(acrylic acid), poly(acrylate esters)), poly(vinyl alcohol), poly(2-ethyl-2-oxazoline), and carboxymethyl cellulose. One non-limiting example of a suitable natural polymer is natural rubber. It should be understood that a binder resin may comprise one or more of the types of binder resins described herein.

When present in a non-woven fiber web and/or in an additional layer positioned on a non-woven fiber web, the binder resin may be applied to the non-woven fiber web in any suitable manner. For instance, the binder resin may be applied to the non-woven fiber web when present in a solution or in a suspension (e.g., for latex binders). The solution or suspension may further comprise water and/or an organic solvent. In some embodiments, a binder resin and one or more species (e.g., a plurality of conductive species, a plurality of capacitive species, a plurality of inorganic particles) may be applied together in a single step. The binder resin and the other species may be applied together by, for example, applying a composition comprising the binder resin and the other species to the non-woven fiber web, e.g., using a method described herein.

In some embodiments, a layer of a pasting paper as described herein may have one or more properties (e.g., tensile strength, wicking height, mean pore size, air permeability, water absorption, specific surface area, electrical conductivity, capacitance) that are advantageous. The layer may be a non-woven fiber web, or may be an additional layer. The additional layer may be a layer disposed on a non-woven fiber web, may be an additional layer that is a capacitance layer, may be an additional layer that is a non-woven fiber web, may be an additional layer that is a resinous layer comprising one or more species dispersed within a binder resin, may be an additional layer comprising a plurality of conductive species, may be an additional layer comprising a plurality of capacitive species, may be an additional layer comprising a plurality of inorganic particles, may be an additional layer comprising a plurality of diatomite particles, may be an additional layer comprising a plurality of particles configured to reduce hydrogen generation, and/or may be an additional layer comprising a plurality of microcapsules. In some embodiments, a stand-alone layer may have one or more properties that are advantageous. The stand-alone layer may be a stand-alone layer that is a capacitance layer, may be a stand-alone layer that is a non-woven fiber web, may be a stand-alone layer that is a resinous layer comprising one or more species dispersed within a binder resin, may be a stand-alone layer comprising a plurality of conductive species, may be a stand-alone layer comprising a plurality of capacitive species, may be a stand-alone layer comprising a plurality of inorganic particles, may be a stand-alone layer comprising a plurality of diatomite particles, may be a stand-alone layer comprising a plurality of particles configured to reduce hydrogen generation, and/or may be a stand-alone layer comprising a plurality of microcapsules.

In some embodiments, a pasting paper or capacitance layer as described herein may have one or more properties (e.g., tensile strength, wicking height, mean pore size, air permeability) that are advantageous. The pasting paper or capacitance layer with the advantageous properties may comprise a non-woven fiber web and, optionally, an additional layer as described herein. The pasting paper or capacitance layer may be, for example, a stand-alone pasting paper, a pasting paper combined with a battery plate or paste as described herein, a stand-alone capacitance layer, or a capacitance layer combined with a battery plate or paste as described herein. The one or more properties may be present in the pasting paper or capacitance layer prior to exposure to an electrolyte such as sulfuric acid (e.g., 1.28 spg sulfuric acid), or at any other suitable point in time (e.g., prior to incorporation into a battery, prior to battery cycling, prior to a certain number of battery cycles, at the end of battery life).

In some embodiments, a pasting paper and/or a non-woven fiber web as described herein may each independently have a dry tensile strength in the machine direction that is greater than or equal to 0.2 lbs/in, greater than or equal to 0.5 lbs/in, greater than or equal to 1 lb/in, greater than or equal to 2 lbs/in, or greater than or equal to 3 lbs/in. The pasting paper and/or the non-woven fiber web may each independently have a dry tensile strength in the machine direction of less than or equal to 5 lbs/in, less than or equal to 3 lbs/in, less than or equal to 2 lbs/in, less than or equal to 1 lb/in, or less than or equal to 0.5 lbs/in. Combinations of the above-referenced ranges are also possible (e.g., greater than or equal to 0.2 lbs/in and less than or equal to 5 lbs/in, greater than or equal to 0.5 lbs/in and less than or equal to 3 lbs/in, or greater than or equal to 1 lb/in and less than or equal to 2 lbs/in). Other ranges are also possible. The dry tensile strength of the pasting paper and/or the tensile strength of the non-woven fiber web may be determined in accordance with BCIS 03A, Rev. December 2015, Method 9.

In some embodiments, a pasting paper and/or a non-woven fiber web as described herein may have a relatively large 1.28 spg sulfuric acid wicking height (e.g., prior to exposure to 1.28 spg sulfuric acid). The 1.28 spg sulfuric acid wicking height of the pasting paper and/or the non-woven fiber web (e.g., prior to exposure to 1.28 spg sulfuric acid) may each independently be greater than or equal to 0.5 cm, greater than or equal to 1 cm, greater than or equal to 2 cm, greater than or equal to 3 cm, greater than or equal to 5 cm, greater than or equal to 7 cm, greater than or equal to 10 cm, greater than or equal to 13 cm, greater than or equal to 15 cm, or greater than or equal to 17 cm. The 1.28 spg sulfuric acid wicking height of the pasting paper and/or the non-woven fiber web (e.g., prior to exposure to 1.28 spg sulfuric acid) may each independently be less than or equal to 20 cm, less than or equal to 17 cm, less than or equal to 15 cm, less than or equal to 13 cm, less than or equal to 10 cm, less than or equal to 7 cm, less than or equal to 5 cm, less than or equal to 3 cm, less than or equal to 2 cm, or less than or equal to 1 cm. Combinations of the above-referenced ranges are also possible (e.g., greater than or equal to 0.5 cm and less than or equal to 20 cm, greater than or equal to 3 cm and less than or equal to 20 cm, greater than or equal to 5 cm and less than or equal to 10 cm, or greater than or equal to 5 cm and less than or equal to 7 cm). Other ranges are also possible. The 1.28 spg sulfuric acid wicking height of the pasting paper and/or the wicking height of the non-woven fiber web (e.g., prior to exposure to 1.28 spg sulfuric acid) may be determined in accordance with ISO 8787 (1986). In ISO 8787, a pasting paper or a non-woven fiber web is positioned vertically in a bath of 1.28 sulfuric acid for 10 minutes. Then, the height that the 1.28 spg sulfuric acid has wicked upwards is measured.

In some embodiments, a pasting paper, a capacitance layer a non-woven fiber web, a resinous layer, an additional layer, and/or a stand-alone layer as described herein may have a relatively large water absorption (e.g., prior to exposure to 1.28 spg sulfuric acid). The water absorption of the pasting paper, the capacitance layer, the non-woven fiber web, the resinous layer, the stand-alone layer, and/or the additional layer (e.g., prior to exposure to 1.28 spg sulfuric acid) may each independently be greater than or equal to 1 g/m², greater than or equal to 2 g/m², greater than or equal to 5 g/m², greater than or equal to 10 g/m², greater than or equal to 15 g/m², greater than or equal to 20 g/m², greater than or equal to 25 g/m², greater than or equal to 30 g/m², greater than or equal to 40 g/m², greater than or equal to 50 g/m², greater than or equal to 60 g/m², greater than or equal to 75 g/m², greater than or equal to 80 g/m², greater than or equal to 90 g/m², greater than or equal to 100 g/m², greater than or equal to 125 g/m², greater than or equal to 150 g/m², or greater than or equal to 175 g/m². The water absorption of the pasting paper, the capacitance layer, the non-woven fiber web, the resinous layer, the stand-alone layer, and/or the additional layer (e.g., prior to exposure to 1.28 spg sulfuric acid) may each independently be less than or equal to 200 g/m², less than or equal to 175 g/m², less than or equal to 150 g/m², less than or equal to 125 g/m², less than or equal to 100 g/m², less than or equal to 90 g/m², less than or equal to 80 g/m², less than or equal to 75 g/m², less than or equal to 70 g/m², less than or equal to 60 g/m², less than or equal to 50 g/m², less than or equal to 40 g/m², less than or equal to 30 g/m², less than or equal to 25 g/m², less than or equal to 20 g/m², less than or equal to 15 g/m², less than or equal to 10 g/m², less than or equal to 5 g/m², or less than or equal to 2 g/m². Combinations of the above-referenced ranges are also possible (e.g., greater than or equal to 1 g/m² and less than or equal to 200 g/m², greater than or equal to 5 g/m² and less than or equal to 100 g/m², greater than or equal to 10 g/m² and less than or equal to 100 g/m², greater than or equal to 15 g/m² and less than or equal to 75 g/m², greater than or equal to 20 g/m² and less than or equal to 80 g/m², or greater than or equal to 20 g/m² and less than or equal to 60 g/m²). Other ranges are also possible. The water absorption of the pasting paper, the water absorption of the capacitance layer, the water absorption of the non-woven fiber web, the water absorption of the resinous layer, the water absorption of the stand-alone layer, and/or the water absorption of the additional layer may be determined in accordance with TAPPI T 441-om-09.

In some embodiments, a pasting paper, a capacitance layer, a non-woven fiber web, a resinous layer, an additional layer, and/or a stand-alone layer as described herein may have a relatively low water contact angle. The water contact angle of the pasting paper, the capacitance layer, the non-woven fiber web, the resinous layer, the stand-alone layer, and/or the additional layer may each independently be less than or equal to 120°, less than or equal to 110°, less than or equal to 100°, less than or equal to 90°, less than or equal to 80°, less than or equal to 70°, less than or equal to 60°, less than or equal to 50°, less than or equal to 40°, less than or equal to 30°, less than or equal to 20°, or less than or equal to 10°. The water contact angle of the pasting paper, the capacitance layer, the non-woven fiber web, the resinous layer, the stand-alone layer, and/or the additional layer may each independently be greater than or equal to 0°, greater than or equal to 10°, greater than or equal to 20°, greater than or equal to 30°, greater than or equal to 40°, greater than or equal to 50°, greater than or equal to 60°, greater than or equal to 70°, greater than or equal to 80°, greater than or equal to 90°, greater than or equal to 100°, or greater than or equal to 110°. Combinations of the above-referenced ranges are also possible (e.g., less than or equal to 120° and greater than or equal to 0°, less than or equal to 80° and greater than or equal to 20°, or less than or equal to 70° and greater than or equal to 40°). Other ranges are also possible. The water contact angle of the pasting paper, the water contact angle of the capacitance layer, the water contact angle of the non-woven fiber web, the water contact angle of the resinous layer, the water contact angle of the stand-alone layer, and/or the water contact angle of the additional layer may be determined in accordance with ASTM D5946 (2009).

Pasting papers, capacitance layers, non-woven fiber webs, resinous layers, additional layers, and stand-alone layers as described herein may have any suitable mean pore sizes. In some embodiments, a pasting paper, a capacitance layer, a non-woven fiber web, a resinous layer, an additional layer, and/or a stand-alone layer may each independently have a mean pore size of greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 20 microns, greater than or equal to 50 microns, or greater than or equal to 70 microns. In some embodiments, a pasting paper, a capacitance layer, a non-woven fiber web, a resinous layer, an additional layer, and/or a stand-alone layer may each independently have a mean pore size of less than or equal to 100 microns, less than or equal to 70 microns, less than or equal to 50 microns, less than or equal to 20 microns, less than or equal to 10 microns, less than or equal to 5 microns, less than or equal to 2 microns, less than or equal to 1 micron, less than or equal to 0.5 microns, or less than or equal to 0.2 microns. Combinations of the above-referenced ranges are also possible (e.g., greater than or equal to 0.1 micron and less than or equal to 100 microns, greater than or equal to 2 microns and less than or equal to 100 microns, greater than or equal to 5 microns and less than or equal to 70 microns, or greater than or equal to 10 microns and less than or equal to 50 microns). Other ranges are also possible. The mean pore size of the pasting paper, the mean pore size of the capacitance layer, the mean pore size of the non-woven fiber web, the mean pore size of the resinous layer, the mean pore size of the additional layer, and/or the mean pore size of the stand-alone layer may be determined in accordance with the liquid porosimetry method described in BCIS-03A Rev. September 09, Method 6. This method comprises using a PMI capillary flow porometer.

Pasting papers, capacitance layers, non-woven fiber webs, additional layers, and stand-alone layers as described herein may have any suitable air permeabilities. In some embodiments, a pasting paper, a capacitance layer, a non-woven fiber web, a resinous layer, an additional layer, and/or a stand-alone layer may each independently have an air permeability of greater than or equal to 0.1 CFM, greater than or equal to 0.2 CFM, greater than or equal to 0.5 CFM, greater than or equal to 1 CFM, greater than or equal to 2 CFM, greater than or equal to 5 CFM, greater than or equal to 10 CFM, greater than or equal to 20 CFM, greater than or equal to 40 CFM, greater than or equal to 80 CFM, greater than or equal to 100 CFM, greater than or equal to 150 CFM, greater than or equal to 200 CFM, greater than or equal to 250 CFM, greater than or equal to 300 CFM, greater than or equal to 400 CFM, greater than or equal to 500 CFM, greater than or equal to 750 CFM, or greater than or equal to 1000 CFM. In some embodiments, a pasting paper, a capacitance layer, a non-woven fiber web, a resinous layer, an additional layer, and/or a stand-alone layer may each independently have an air permeability of less than or equal to 1300 CFM, less than or equal to 1000 CFM, less than or equal to 750 CFM, less than or equal to 500 CFM, less than or equal to 400 CFM, less than or equal to 300 CFM, less than or equal to 250 CFM, less than or equal to 200 CFM, less than or equal to 150 CFM, less than or equal to 100 CFM, less than or equal to 80 CFM, less than or equal to 40 CFM, less than or equal to 20 CFM, less than or equal to 10 CFM, less than or equal to 5 CFM, less than or equal to 2 CFM, less than or equal to 1 CFM, less than or equal to 0.5 CFM, or less than or equal to 0.2 CFM. Combinations of the above-referenced ranges are also possible (e.g., greater than or equal to 0.1 CFM and less than or equal to 20 CFM, greater than or equal to 0.1 CFM and less than or equal to 10 CFM, greater than or equal to 0.5 CFM and less than or equal to 1300 CFM, greater than or equal to 2 CFM and less than or equal to 1300 CFM, greater than or equal to 20 CFM and less than or equal to 400 CFM, or greater than or equal to 40 CFM and less than or equal to 250 CFM). Other ranges are also possible. As used herein, CFM refers to cubic feet per square foot of sample area per minute (ft³/ft² min). The air permeability of the pasting paper, the air permeability of the capacitance layer, the air permeability of the non-woven fiber web, the air permeability of the resinous layer, the air permeability of the additional layer, and/or the air permeability of the stand-alone layer may be determined in accordance with ASTM Test Standard D737-96 (1996) under a pressure drop of 125 Pa on a sample with a test area of 38 cm².

Pasting papers and non-woven fiber webs as described herein may have any suitable specific surface areas. In some embodiments, a pasting paper and/or a non-woven fiber web may each independently have a specific surface area of greater than or equal to 0.1 m²/g, greater than or equal to 0.2 m²/g, greater than or equal to 0.3 m²/g, greater than or equal to 0.4 m²/g, greater than or equal to 0.5 m²/g, greater than or equal to 0.6 m²/g, greater than or equal to 0.8 m²/g, greater than or equal to 1 m²/g, greater than or equal to 2 m²/g, greater than or equal to 5 m²/g, greater than or equal to 8 m²/g, greater than or equal to 10 m²/g, greater than or equal to 15 m²/g, greater than or equal to 20 m²/g, greater than or equal to 25 m²/g, greater than or equal to 50 m²/g, greater than or equal to 100 m²/g, greater than or equal to 200 m²/g, greater than or equal to 500 m²/g, greater than or equal to 1000 m²/g, greater than or equal to 1500 m²/g, greater than or equal to 2000 m²/g, greater than or equal to 2500 m²/g, or greater than or equal to 3000 m²/g. In some embodiments, a pasting paper and/or a non-woven fiber web may each independently have a specific surface of less than or equal to 3500 m²/g, less than or equal to 3000 m²/g, less than or equal to 2500 m²/g, less than or equal to 2000 m²/g, less than or equal to 1500 m²/g, less than or equal to 1000 m²/g, less than or equal to 500 m²/g, less than or equal to 200 m²/g, less than or equal to 100 m²/g, less than or equal to 50 m²/g, less than or equal to 25 m²/g, less than or equal to 20 m²/g, less than or equal to 15 m²/g, less than or equal to 10 m²/g, less than or equal to 8 m²/g, less than or equal to 5 m²/g, less than or equal to 2 m²/g, less than or equal to 1 m²/g, less than or equal to 0.8 m²/g, less than or equal to 0.6 m²/g, less than or equal to 0.5 m²/g, less than or equal to 0.4 m²/g, less than or equal to 0.3 m²/g, or less than or equal to 0.2 m²/g. Combinations of the above-referenced ranges are also possible (e.g., greater than or equal to 0.1 m²/g and less than or equal to 3500 m²/g, greater than or equal to 0.5 m²/g and less than or equal to 2000 m²/g, greater than or equal to 0.6 m²/g and less than or equal to 1500 m²/g, greater than or equal to 0.1 m²/g and less than or equal to 10 m²/g, greater than or equal to 0.3 m²/g and less than or equal to 2 m²/g, or greater than or equal to 0.4 m²/g and less than or equal to 0.8 m²/g). Other ranges are also possible. The specific surface area of the pasting paper and/or the specific surface area of the non-woven fiber web may be determined in accordance with section 10 of Battery Council International Standard BCIS-03A (2002), “Recommended Battery Materials Specifications Valve Regulated Recombinant Batteries”, section 10 being “Standard Test Method for Surface Area of Recombinant Battery Separator Mat” as described elsewhere herein.

Pasting papers, capacitance layers, non-woven fiber webs, resinous layers, additional layers, and stand-alone layers as described herein may have any suitable thicknesses. In some embodiments, a pasting paper, a capacitance layer, a non-woven fiber web, an additional layer, and/or a stand-alone layer may each independently have a thickness of greater than or equal to 0.05 mm, greater than or equal to 0.075 mm, greater than or equal to 0.1 mm, greater than or equal to 0.12 mm, greater than or equal to 0.14 mm, greater than or equal to 0.15 mm, greater than or equal to 0.16 mm, greater than or equal to 0.175 mm, greater than 0.2 mm, greater than or equal to 0.2 mm, greater than or equal to 0.3 mm, greater than or equal to 0.5 mm, greater than or equal to 0.7 mm, or greater than or equal to 1 mm. In some embodiments, a pasting paper, a capacitance layer, a non-woven fiber web, a resinous layer, an additional layer, and/or a stand-alone layer may each independently have a thickness of less than or equal to 1.2 mm, less than or equal to 1 mm, less than or equal to 0.7 mm, less than or equal to 0.5 mm, less than or equal to 0.3 mm, less than or equal to 0.2 mm, less than 0.2 mm, less than or equal to 0.175 mm, less than or equal to 0.16 mm, less than or equal to 0.15 mm, less than or equal to 0.14 mm, less than or equal to 0.12 mm, less than or equal to 0.1 mm, or less than or equal to 0.075 mm. Combinations of the above-referenced ranges are also possible (e.g., greater than or equal to 0.05 mm and less than or equal to 1.2 mm, greater than or equal to 0.05 mm and less than or equal to 1 mm, greater than or equal to 0.1 mm and less than or equal to 0.7 mm, greater than or equal to 0.1 mm and less than or equal to 0.5 mm, greater than or equal to 0.15 mm and less than or equal to 0.5 mm, greater than or equal to 0.05 mm and less than 0.2 mm, greater than or equal to 0.1 mm and less than or equal to 0.175 mm, greater than or equal to 0.12 mm and less than or equal to 0.16 mm, or greater than or equal to 0.15 mm and less than or equal to 0.3 mm). Other ranges are also possible. The thickness of the pasting paper, the thickness of the capacitance layer, the thickness of the non-woven fiber web, the thickness of the resinous layer, the thickness of the additional layer, and/or the thickness of the stand-alone layer may be measured in accordance with BCIS-03A, September 09, Method 10 under 10 kPa applied pressure.

Pasting papers, capacitance layers, non-woven fiber webs, resinous layers, additional layers, and stand-alone layers as described herein may have any suitable density. In some embodiments, a pasting paper, a capacitance layer, a non-woven fiber web, a resinous layer, an additional layer, and/or a stand-alone layer may each independently have a density of greater than or equal to 0.01 mg/mm³, greater than or equal to 0.02 mg/mm³, greater than or equal to 0.03 mg/mm³, greater than or equal to 0.04 mg/mm³, greater than or equal to 0.05 mg/mm³, greater than or equal to 0.07 mg/mm³, greater than or equal to 0.1 mg/mm³, greater than or equal to 0.15 mg/mm³, greater than or equal to 0.2 mg/mm³, greater than or equal to 0.25 mg/mm³, greater than or equal to 0.3 mg/mm³, greater than or equal to 0.4 mg/mm³, greater than or equal to 0.5 mg/mm³, or greater than or equal to 0.7 mg/mm³. In some embodiments, a pasting paper, a capacitance layer, a non-woven fiber web, a resinous layer, an additional layer, and/or a stand-alone layer may each independently have a density of less than or equal to 1 mg/mm³, less than or equal to 0.7 mg/mm³, less than or equal to 0.5 mg/mm³, less than or equal to 0.4 mg/mm³, less than or equal to 0.3 mg/mm³, less than or equal to 0.25 mg/mm³, less than or equal to 0.2 mg/mm³, less than or equal to 0.15 mg/mm³, less than or equal to 0.1 mg/mm³, less than or equal to 0.07 mg/mm³, less than or equal to 0.05 mg/mm³, less than or equal to 0.04 mg/mm³, less than or equal to 0.03 mg/mm³, or less than or equal to 0.02 mg/mm³. Combinations of the above-referenced ranges are also possible (e.g., greater than or equal to 0.01 mg/mm³ and less than or equal to 1 mg/mm³, greater than or equal to 0.01 mg/mm³ and less than or equal to 0.5 mg/mm³, greater than or equal to 0.1 mg/mm³ and less than or equal to 0.4 mg/mm³, greater than or equal to 0.1 mg/mm³ and less than or equal to 0.3 mg/mm³, or greater than or equal to 0.15 mg/mm³ and less than or equal to 0.25 mg/mm³). Other ranges are also possible.

Pasting papers, capacitance layers, non-woven fiber webs, resinous layers, additional layers, and stand-alone layers as described herein may have any suitable basis weights. In some embodiments, a pasting paper, a capacitance layer, a non-woven fiber web, an additional layer, a resinous layer, and/or a stand-alone layer may each independently have a basis weight of greater than or equal to 0.1 g/m², greater than or equal to 0.2 g/m², greater than or equal to 0.5 g/m², greater than or equal to 1 g/m², greater than or equal to 2 g/m², greater than or equal to 5 g/m², greater than or equal to 10 g/m², greater than or equal to 15 g/m², greater than or equal to 20 g/m², greater than or equal to 25 g/m², greater than or equal to 30 g/m², greater than or equal to 35 g/m², greater than or equal to 40 g/m², greater than or equal to 45 g/m², greater than or equal to 50 g/m², greater than or equal to 60 g/m², greater than or equal to 70 g/m², greater than or equal to 80 g/m², greater than or equal to 90 g/m², greater than or equal to 100 g/m², greater than or equal to 150 g/m², greater than or equal to 200 g/m², or greater than or equal to 250 g/m². In some embodiments, a pasting paper, a capacitance layer, a non-woven fiber web, a resinous layer, an additional layer, and/or a stand-alone layer may each independently have a basis weight of less than or equal to 300 g/m², less than or equal to 250 g/m², less than or equal to 200 g/m², less than or equal to 150 g/m², less than or equal to 100 g/m², less than or equal to 90 g/m², less than or equal to 80 g/m², less than or equal to 70 g/m², less than or equal to 60 g/m², less than or equal to 50 g/m², less than or equal to 45 g/m², less than or equal to 40 g/m², less than or equal to 35 g/m², less than or equal to 30 g/m², less than or equal to 25 g/m², less than or equal to 20 g/m², less than or equal to 15 g/m², less than or equal to 10 g/m², less than or equal to 5 g/m², less than or equal to 2 g/m², less than or equal to 1 g/m², less than or equal to 0.5 g/m², or less than or equal to 0.2 g/m². Combinations of the above-referenced ranges are also possible (e.g., greater than or equal to 0.1 g/m² and less than or equal to 10 g/m², greater than or equal to 1 g/m² and less than or equal to 100 g/m², greater than or equal to 5 g/m² and less than or equal to 300 g/m², greater than or equal to 5 g/m² and less than or equal to 150 g/m², greater than or equal to 5 g/m² and less than or equal to 100 g/m², greater than or equal to 7 g/m² and less than or equal to 100 g/m², greater than or equal to 7 g/m² and less than or equal to 50 g/m², greater than or equal to 10 g/m² and less than or equal to 70 g/m², greater than or equal to 10 g/m² and less than or equal to 30 g/m², greater than or equal to 20 g/m² and less than or equal to 40 g/m², or greater than or equal to 25 g/m² and less than or equal to 35 g/m²). Other ranges are also possible. The basis weight of the pasting paper, the basis weight of the capacitance layer, the basis weight of the non-woven fiber web, the basis weight of the resinous layer, the basis weight of the additional layer, and/or the basis weight of the stand-alone layer may be determined in accordance with BCIS-03A, September 09, Method 3.

Pasting papers, capacitance layers, non-woven fiber webs, resinous layers, additional layers, and stand-alone layers as described herein may have any suitable electrical resistances. In some embodiments, a pasting paper, a capacitance layer, a non-woven fiber web, a resinous layer, an additional layer, and/or a stand-alone layer may each independently have an electrical resistance of greater than or equal to 5 milliΩ·cm², greater than or equal to 10 milliΩ·cm², greater than or equal to 15 milliΩ·cm², greater than or equal to 20 milliΩ·cm², greater than or equal to 30 milliΩ·cm², greater than or equal to 40 milliΩ·cm², greater than or equal to 50 milliΩ·cm², or greater than or equal to 75 milliΩ·cm². In some embodiments, a pasting paper, a capacitance layer, a non-woven fiber web, a resinous layer, an additional layer, and/or a stand-alone layer may each independently have an electrical resistance of less than or equal to 100 milliΩ·cm², less than or equal to 75 milliΩ·cm², less than or equal to 50 milliΩ·cm², less than or equal to 40 milliΩ·cm², less than or equal to 30 milliΩ·cm², less than or equal to 20 milliΩ·cm², less than or equal to 15 milliΩ·cm², or less than or equal to 10 milliΩ·cm². Combinations of the above-referenced ranges are also possible (e.g., greater than or equal to 5 milliΩ·cm² and less than or equal to 100 milliΩ·cm², greater than or equal to 5 milliΩ·cm² and less than or equal to 50 milliΩ·cm², greater than or equal to 5 milliΩ·cm² and less than or equal to 30 milliΩ·cm², greater than or equal to 5 milliΩ·cm² and less than or equal to 15 milliΩ·cm², or greater than or equal to 20 milliΩ·cm² and less than or equal to 40 milliΩ·cm²). Other ranges are also possible. The electrical resistance of the pasting paper, the electrical resistance of the capacitance layer, the electrical resistance of the non-woven fiber web, the electrical resistance of the resinous layer, the electrical resistance of the additional layer, and/or the electrical resistance of the stand-alone layer may be determined in accordance by performing BCIS-03B (2002), method 18 and omitting the pretreatment or conditioning step.

Pasting papers, capacitance layers, non-woven fiber webs, resinous layers, additional layers, and stand-alone layers as described herein may have any suitable electrical conductivities. In some embodiments, a pasting paper, a capacitance layer, a non-woven fiber web, a resinous layer, an additional layer, and/or a stand-alone layer may each independently have an electrical conductivity of greater than or equal to 1 S/m, greater than or equal to 2 S/m, greater than or equal to 5 S/m, greater than or equal to 10 S/m, greater than or equal to 20 S/m, greater than or equal to 50 S/m, greater than or equal to 100 S/m, greater than or equal to 200 S/m, greater than or equal to 500 S/m, greater than or equal to 1,000 S/m, greater than or equal to 2,000 S/m, greater than or equal to 5,000 S/m, greater than or equal to 10,000 S/m, greater than or equal to 20,000 S/m, greater than or equal to 50,000 S/m, greater than or equal to 100,000 S/m, greater than or equal to 200,000 S/m, or greater than or equal to 250,000 S/m. The electrical conductivity of the pasting paper, the capacitance layer, the non-woven fiber web, the resinous layer, the additional layer, and/or the stand-alone layer may each independently be less than or equal to 300,000 S/m, less than or equal to 250,000 S/m, less than or equal to 200,000 S/m, less than or equal to 100,000 S/m, less than or equal to 50,000 S/m, less than or equal to 20,000 S/m, less than or equal to 10,000 S/m, less than or equal to 5,000 S/m, less than or equal to 2,000 S/m, less than or equal to 1,000 S/m, less than or equal to 500 S/m, less than or equal to 200 S/m, less than or equal to 100 S/m, less than or equal to 50 S/m, less than or equal to 20 S/m, less than or equal to 10 S/m, less than or equal to 5 S/m, or less than or equal to 2 S/m. Combinations of the above-referenced ranges are also possible (e.g., greater than or equal to 1 S/m and less than or equal to 300,000 S/m, greater than or equal to 5 S/m and less than or equal to 250,000 S/m, or greater than or equal to 10 S/m and less than or equal to 200,000 S/m). Other ranges are also possible. The electrical conductivity of the pasting paper, the electrical conductivity of the capacitance layer, the electrical conductivity of the non-woven fiber web, the electrical conductivity of the resinous layer, the electrical conductivity of the additional layer, and/or the electrical conductivity of the stand-alone layer may be determined by measuring the resistivity of the pasting paper, the capacitance layer, the non-woven fiber web, the resinous layer, the additional layer, and/or the stand-alone layer according to the four point method described in ASTM F390-11 (2018), and then dividing the inverse of the measured resistivity by the thickness of the pasting paper, capacitance layer, non-woven fiber web, resinous layer, additional layer, and/or capacitance layer.

Pasting papers, capacitance layers, non-woven fiber webs, resinous layers, additional layers, and stand-alone layers as described herein may have any suitable specific capacitance. In some embodiments, a pasting paper, a capacitance layer, a non-woven fiber web, a resinous layer, an additional layer, and/or a stand-alone layer may each independently have a specific capacitance of greater than or equal to 1 F/g, greater than or equal to 2 F/g, greater than or equal to 5 F/g, greater than or equal to 10 F/g, greater than or equal to 15 F/g, greater than or equal to 20 F/g, greater than or equal to 25 F/g, greater than or equal to 50 F/g, greater than or equal to 75 F/g, greater than or equal to 100 F/g, greater than or equal to 125 F/g, greater than or equal to 150 F/g, or greater than or equal to 200 F/g. In some embodiments, a pasting paper, a capacitance layer, a non-woven fiber web, a resinous layer, an additional layer, and/or a stand-alone layer may each independently have a specific capacitance of less than or equal to 250 F/g, less than or equal to 200 F/g, less than or equal to 150 F/g, less than or equal to 125 F/g, less than or equal to 100 F/g, less than or equal to 75 F/g, less than or equal to 50 F/g, less than or equal to 25 F/g, less than or equal to 20 F/g, less than or equal to 15 F/g, less than or equal to 10 F/g, less than or equal to 5 F/g, or less than or equal to 2 F/g. Combinations of the above-referenced ranges are also possible (e.g., greater than or equal to 1 F/g and less than or equal to 250 F/g, greater than or equal to 10 F/g and less than or equal to 150 F/g, or greater than or equal to 20 F/g and less than or equal to 125 F/g). Other ranges are also possible.

The specific capacitance may be determined by in accordance with IEC 62576:2018 as described elsewhere herein in relation to capacitive fibers but performed on a symmetric supercapacitor/ultracapacitor device including two identical electrodes of the pasting paper, the capacitance layer, the non-woven fiber web, the resinous layer, the additional layer, or the stand-alone layer.

Pasting papers, capacitance layers, non-woven fiber webs, resinous layers, additional layers, and stand-alone layers as described herein may cause a battery plate on which the pasting paper, capacitance layer, non-woven fiber web, resinous layer, additional layer, or stand-alone layer is disposed to exhibit any suitable hydrogen shift. The hydrogen shift may be greater than or equal to 10 mV, greater than or equal to 15 mV, greater than or equal to 20 mV, greater than or equal to 25 mV, greater than or equal to 30 mV, greater than or equal to 40 mV, greater than or equal to 50 mV, greater than or equal to 75 mV, greater than or equal to 100 mV, greater than or equal to 120 mV, greater than or equal to 150 mV, greater than or equal to 175 mV, greater than or equal to 200 mV, greater than or equal to 220 mV, greater than or equal to 250 mV, greater than or equal to 275 mV, greater than or equal to 300 mV, greater than or equal to 350 mV, greater than or equal to 400 mV, or greater than or equal to 450 mV. The hydrogen shift may be less than or equal to 500 mV, less than or equal to 450 mV, less than or equal to 400 mV, less than or equal to 350 mV, less than or equal to 300 mV, less than or equal to 275 mV, less than or equal to 250 mV, less than or equal to 220 mV, less than or equal to 200 mV, less than or equal to 175 mV, less than or equal to 150 mV, less than or equal to 120 mV, less than or equal to 100 mV, less than or equal to 75 mV, less than or equal to 50 mV, less than or equal to 40 mV, less than or equal to 30 mV, less than or equal to 25 mV, less than or equal to 20 mV, or less than or equal to 15 mV. Combinations of the above-referenced ranges are also possible (e.g., greater than or equal to 10 mV and less than or equal to 500 my, greater than or equal to 20 mV and less than or equal to 250 mV, or greater than or equal to 30 mV and less than or equal to 120 mV). Other ranges are also possible. As used herein, the hydrogen shift refers to the difference in voltage between the voltage at which hydrogen is produced in the presence of the pasting paper, capacitance layer, non-woven fiber web, resinous layer, additional layer, or stand-alone layer and the voltage at which hydrogen is produced in the absence of the pasting paper, capacitance layer, non-woven fiber web, resinous layer, additional layer, or stand-alone layer.

The hydrogen shift caused by a pasting paper, capacitance layer, non-woven fiber web, resinous layer, additional layer, or stand-alone layer may be determined by the procedure that follows. The voltage at which hydrogen is generated in the absence of the pasting paper, capacitance layer, non-woven fiber web, resinous layer, additional layer, or stand-alone layer may be determined in a battery including a lead dioxide positive electrode, a metallic lead negative electrode, and a sulfuric acid electrolyte. This voltage may be compared to the voltage at which hydrogen is generated in an otherwise equivalent cell including the pasting paper, capacitance layer, non-woven fiber web, resinous layer, additional layer, or stand-alone layer. For both measurements, the negative electrode voltage may be driven by a mercurous sulfate reference electrode. The voltage of the reference electrode may be varied, during which the current through the test cell may be measured. An increase in the measured current indicates that hydrogen is being generated, and so the lowest voltage at which the measured current increases is taken to be the voltage at which hydrogen is generated.

Pasting papers, capacitance layers, non-woven fiber webs, resinous layers, additional layers, and stand-alone layers as described herein may cause a battery plate on which the pasting paper, capacitance layer, non-woven fiber web, resinous layer, additional layer, or stand-alone layer is positioned to exhibit a reduced acid stratification distance and/or may have a relatively low acid stratification distance. For instance, the pasting paper, capacitance layer, non-woven fiber web, resinous layer, additional layer, or stand-alone layer may have a lower mean flow pore size than the battery plate on which it is disposed, reducing the mean flow pore size of the pasting paper/capacitance layer/non-woven fiber web/resinous layer/additional layer/stand-alone layer-battery plate composite. The acid stratification distance may be greater than or equal to 0.01 cm, greater than or equal to 0.02 cm, greater than or equal to 0.05 cm, greater than or equal to 0.075 cm, greater than or equal to 0.1 cm, greater than or equal to 0.2 cm, greater than or equal to 0.5 cm, greater than or equal to 0.75 cm, greater than or equal to 1 cm, greater than or equal to 1.5 cm, greater than or equal to 2 cm, greater than or equal to 3 cm, greater than or equal to 4 cm, greater than or equal to 5 cm, greater than or equal to 6 cm, greater than or equal to 8 cm, greater than or equal to 10 cm, greater than or equal to 12.5 cm, greater than or equal to 15 cm, or greater than or equal to 17.5 cm. The acid stratification distance may be less than or equal to 20 cm, less than or equal to 17.5 cm, less than or equal to 15 cm, less than or equal to 12.5 cm, less than or equal to 10 cm, less than or equal to 8 cm, less than or equal to 6 cm, less than or equal to 5 cm, less than or equal to 4 cm, less than or equal to 3 cm, less than or equal to 2 cm, less than or equal to 1.5 cm, less than or equal to 2 cm, less than or equal to 0.75 cm, less than or equal to 0.5 cm, less than or equal to 0.2 cm, less than or equal to 0.1 cm, less than or equal to 0.075 cm, less than or equal to 0.05 cm, or less than or equal to 0.02 cm. Combinations of the above-referenced ranges are also possible (e.g., greater than or equal to 0.01 cm and less than or equal to 20 cm, greater than or equal to 0.5 cm and less than or equal to 10 cm, or greater than or equal to 0.1 cm and less than or equal to 5 cm). Other ranges are also possible.

The acid stratification distance may be measured by the procedure described in this paragraph. First, a 8.5 inch (measured in the MD)×1.5 inch sample (e.g., of the pasting paper, capacitance layer, non-woven fiber web, resinous layer, additional layer, or stand-alone layer) may be immersed in a 1.1 spg sulfuric acid solution until the sample is saturated with the 1.1 spg sulfuric acid. Then, the saturated sample may be placed upright between two polycarbonate plates and surrounded by a gasket such that the 1.1 spg sulfuric acid is contained laterally in the sample and the top surface of the sample is accessible at the top of the plates. In this configuration, the plates may be separated at a distance such that the sample has an average density of about 240 g/(m²*mm). A volume of 10-25 mL of 1.28 spg sulfuric acid containing a soluble dye may then be introduced into the accessible region at the top of the sample between the plates until it just contacts the top edge of the sample. The distance the 1.28 spg sulfuric acid travels downward after 60 minutes (displacing the initial 1.1 spg sulfuric acid within the sample) during this procedure is the acid stratification distance. If there is variation in the distance the 1.28 spg sulfuric acid travels (e.g., variation across the width of the sample), the middle point between the highest and lowest distances may be used to calculate the acid stratification distance. The test may be performed at ambient pressure and at a temperature of 25° C.

As described above, in some embodiments, a pasting papers described herein may be configured such that at least a portion of the pasting paper (and/or all or portions of one or more layers therein) dissolves upon exposure to an electrolyte, such as upon exposure to sulfuric acid (e.g., at a concentration of 1.28 spg). Some properties of such pasting papers (and/or layer(s) therein) may be different prior to exposure to the electrolyte than after exposure to the electrolyte for a certain period of time.

For instance, in some embodiments, at least a portion of the pasting paper and/or the non-woven fiber web may dissolve upon exposure to an electrolyte (e.g., sulfuric acid, such as 1.28 spg sulfuric acid). In some cases, a pasting paper and/or a non-woven fiber web may comprise a plurality of cellulose fibers, and at least a portion of the cellulose fibers may dissolve upon exposure to an electrolyte (e.g., sulfuric acid, such as 1.28 spg sulfuric acid). The pasting paper and/or the non-woven fiber web may each independently be configured such that greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, or greater than or equal to 70 wt % of the cellulose fibers dissolve after storage in 1.28 spg sulfuric acid at 75° C. for 7 days. The pasting paper and/or the non-woven fiber web may each independently be configured such that less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % of the cellulose fibers dissolve after storage in 1.28 spg sulfuric acid at 75° C. for 7 days. Combinations of the above-referenced ranges are also possible (e.g., greater than or equal to 0 wt % and less than or equal to 80 wt %). Other ranges are also possible.

In some embodiments, a pasting paper and/or a non-woven fiber web may have a relatively high dry tensile strength after exposure to 1.28 spg sulfuric acid. The pasting paper and/or the non-woven fiber web may each independently be configured to have a dry tensile strength after storage in 1.28 spg sulfuric acid at 75° C. for 7 days of greater than or equal to 0.2 lbs/in, greater than or equal to 0.5 lbs/in, greater than or equal to 1 lb/in, greater than or equal to 2 lbs/in, greater than or equal to 3 lbs/in, greater than or equal to 4 lbs/in, greater than or equal to 5 lbs/in, or greater than or equal to 7 lbs/in. The pasting paper and/or the non-woven fiber web may each independently be configured to have a dry tensile strength after storage in 1.28 spg sulfuric acid at 75° C. for 7 days of less than or equal to 10 lbs/in, less than or equal to 7 lbs/in, less than or equal to 5 lbs/in, less than or equal to 4 lbs/in, less than or equal to 3 lbs/in, less than or equal to 2 lbs/in, less than or equal to 1 lb/in, or less than or equal to 0.5 lbs/in. Combinations of the above-referenced ranges are also possible (e.g., greater than or equal to 0.2 lbs/in and less than or equal to 10 lbs/in, greater than or equal to 1 lb/in and less than or equal to 10 lbs/in, greater than or equal to 0.5 lbs/in and less than or equal to 5 lbs/in, greater than or equal to 1 lb/in and less than or equal to 5 lbs/in, greater than or equal to 1 lb/in and less than or equal to 3 lbs/in, or greater than or equal to 1 lb/in and less than or equal to 2 lbs/in). Other ranges are also possible. The dry tensile strength of the pasting paper and/or the dry tensile strength of the non-woven fiber web may be determined in accordance with BCIS 03A, Rev. December 2015, Method 9.

In some embodiments, the dry tensile strength of a pasting paper and/or the dry tensile strength of a non-woven fiber web may change relatively little after exposure to 1.28 spg sulfuric acid. The pasting paper and/or the non-woven fiber web may each independently be configured to have a dry tensile strength after storage in 1.28 spg sulfuric acid at 75° C. for 7 days that is within 40%, within 35%, within 30%, within 25%, within 20%, within 15%, within 10%, within 5%, within 2%, or within 1% of its dry tensile strength at the point in time when it has its maximum dry tensile strength (e.g., after fabrication, prior to exposure to sulfuric acid).

In some embodiments, a pasting paper and/or a non-woven fiber web as described herein may be configured to have a mean pore size after exposure to 1.28 spg sulfuric acid that is larger than its mean pore size prior to exposure to 1.28 spg sulfuric acid. The pasting paper and/or the non-woven fiber web may each independently be configured to have a mean pore size after storage in 1.28 spg sulfuric acid at 75° C. for 7 days of greater than or equal to 0.1 micron, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 20 microns, greater than or equal to 50 microns, greater than or equal to 100 microns, greater or equal to 150 microns, greater than or equal to 200 microns, or greater than or equal to 250 microns. The pasting paper and/or the non-woven fiber web may each independently be configured to have a mean pore size after storage in 1.28 spg sulfuric acid at 75° C. for 7 days of less than or equal to 300 microns, less than or equal to 250 microns, less than or equal to 200 microns, less than or equal to 150 microns, less than or equal to 100 microns, less than or equal to 50 microns, less than or equal to 20 microns, less than or equal to 10 microns, less than or equal to 5 microns, less than or equal to 2 microns, less than or equal to 1 micron, less than or equal to 0.5 microns, or less than or equal to 0.2 microns. Combinations of the above-referenced ranges are also possible (e.g., greater than or equal to 0.1 micron and less than or equal to 300 microns, greater than or equal to 2 microns and less than or equal to 300 microns, greater than or equal to 5 microns and less than or equal to 200 microns, or greater than or equal to 10 microns and less than or equal to 150 microns). Other ranges are also possible. The mean pore size of the pasting paper and/or the mean pore size of the non-woven fiber web may be determined in accordance with the liquid porosimetry method described in BCIS-03A Rev. September 09, Method 6. This method comprises using a PMI capillary flow porometer.

The mean pore size of a pasting paper and the mean pore size of a non-woven fiber web may change by any appropriate amounts after exposure to 1.28 spg sulfuric acid. The pasting paper and/or the non-woven fiber web may each independently be configured to have a mean pore size after storage in 1.28 spg sulfuric acid at 75° C. for 7 days that is greater than or equal to 0% larger, greater than or equal to 1% larger, greater than or equal to 2% larger, greater than or equal to 5% larger, greater than or equal to 10% larger, greater than or equal to 25% larger, greater than or equal to 50% larger, greater than or equal to 100% larger, or greater than or equal to 200% larger than its mean pore size at another point in time (e.g., after fabrication, prior to exposure to sulfuric acid). The pasting paper and/or the non-woven fiber web may each independently be configured to have a mean pore size after storage in 1.28 spg sulfuric acid at 75° C. for 7 days that is less than or equal to 300% larger, less than or equal to 200% larger, less than or equal to 100% larger, less than or equal to 50% larger, less than or equal to 25% larger, less than or equal to 10% larger, less than or equal to 5% larger, less than or equal to 2% larger, or less than or equal to 1% larger than its mean pore size at another point in time (e.g., after fabrication, prior to exposure to sulfuric acid). Combinations of the above-referenced ranges are also possible (e.g., greater than or equal to 0% larger and less than or equal to 300% larger). Other ranges are also possible.

In some embodiments, a pasting paper and/or a non-woven fiber web as described herein may be configured to have an air permeability after exposure to 1.28 spg sulfuric acid that is larger than its air permeability prior to exposure to 1.28 spg sulfuric acid. The pasting paper and/or the non-woven fiber web may each independently be configured to have an air permeability after storage in 1.28 spg sulfuric acid at 75° C. for 7 days of greater than or equal to 0.5 CFM, greater than or equal to 1 CFM, greater than or equal to 2 CFM, greater than or equal to 5 CFM, greater than or equal to 10 CFM, greater than or equal to 20 CFM, greater than or equal to 50 CFM, greater than or equal to 100 CFM, greater than or equal to 200 CFM, greater than or equal to 300 CFM, greater than or equal to 500 CFM, greater than or equal to 750 CFM, or greater than or equal to 1000 CFM. The pasting paper and/or the non-woven fiber web may each independently be configured to have an air permeability after storage in 1.28 spg sulfuric acid at 75° C. for 7 days of less than or equal to 1300 CFM, less than or equal to 1000 CFM, less than or equal to 750 CFM, less than or equal to 500 CFM, less than or equal to 300 CFM, less than or equal to 200 CFM, less than or equal to 100 CFM, less than or equal to 50 CFM, less than or equal to 20 CFM, less than or equal to 10 CFM, less than or equal to 5 CFM, less than or equal to 2 CFM, or less than or equal to 1 CFM. Combinations of the above-referenced ranges are also possible (e.g., greater than or equal to 0.5 CFM and less than or equal to 1300 CFM, greater than or equal to 100 CFM and less than or equal to 1300 CFM, greater than or equal to 200 CFM and less than or equal to 1300 CFM, or greater than or equal to 300 CFM and less than or equal to 1000 CFM). Other ranges are also possible. As used herein, CFM refers to cubic feet per square foot of sample area per minute (ft³/ft² min). The air permeability of the pasting paper and/or the air permeability of the non-woven fiber web may be determined in accordance with ASTM Test Standard D737-96 (1996) under a pressure drop of 125 Pa on a sample with a test area of 38 cm². The air permeability of a pasting paper and/or the air permeability of a non-woven fiber web may change by any appropriate amount after exposure to 1.28 spg sulfuric acid. The pasting paper and/or the non-woven fiber web may each independently be configured to have an air permeability after storage in 1.28 spg sulfuric acid at 75° C. for 7 days that is greater than or equal to 0% larger, greater than or equal to 1% larger, greater than or equal to 2% larger, greater than or equal to 5% larger, greater than or equal to 10% larger, greater than or equal to 25% larger, greater than or equal to 50% larger, greater than or equal to 100% larger, greater than or equal to 200% larger, greater than or equal to 300% larger, greater than or equal to 400% larger, greater than or equal to 500% larger, or greater than or equal to 750% larger than its air permeability size at another point in time (e.g., after fabrication, prior to exposure to sulfuric acid). The pasting paper and/or the non-woven fiber web may each independently be configured to have an air permeability after storage in 1.28 spg sulfuric acid at 75° C. for 7 days that is less than or equal to 1000% larger, less than or equal to 750% larger, less than or equal to 500% larger, less than or equal to 400% larger, less than or equal to 300% larger, less than or equal to 200% larger, less than or equal to 100% larger, less than or equal to 50% larger, less than or equal to 25% larger, less than or equal to 10% larger, less than or equal to 5% larger, less than or equal to 2% larger, or less than or equal to 1% larger than its air permeability size at another point in time (e.g., after fabrication, prior to exposure to sulfuric acid). Combinations of the above-referenced ranges are also possible (e.g., greater than or equal to 0% larger and less than or equal to 1000% larger). Other ranges are also possible.

As described above, in some embodiments the pasting papers and the capacitance layers described herein may be suitable for lead-acid batteries. However, the pasting papers and the capacitance layers may also be used for other battery types and references to lead-acid batteries herein should be understood not to be limiting. Lead-acid batteries typically comprise a first battery plate (e.g., a negative battery plate) that comprises lead and a second battery plate (e.g., a positive battery plate) that comprises lead dioxide. During discharge, electrons pass from the first battery plate to the second battery plate while the lead paste in the first battery plate is oxidized to form lead sulfate and the lead dioxide in the second battery plate is reduced to also form lead sulfate. During charge, electrons pass from the second battery plate to the first battery plate while the lead sulfate in the first battery plate is reduced to form lead and the lead sulfate in the second battery plate is oxidized to form lead dioxide. Pasting papers and capacitance layers as described herein may be suitable for use on positive battery plates and/or negative battery plates.

In some embodiments, a pasting paper and/or a capacitance layer as described herein may be disposed on a battery plate for use in a valve regulated lead-acid battery (VRLA) battery, such as an AGM/VRLA battery (and/or may be present in a VRLA battery such as an AGM/VRLA battery), or may be disposed on a battery plate for use in a VRLA/Gel battery (and/or may be present in a VRLA/Gel battery). VRLA batteries are lead-acid batteries that comprise a valve configured to vent one or more gases from the battery. These gases may include gases that form as a result of electrolyte decomposition during overcharging, such as hydrogen gas and/or oxygen gas. It may be desirable to maintain the gases in the battery so that they may recombine, reducing or eliminating the need to replenish the decomposed electrolyte. However, it may also be desirable to maintain the pressure inside the battery at a safe level. For these reasons, the valve may be configured to vent the gas(es) under some circumstances, such as when the pressure inside the battery is above a threshold value, but not in others, such as when the pressure inside the battery is below the threshold value.

It should be noted that pasting papers and capacitance layers described herein may, in some embodiments, be disposed on battery plates configured to be used with (and/or battery plates positioned in) other types of lead-acid batteries. For instance, a pasting paper and/or a capacitance layer may be disposed on a battery plate for use in a conventional flooded battery (and/or may be present in a conventional flooded battery), and/or may be disposed on a battery plate for use in an enhanced flooded battery (an EFB) (and/or may be present in an EFB battery).

Battery plates described herein (e.g., battery plates on which pasting papers are disposed, battery plates on which capacitance layers are disposed, first battery plates, negative battery plates, second battery plates, positive battery plates) typically comprise a battery paste disposed on a grid. A battery paste included in a first battery plate (e.g., a negative battery plate) may comprise lead, and/or may comprise both lead and lead dioxide (e.g., prior to full charging, during fabrication, battery assembly, and/or during one or more portions of a method described herein). A battery paste included in a second battery plate (e.g., a positive battery plate), may comprise lead dioxide, and/or may comprise both lead and lead dioxide (e.g., prior to full charging, during fabrication, during battery assembly, and/or during one or more portions of a method described herein). Grids (e.g., a grid included in a first battery plate, a grid included in a negative battery plate, a grid included in a second battery plate, a grid included in a positive battery plate), in some embodiments, include lead and/or a lead alloy.

In some embodiments, one or more battery plates (e.g., battery plates on which pasting papers are disposed, battery plates on which capacitance layers are disposed, first battery plates, negative battery plates, second battery plates, positive battery plates) may further comprise one or more additional components. For instance, a battery plate may comprise a reinforcing material, such as an expander. When present, an expander may comprise barium sulfate, carbon black and lignin sulfonate as the primary components. The components of the expander(s) (e.g., carbon black and/or lignin sulfonate, if present, and/or any other components) can be pre-mixed or not pre-mixed. In some embodiments, a battery plate may comprise a commercially available expander, such as an expander produced by Hammond Lead Products (Hammond, Ind.) (e.g., a Texex® expander) or an expander produced by Atomized Products Group, Inc. (Garland, Tex.). Further examples of reinforcing materials include chopped organic fibers (e.g., having an average length of 0.125 inch or more), glass fibers (e.g., chopped glass fibers), metal sulfate(s) (e.g., nickel sulfate, copper sulfate), red lead (e.g., a Pb₃O₄-containing material), litharge, and paraffin oil.

It should be understood that while the additional components described above may be present in any combination of battery plates in a battery (e.g., in a first or negative battery plate and a second or positive battery plate, in a first or negative battery plate but not a second or positive battery plate, in a second or positive battery plate but not a first or negative battery plate, in no battery plates), some additional components may be especially advantageous for some types of battery plates. For instance, expanders, metal sulfates, and parafins may be especially advantageous for use in second or positive battery plates. One or more of these components may be present in a second or positive battery plate, and absent in a first or negative battery plates. Some additional components described above may have utility in many types of battery plates (e.g., first battery plates, negative battery plates, second battery plates, positive battery plates). Non-limiting examples of such components include fibers (e.g., chopped organic fibers, chopped glass fibers). These components may, in some embodiments, be present in both first and second battery plates, and/or be present in both negative and positive battery plates.

When a battery plate comprises glass fibers, the glass fibers may make up any suitable amount thereof. The glass fibers may make up greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, or greater than or equal to 9 wt % of the battery plate. The glass fibers may make up less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, less than or equal to 0.75 wt %, less than or equal to 0.5 wt %, or less than or equal to 0.2 wt % of the battery plate. Combinations of the above-referenced ranges are also possible (e.g., greater than or equal to 0.1 wt % and less than or equal to 10 wt %, greater than or equal to 0.2 wt % and less than or equal to 7 wt %, or greater than or equal to 0.5 wt % and less than or equal to 5 wt %). Other ranges are also possible. The ranges above for weight percentage are based on the total dry weight of the battery plate. For example, the glass fibers may be present in an amount of greater than or equal to 0.1 wt % and less than or equal to 10 wt % of the total dry weight of the battery plate.

When present, glass fibers in a battery plate may have a variety of suitable compositions. For instance, the glass fibers may comprise silica, alumina, iron oxide, calcium oxide, magnesium oxide, boron oxide, and/or sodium oxide. One example of a suitable glass fiber is a PA10-6 fiber. PA10-6 fibers include 63-68 wt % silica, 2-6% alumina, 0.05-3 wt % iron oxide, 12-16 wt % calcium oxide, 1-6 wt % magnesium oxide, 3-8 wt % boron oxide, and 4-10 wt % sodium oxide. PA10-6 fibers also have an average fiber diameter of 3.5 microns, an aspect ratio of greater than or equal to 5:1, and a density of 2.54 g/cm³. In some embodiments, the glass fibers may comprise fibers differing from PA10-6 fibers in one or more ways (e.g., glass fibers having one or more of the properties described elsewhere herein, glass fibers having a density of greater than or equal to 2.4 g/cm³ and less than or equal to 2.6 g/cm³).

When present, glass fibers positioned in a battery plate may have any suitable average fiber diameter. The average fiber diameter of the glass fibers in the battery plate may be greater than or equal to 0.1 micron, greater than or equal to 0.2 microns, greater than or equal to 0.5 microns, greater than or equal to 0.75 microns, greater than or equal to 1 micron, greater than or equal to 1.5 microns, greater than or equal to 2 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 15 microns, greater than or equal to 20 microns, greater than or equal to 30 microns, or greater than or equal to 40 microns. The average fiber diameter of the glass fibers in the battery plate may be less than or equal to 50 microns, less than or equal to 40 microns, less than or equal to 30 microns, less than or equal to 20 microns, less than or equal to 15 microns, less than or equal to 10 microns, less than or equal to 8 microns, less than or equal to 6 microns, less than or equal to 5 microns, less than or equal to 4 microns, less than or equal to 3 microns, less than or equal to 2 microns, less than or equal to 1.5 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 micron and less than or equal to 50 microns, greater than or equal to 0.1 micron and less than or equal to 20 microns, or greater than or equal to 0.1 micron and less than or equal to 10 microns). Other ranges are also possible. One of ordinary skill in the art would be familiar with techniques that may be used to determine the average fiber diameter of glass fibers in a battery plate. Two examples of suitable techniques are transmission electron microscopy and scanning electron microscopy. Unless otherwise specified, references to an average fiber diameter of the glass fibers in the battery plate should be understood to refer to a number average diameter of the glass fibers in the battery plate.

When present, glass fibers positioned in a battery plate may have any suitable average length. The average length of the glass fibers in the battery plate may be greater than or equal to 0.001 mm, greater than or equal to 0.002 mm, greater than or equal to 0.005 mm, greater than or equal to 0.0075 mm, greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 1.5 mm, greater than or equal to 2 mm, greater than or equal to 3 mm, greater than or equal to 4 mm, greater than or equal to 5 mm, greater than or equal to 6 mm, or greater than or equal to 8 mm. The average length of the glass fibers in the battery plate may be less than or equal to 10 mm, less than or equal to 8 mm, less than or equal to 6 mm, less than or equal to 5 mm, less than or equal to 4 mm, less than or equal to 3 mm, less than or equal to 2 mm, less than or equal to 1.5 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, less than or equal to 0.02 mm, less than or equal to 0.01 mm, less than or equal to 0.0075 mm, less than or equal to 0.005 mm, or less than or equal to 0.002 mm. Combinations of the above-referenced ranges are also possible (e.g., greater than or equal to 0.001 mm and less than or equal to 10 mm, greater than or equal to 0.01 mm and less than or equal to 5 mm, or greater than or equal to 0.1 mm and less than or equal to 1 mm). Other ranges are also possible.

When present, glass fibers positioned in a battery plate may have any suitable average aspect ratio. The average aspect ratio of the glass fibers in a battery plate may be greater than or equal to 100:20, greater than or equal to 100:15, greater than or equal to 100:10, greater than or equal to 100:7, greater than or equal to 100:5, greater than or equal to 100:2, greater than or equal to 100:0.7, greater than or equal to 100:0.5, or greater than or equal to 100:0.2. The average aspect ratio of the glass fibers in a battery plate may be less than or equal to 100:0.1, less than or equal to 100:0.2, less than or equal to 100:0.5, less than or equal to 100:0.7, less than or equal to 100:2, less than or equal to 100:5, less than or equal to 100:7, less than or equal to 100:10, or less than or equal to 100:15. Combinations of the above-referenced ranges are also possible (e.g., greater than or equal to 100:20 and less than or equal to 100:0.1, greater than or equal to 100:7 and less than or equal to 100:0.2, or greater than or equal to 100:5 and less than or equal to 100:0.5). As used herein, the aspect ratio of a glass fiber in a battery plate is the ratio of the fiber diameter of the glass fiber to the length of the glass fiber. The average aspect ratio of the glass fibers in the battery plate is the average of the aspect ratios of the glass fibers in the battery plate in the plurality of glass fibers in the battery plate.

When present, glass fibers positioned in a battery plate may have any suitable average acid absorption. The average acid absorption of the glass fibers in a battery plate may be greater than or equal to 10%, greater than or equal to 20%, greater than or equal to 50%, greater than or equal to 75%, greater than or equal to 100%, greater than or equal to 200%, greater than or equal to 500%, greater than or equal to 750%, greater than or equal to 1000%, greater than or equal to 1250%, greater than or equal to 1500%, greater than or equal to 1750%, greater than or equal to 2000%, greater than or equal to 2250%, greater than or equal to 2500%, greater than or equal to 2750%, greater than or equal to 3000%, greater than or equal to 3500%, greater than or equal to 4000%, or greater than or equal to 4500%. The average acid absorption of the glass fibers in a battery plate may be less than or equal to 5000%, less than or equal to 4500%, less than or equal to 4000%, less than or equal to 3500%, less than or equal to 3000%, less than or equal to 2750%, less than or equal to 2500%, less than or equal to 2250%, less than or equal to 2000%, less than or equal to 1750%, less than or equal to 1500%, less than or equal to 1250%, less than or equal to 1000%, less than or equal to 750%, less than or equal to 500%, less than or equal to 200%, less than or equal to 100%, less than or equal to 75%, less than or equal to 30%, or less than or equal to 20%. Combinations of the above-referenced ranges are also possible (e.g., greater than or equal to 10% and less than or equal to 5000%, greater than or equal to 100% and less than or equal to 2500%, or greater than or equal to 500% and less than or equal to 1500%). Other ranges are also possible.

The acid absorption of a sample of fibers may be measured by the following procedure: (1) A one gram of the sample of fibers may be placed in a petri dish; (2) An amount of 1.28 spg sulfuric acid sufficient to wet and cover the fibers may be placed on the fibers; (3) The fibers may be soaked in the 1.28 spg sulfuric acid for five minutes; (4) The fibers may be removed from the 1.28 sulfuric acid, placed on a screen and drained for one minute; (5) The mass of the fibers may be measured to determine the wet mass of the fibers; and (6) The acid absorption of the fibers may be determined by solving the following equation: Acid absorption=((wet mass of fibers in grams−one gram)/(one gram))*(100%)).

In some embodiments, a battery comprising a battery plate on which a pasting paper as described herein is disposed and/or on which a capacitance layer as described herein is disposed may further comprise a separator. The separator may be positioned between a negative battery plate and a positive battery plate therein to prevent electronic short circuiting. Non-limiting examples of suitable separators include non-woven glass separators (e.g., absorptive glass mat (AGM) separators), poly(ethylene) separators, separators comprising a phenol resin, leaf separators, envelope separators (i.e., separators sealed on three sides), z-fold separators, sleeve separators, corrugated separators, C-wrap separators, U-wrap separators, etc. The separator, if present, may be infiltrated by an electrolyte, such as sulfuric acid (e.g., at 1.28 spg), which promotes ion transport between the two battery plates during discharge and charge.

Non-woven fiber webs, pasting papers, capacitance layers, additional layers, and stand-alone layers described herein may be produced using suitable processes, such as a wet laid process. In general, a wet laid process involves mixing together fibers of one or more type; for example, a plurality of glass fibers may be mixed together with a plurality of multicomponent fibers and a plurality of cellulose fibers to provide a fiber slurry. The slurry may be, for example, an aqueous-based slurry. In some embodiments, fibers are optionally stored separately, or in combination, in various holding tanks prior to being mixed together.

For instance, each plurality of fibers or fiber type may be mixed and pulped together in separate containers. As an example, a plurality of glass fibers may be mixed and pulped together in one container, a plurality of multicomponent fibers may be mixed and pulped in a second container, and a plurality of cellulose fibers may be mixed and pulped in a third container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture. Furthermore, it should be appreciated that other combinations of fibers types may be used in fiber mixtures, such as the fiber types described herein.

In some embodiments, a non-woven fiber web may be formed by a wet laid process. For example, in some embodiments, a single dispersion (e.g., a pulp) in a solvent (e.g., an aqueous solvent such as water) or slurry can be applied onto a wire conveyor in a papermaking machine (e.g., a fourdrinier or a rotoformer) to form a single layer supported by the wire conveyor. Vacuum may be continuously applied to the dispersion of fibers during the above process to remove the solvent from the fibers, thereby resulting in an article containing the single layer.

In some embodiments, multiple layers may be formed simultaneously or sequentially in a wet laid process. For instance, a first layer may be formed as described above, and then one or more layers may be formed on the first layer by following the same procedure. As an example, a dispersion in a solvent or slurry may be applied to a first layer on a wire conveyor, and vacuum applied to the dispersion or slurry to form a second layer on the first layer. Further layers may be formed on the first layer and the second layer by following this same process.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet laid process uses similar equipment as in a conventional papermaking process, for example, a hydropulper, a former or a headbox, a dryer, and an optional converter. A non-woven fiber web, pasting paper, capacitance layer, additional layer, or stand-alone layer can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

In some cases, the pH of the fiber slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

In some embodiments, one or more further processes may be performed after formation of a non-woven fiber web (e.g., to form an additional layer on a non-woven fiber web, to incorporate one or more further components into the non-woven fiber web). For instance, the non-woven fiber web may be exposed to a slurry comprising one or more components (e.g., a plurality of conductive species, a plurality of capacitive species, a plurality of inorganic particles, a plurality of diatomite particles, a plurality of particles configured to reduce hydrogen generation, a plurality of microcapsules). The non-woven fiber web may be immersed in the slurry (e.g., to form a fiber web comprising one or more components of the slurry), and/or the slurry may be deposited onto the non-woven fiber web (e.g., so that the fiber web after deposition of the slurry thereon comprises one or more components of the slurry; to form an additional layer disposed on the non-woven fiber web comprising one or more components of the slurry, such as a resinous layer comprising a binder resin and one or more species dispersed in the binder resin). When the slurry is deposited onto the non-woven fiber web, the depth that it penetrates into the non-woven fiber web may depend on its viscosity. For example, slurries with higher viscosities may form layers on the non-woven fiber web that penetrate little (or at all) with the non-woven fiber web. These layers may be additional layers as described elsewhere herein (e.g., layers disposed on non-woven fiber webs, additional layers that are capacitance layers, additional layers that are resinous layers). Slurries with lower viscosities may fully penetrate into the non-woven fiber web, and/or may penetrate into the non-woven fiber web such that a single layer comprising species from the slurry and comprising the non-woven fiber web is formed after exposure of the non-woven fiber web to the slurry. After exposure of the non-woven fiber web to the slurry, excess amounts of the slurry can be removed and/or the non-woven fiber web and slurry may be dried.

A variety of suitable processes may be employed to form a stand-alone layer described herein (e.g., a stand-alone layer that is a capacitance layer, a stand-alone layer that is a resinous layer). In some embodiments, a stand-alone layer is fabricated by forming a slurry comprising the components of the stand-alone layer (e.g., a plurality of conductive species, a plurality of capacitive species, a binder resin, fibers). The slurry may be applied to a scrim, and then removed from the scrim (e.g., during winding).

After formation of a pasting paper, a capacitance layer, an additional layer, or a stand-alone layer (e.g., an additional layer, a stand-alone capacitive layer), the pasting paper, the capacitance layer, the additional layer or the stand-alone layer may be incorporated into a battery plate. For instance, the pasting paper, the capacitance layer, the additional layer, or the stand-alone layer may be disposed on a battery plate. Battery plates for lead-acid batteries are typically formed by positioning a battery paste comprising lead and/or lead dioxide on a metal grid. After a battery plate is formed, the pasting paper, the capacitance layer, the additional layer, or the stand-alone layer may then be positioned on (and, optionally, at least partially embedded in) the battery paste therein. Then, the pasting paper-covered, capacitance-layer covered, additional-layer covered, or stand-alone layer-covered battery plate may undergo further manufacturing steps, such as being cut to form plates appropriately sized for inclusion in a battery, and/or being cured in an oven.

Once ready for inclusion in a final battery, the pasting paper-covered, capacitance-layer covered, additional-layer covered, or stand-alone layer-covered battery plate may be assembled with other battery components, such as an additional battery plate (e.g., a negative battery plate may be assembled with a positive battery plate), a separator, etc. These components may be placed in an external casing, and, optionally compressed. If compressed, the thickness of one or more battery components (e.g., a pasting paper disposed on a battery plate) may be reduced. Then, an electrolyte, such as 1.28 spg sulfuric acid, may be added to the battery.

After assembly, the battery may undergo a formation step, during which the battery becomes fully charged and ready for operation. Formation may involve passing an electric current through an assembly of alternating negative and positive battery plates separated by separators. During formation, the battery paste in the negative and positive battery plates may be converted into negative and positive active materials, respectively. For example, lead dioxide in a battery paste disposed on the negative battery plate may be transformed into lead, and/or lead in a battery paste disposed on the positive battery plate may be transformed into lead dioxide.

When present, a plurality of cellulose fibers in a pasting paper may dissolve in an electrolyte over any suitable period of time after the addition of the electrolyte to the battery. For instance, at least a portion of the plurality of cellulose fibers, or all of the plurality of cellulose fibers, may be dissolved in the electrolyte prior to formation. In some embodiments, at least a portion of a plurality of cellulose fibers, or all of the plurality of cellulose fibers, dissolve in the electrolyte during formation. In some embodiments, at least a portion of the plurality of cellulose fibers, or all of the plurality of cellulose fibers, may be dissolved in the electrolyte after formation.

Paragraph 1: In some embodiments, a lead-acid battery is provided. The lead-acid battery comprises a battery plate comprising lead and a pasting paper disposed on the battery plate. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron.

Paragraph 2: In some embodiments, a lead-acid battery comprises a battery plate comprising lead and a pasting paper disposed on the battery plate. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % of the non-woven fiber web based on the total weight of the non-woven fiber web.

Paragraph 3: In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The plurality of cellulose fibers makes up greater than or equal to 20 wt % and less than or equal to 80 wt % of the non-woven fiber web based on the total weight of the non-woven fiber web. The plurality of multicomponent fibers makes up greater than or equal to 10 wt % and less than or equal to 50 wt % of the non-woven fiber web based on the total weight of the non-woven fiber web. The plurality of glass fibers makes up greater than or equal to 10 wt % and less than or equal to 50 wt % of the non-woven fiber web based on the total weight of the non-woven fiber web. In some cases, the pasting paper has a thickness of less than 0.2 mm.

Paragraph 4: In some embodiments, a pasting paper for use in a battery is provided. The pasting paper comprises a non-woven fiber web comprising a plurality of cellulose fibers, a plurality of multicomponent fibers, and a plurality of glass fibers. Each of the plurality of cellulose fibers, plurality of multicomponent fibers, and plurality of glass fibers has an average fiber diameter of greater than or equal to 1 micron. The pasting paper has a thickness of less than 0.2 mm, an air permeability of less than or equal to 300 CFM, a 1.28 spg sulfuric acid wicking height of greater than or equal to 3 cm, and/or is configured to have a dry tensile strength in a machine direction of greater than or equal to 1 lb/in after storage in 1.28 spg sulfuric acid at 75° C. for 7 days.

Paragraph 5: In some embodiments, methods of forming battery plates are provided. A method of forming a battery plate comprises disposing a pasting paper on a battery paste comprising lead. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron.

Paragraph 6: In some embodiments, a method of forming a battery plate comprises disposing a pasting paper on a battery paste comprising lead. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

Paragraph 7: In some embodiments, methods of assembling lead-acid batteries are provided. A method of assembling a lead-acid battery comprises assembling a first battery plate comprising lead with a separator and a second battery plate to form a lead-acid battery. A pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron.

Paragraph 8: In some embodiments, a method of assembling a lead-acid battery comprises assembling a first battery plate comprising lead with a separator and a second battery plate to form a lead-acid battery. A pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web.

Paragraph 9: In some embodiments, methods of forming lead-acid batteries are provided. A method of forming a lead-acid battery comprises assembling a first battery plate comprising lead with a separator, an electrolyte, and a second battery plate to form a lead-acid battery. The pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The method further comprises dissolving at least a portion of the plurality of cellulose fibers within the pasting paper in the electrolyte.

Paragraph 10: In some embodiments, a method of forming a lead-acid battery comprises assembling a first battery plate comprising lead with a separator, an electrolyte, and a second battery plate to form a lead-acid battery. The pasting paper is disposed on the first battery plate. The pasting paper comprises a non-woven fiber web comprising a plurality of cellulose fibers, a plurality of multicomponent fibers having an average fiber diameter of greater than or equal to 1 micron, and a plurality of glass fibers having an average fiber diameter of greater than or equal to 1 micron. The plurality of cellulose fibers makes up greater than or equal to 20 wt % of the non-woven fiber web based on the total weight of the non-woven fiber web. The method further comprises dissolving at least a portion of the plurality of cellulose fibers within the pasting paper in the electrolyte.

Paragraph 11: In some embodiments, a pasting paper described in any one of paragraphs 1-10 has an air permeability of less than or equal to 300 CFM (e.g., an air permeability of greater than or equal to 2 CFM and less than or equal to 1300 CFM, an air permeability of greater than or equal to 20 CFM and less than or equal to 400 CFM, an air permeability of greater than or equal to 40 CFM and less than or equal to 250 CFM).

Paragraph 12: In some embodiments, a pasting paper described in any one of paragraphs 1-11 has a 1.28 spg sulfuric acid wicking height of greater than or equal to 3 cm (e.g., a 1.28 spg sulfuric acid wicking height of greater than or equal to 3 cm and less than or equal to 20 cm, a 1.28 spg sulfuric acid wicking height of greater than or equal to 5 cm and less than or equal to 10 cm, a 1.28 spg sulfuric acid wicking height of greater than or equal to 5 cm and less than or equal to 7 cm).

Paragraph 13: In some embodiments, a pasting paper described in any one of paragraphs 1-12 is configured to have a dry tensile strength in a machine direction of greater than or equal to 1 lb/in after storage in 1.28 spg sulfuric acid at 75° C. for 7 days (e.g., a dry tensile strength in a machine direction of greater than or equal to 0.2 lbs/in and less than or equal to 10 lb/in after storage in 1.28 spg sulfuric acid at 75° C. for 7 days, a dry tensile strength in a machine direction of greater than or equal to 1 lb/in and less than or equal to 10 lbs/in after storage in 1.28 spg sulfuric acid at 75° C. for 7 days, a dry tensile strength in a machine direction of greater than or equal to 0.5 lbs/in and less than or equal to 5 lbs/in after storage in 1.28 spg sulfuric acid at 75° C. for 7 days, a dry tensile strength in a machine direction of greater than or equal to 1 lb/in and less than or equal to 5 lbs/in after storage in 1.28 spg sulfuric acid at 75° C. for 7 days, a dry tensile strength in a machine direction of greater than or equal to 1 lb/in and less than or equal to 3 lbs/in after storage in 1.28 spg sulfuric acid at 75° C. for 7 days, a dry tensile strength in a machine direction of greater than or equal to 1 lb/in and less than or equal to 2 lbs/in after storage in 1.28 spg sulfuric acid at 75° C. for 7 days).

Paragraph 14: In some embodiments, a pasting paper as described in any one of paragraphs 1-13 has a composition such that a binder resin makes up less than or equal to 10 wt %, less than or equal to 5 wt %, or less than or equal to 2 wt % of the pasting paper based on the total weight of the pasting paper.

Paragraph 15: In some embodiments, a plurality of cellulose fibers as described in any one of paragraphs 1-14 comprises fibrillated cellulose fibers.

Paragraph 16: In some embodiments, a plurality of cellulose fibers as described in any one of paragraphs 1-15 has a Canadian Standard Freeness of greater than or equal to 45 CSF and less than or equal to 800 CSF (e.g., a Canadian Standard Freeness of greater than or equal to 45 CSF and less than or equal to 800 CSF, a Canadian Standard Freeness of greater than or equal to 300 CSF and less than or equal to 700 CSF, a Canadian Standard Freeness of greater than or equal to 550 CSF and less than or equal to 650 CSF).

Paragraph 17: In some embodiments, a plurality of glass fibers as described in any one of paragraphs 1-16 comprises microglass fibers.

Paragraph 18: In some embodiments, a plurality of glass fibers as described in any one of paragraphs 1-17 comprises chopped strand glass fibers.

Paragraph 19: In some embodiments, a pasting paper as described in any one of paragraphs 1-18 has a mean pore size of greater than or equal to 2 microns and less than or equal to 100 microns (e.g., a mean pore size of greater than or equal to 5 microns and less than or equal to 70 microns, a mean pore size of greater than or equal to 10 microns and less than or equal to 50 microns).

Paragraph 20: In some embodiments, a pasting paper as described in any one of paragraphs 1-19 has a specific surface area of greater than or equal to 0.1 m²/g and less than or equal to 10 m²/g (e.g., a specific surface area of greater than or equal to 0.3 m²/g and less than or equal to 2 m²/g, a specific surface area of greater than or equal to 0.4 m²/g and less than or equal to 0.8 m²/g).

Paragraph 21: In some embodiments, a pasting paper as described in any one of paragraphs 1-20 is configured to have a mean pore size of greater than or equal to 2 microns and less than or equal to 300 microns after storage in 1.28 spg sulfuric acid at 75° C. for 7 days (e.g., a mean pore size of greater than or equal to 5 microns and less than or equal to 200 microns after storage in 1.28 spg sulfuric acid at 75° C. for 7 days, a mean pore size of greater than or equal to 10 microns and less than or equal to 150 microns after storage in 1.28 spg sulfuric acid at 75° C. for 7 days).

Paragraph 22: In some embodiments, a pasting paper as described in any one of paragraphs 1-21 is configured to have an air permeability of greater than or equal to 100 CFM and less than or equal to 1300 CFM after storage in 1.28 spg sulfuric acid at 75° C. for 7 days (e.g., an air permeability of greater than or equal to 200 CFM and less than or equal to 1300 CFM after storage in 1.28 spg sulfuric acid at 75° C. for 7 days, an air permeability of greater than or equal to 300 CFM and less than or equal to 1000 CFM after storage in 1.28 spg sulfuric acid at 75° C. for 7 days).

Paragraph 23: In some embodiments, a pasting paper as described in any one of paragraphs 1-22 has an electrical resistance of greater than or equal to 5 milliΩ·cm² and less than or equal to 100 milliΩ·cm² (e.g., an electrical resistance of greater than or equal to 5 milliΩ·cm² and less than or equal to 50 milliΩ·cm², an electrical resistance of greater than or equal to 5 milliΩ·cm² and less than or equal to 30 milliΩ·cm²).

Paragraph 24: In some embodiments, a method as described in any one of paragraphs 1-23 further comprises positioning the battery plate in a battery.

Paragraph 25: In some embodiments, a method as described in any one of paragraphs 1-24 further comprises exposing the battery plate to an electrolyte.

Paragraph 26: In some embodiments, an electrolyte as described in any one of paragraphs 1-25 comprises sulfuric acid (e.g., the electrolyte comprises 1.28 spg sulfuric acid).

Paragraph 27: In some embodiments, upon exposure of a battery plate described in any one of paragraphs 1-26 to the electrolyte, at least a portion of the pasting paper dissolves in the electrolyte.

Paragraph 28: In some embodiments, after dissolution of at least a portion of a pasting paper as described in any one of paragraphs 1-27 in the electrolyte, the non-woven fiber web is a porous non-woven fiber web comprising the plurality of glass fibers and the plurality of multicomponent fibers.

Paragraph 29: In some embodiments, after dissolution of at least a portion of a pasting paper described in any one of paragraphs 1-28 in the electrolyte, a mean pore size of the pasting paper is greater than a mean pore size of the pasting paper prior to dissolution of at least a portion of the pasting paper in the electrolyte.

Paragraph 30: In some embodiments, after dissolution of at least a portion of the pasting paper in the electrolyte, an air permeability of a pasting paper described in any one of paragraphs 1-29 is greater than an air permeability of the pasting paper prior to dissolution of at least a portion of the pasting paper in the electrolyte.

Paragraph 31: In some embodiments, a pasting paper for use in a battery comprises a non-woven fiber web comprising a plurality of cellulose fibers and a plurality of multicomponent fibers. The plurality of cellulose fibers makes up greater than or equal to 20 wt % of the non-woven fiber web based on the total weight of the non-woven fiber web. The pasting paper further comprises a plurality of conductive species. The plurality of conductive species comprises conductive fibers and/or conductive particles.

Paragraph 32: In some embodiments, the non-woven fiber web of a pasting paper as described in paragraph 31 comprises a plurality of glass fibers.

Paragraph 33: In some embodiments, the plurality of a conductive species of a pasting paper as described in any one of paragraphs 31-32 comprises conductive fibers.

Paragraph 34: In some embodiments, the plurality of conductive species of a pasting paper as described in any one of paragraphs 31-33 comprises conductive particles.

Paragraph 35: In some embodiments, the non-woven fiber web of a pasting paper as described in any one of paragraphs 31-34 comprises the conductive species.

Paragraph 36: In some embodiments, a pasting paper as described in any one of paragraphs 31-35 comprises a layer disposed on the non-woven fiber web comprising the conductive species.

Paragraph 37: In some embodiments, the layer of a pasting paper described in any one of paragraphs 31-36 comprising the conductive species comprises a binder resin.

Paragraph 38: In some embodiments, a conductive species of a pasting paper as described in paragraph 37 is dispersed within the binder resin.

Paragraph 39: In some embodiments, a binder resin of a pasting paper as described in any one of paragraphs 37-38 makes up greater than or equal to 0.5 wt % and less than or equal to 30 wt % of the layer comprising the conductive species.

Paragraph 40: In some embodiments, a pasting paper for use in a battery comprises a non-woven fiber web comprising a plurality of cellulose fibers, a plurality of multicomponent fibers, and a plurality of glass fibers. The plurality of cellulose fibers makes up greater than or equal to 20 wt % of the non-woven fiber web based on the total weight of the non-woven fiber web. The pasting paper further comprises a plurality of conductive species and a plurality of capacitive species. A ratio of the weight of the plurality of conductive species to the plurality of capacitive species is greater than or equal to 5:95 and less than or equal to 30:70.

Paragraph 41: In some embodiments, the plurality of conductive species of a pasting paper as described in paragraph 40 comprises conductive fibers.

Paragraph 42: In some embodiments, the plurality of conductive species of a pasting paper as described in any one of paragraphs 40-41 comprises conductive particles.

Paragraph 43: In some embodiments, the non-woven fiber web of a pasting paper as described in any one of paragraphs 40-42 comprises the conductive species.

Paragraph 44: In some embodiments, a pasting paper as described in any one of paragraphs 40-43 comprises a layer disposed on the non-woven fiber web comprising the conductive species.

Paragraph 45: In some embodiments, the layer of a pasting paper as described in any one of paragraphs 40-44 comprising a conductive species comprises a binder resin.

Paragraph 46: In some embodiments, the conductive species of a pasting paper as described in paragraph 45 is dispersed within the binder resin.

Paragraph 47: In some embodiments, the binder resin of a pasting paper as described in any one of paragraphs 45-46 makes up greater than or equal to 0.5 wt % and less than or equal to 30 wt % of the layer comprising the conductive species.

Paragraph 48: In some embodiments, the plurality capacitive species of a pasting paper as described in any one of paragraphs 40-47 comprises capacitive fibers.

Paragraph 49: In some embodiments, the plurality of capacitive species of a pasting paper as described in any one of paragraphs 40-48 comprises capacitive particles.

Paragraph 50: In some embodiments, the non-woven fiber web of a pasting paper as described in any one of paragraphs 40-49 comprises the capacitive species.

Paragraph 51: In some embodiments, a pasting paper as described in any one of paragraphs 40-50 comprises a layer disposed on the non-woven fiber web comprising the capacitive species.

Paragraph 52: In some embodiments, the layer of a pasting paper as described in paragraph 51 disposed on the non-woven fiber web and comprising the capacitive species comprises the conductive species.

Paragraph 53: In some embodiments, the layer of a pasting paper as described in any one of paragraphs 40-52 comprising the capacitive species comprises a binder resin.

Paragraph 54: In some embodiments, the capacitive species of a pasting paper described in any one of paragraphs 40-53 is dispersed within the binder resin.

Paragraph 55: In some embodiments, the binder resin of a pasting paper as described in any one of paragraphs 40-55 makes up greater than or equal to 0.5 wt % and less than or equal to 30 wt % of the layer comprising the capacitive species.

Paragraph 56: In some embodiments, a battery comprises a battery plate comprising an active mass comprising lead and a layer comprising a plurality of conductive species and a plurality of capacitive species. A ratio of a weight of the plurality of conductive species to a weight of a plurality of capacitive species is greater than or equal to 5:95 and less than or equal to 30:70. A ratio of a sum of a weight of the plurality of conductive species and a weight of the plurality of capacitive species to a weight of the active mass is less than 1:100.

Paragraph 57: In some embodiments, the plurality of conductive species of a battery as described in paragraph 56 comprises conductive fibers.

Paragraph 58: In some embodiments, the plurality of conductive species of a battery as described in any one of paragraphs 56-57 comprises conductive particles.

Paragraph 59: In some embodiments, the plurality capacitive species of a battery as described in any one of paragraphs 56-58 comprises capacitive fibers.

Paragraph 60: In some embodiments, the plurality of capacitive species of a pasting paper as described in any one of paragraphs 56-59 comprises capacitive particles.

Paragraph 61: In some embodiments, the layer of a battery as described in any one of paragraphs 56-60 comprises a non-woven fiber web.

Paragraph 62: In some embodiments, the layer or a battery as described in any one of paragraphs 56-60 is disposed on a non-woven fiber web.

Paragraph 63: In some embodiments, the layer of a battery as described in any one of paragraphs 56-62 comprises a binder resin.

Paragraph 64: In some embodiments, the conductive species of a battery as described in paragraph 63 is dispersed within the binder resin.

Paragraph 65: In some embodiments, the binder resin of a battery as described in any one of paragraphs 63-64 makes up greater than or equal to 0.5 wt % and less than or equal to 30 wt % of the layer.

Paragraph 66: In some embodiments, the non-woven fiber web of a battery as described in any one of claims 61-65 comprises a plurality of cellulose fibers.

Paragraph 67: In some embodiments, the non-woven fiber web of a battery as described in any one of paragraphs 61-66 comprises a plurality of multicomponent fibers.

Paragraph 68: In some embodiments, the non-woven fiber web of a battery as described in any one of paragraphs 61-67 comprises a plurality of glass fibers.

Paragraph 69: In some embodiments, a battery as described in any one of paragraphs 56-68 is configured such that the ratio of the sum of the weight of the plurality of conductive species and the weight of the plurality of capacitive species to the weight of the active mass is less than or equal to 1:200.

Paragraph 70: In some embodiments, a battery as described in any one of paragraphs 56-69 is configured such that the ratio of the sum of the weight of the plurality of conductive species and the weight of the plurality of capacitive species to the weight of the active mass is less than or equal to 1:500.

Paragraph 71: In some embodiments, a battery as described in any one of paragraphs 56-70 is configured such that the ratio of the sum of the weight of the plurality of conductive species and the weight of the plurality of capacitive species to the weight of the active mass is greater than or equal to 1:1000.

Paragraph 72: In some embodiments, a pasting paper for use in a battery comprises a non-woven fiber web comprising a plurality of cellulose fibers, a plurality of multicomponent fibers, and a plurality of glass fibers. The plurality of cellulose fibers makes up greater than or equal to 20 wt % of the non-woven fiber web based on the total weight of the non-woven fiber web. The pasting paper further comprises a plurality of inorganic particles.

Paragraph 73: In some embodiments, the inorganic particles of a pasting paper as described in paragraph 72 comprise silica.

Paragraph 74: In some embodiments, the silica of a pasting paper as described in paragraph 73 is fumed silica.

Paragraph 75: In some embodiments, the inorganic particles of a pasting paper as described in any one of paragraphs 72-74 comprise barium sulfate.

Paragraph 76: In some embodiments, the non-woven fiber web of a pasting paper as described in any one of paragraphs 72-75 comprises the inorganic particles.

Paragraph 77: In some embodiments, the non-woven fiber web of a pasting paper as described in any one of paragraphs 72-76 comprises a layer disposed on the non-woven fiber web comprising the inorganic particles.

Paragraph 78: In some embodiments, the layer of a pasting paper as described in any one of paragraphs 72-77 comprising the inorganic particles comprises a binder resin.

Paragraph 79: In some embodiments, the inorganic particles of a pasting paper as described in paragraph 78 are dispersed within the binder resin.

Paragraph 80: In some embodiments, the binder resin of a pasting paper as described in any one of paragraphs 79-80 makes up greater than or equal to 0.5 wt % and less than or equal to 30 wt % of the layer comprising the inorganic particles.

Paragraph 81: In some embodiments, the inorganic particles of a pasting paper as described in any one of paragraphs 72-80 make up greater than or equal to 0.1 wt % and less than or equal to 60 wt % of the pasting paper.

Paragraph 82: In some embodiments, the inorganic particles of a pasting paper as described in any one of paragraphs 72-81 have an average diameter of greater than or equal to 0.01 micron and less than or equal to 50 microns.

Paragraph 83: In some embodiments, a method of forming a battery plate comprises disposing a pasting paper on a battery paste comprising lead. The pasting paper comprises a non-woven fiber web comprising a plurality of cellulose fibers and a plurality of multicomponent fibers having an average fiber diameter of greater than or equal to 1 micron. The plurality of cellulose fibers makes up greater than or equal to 20 wt % of the non-woven fiber web based on the total weight of the non-woven fiber web. The pasting paper further comprises one or more of a plurality of conductive species, a plurality of capacitive species, and a plurality of inorganic particles.

Paragraph 84: In some embodiments, a pasting paper for use in a battery comprises a non-woven fiber web. The non-woven fiber web comprises a plurality of fibers. The pasting paper comprises barium oxide in an amount of greater than or equal to 0.1 wt % and less than or equal to 10 wt %.

Paragraph 85: In some embodiments, the plurality of fibers of a pasting paper as described in paragraph 84 comprises glass fibers.

Paragraph 86: In some embodiments, the glass fibers of a pasting paper as described in paragraph 85 comprise barium oxide.

Paragraph 87: In some embodiments, the plurality of fibers of a pasting paper as described in any one of paragraphs 84-86 comprises cellulose fibers.

Paragraph 88: In some embodiments, the plurality of fibers of a pasting paper as described in any one of paragraphs 84-87 comprises multicomponent fibers.

Paragraph 89: In some embodiments, a pasting paper as described in any one of paragraphs 84-88 comprises a plurality of conductive species.

Paragraph 90: In some embodiments, the plurality of conductive species of a pasting paper as described in paragraph 89 comprises conductive fibers.

Paragraph 91: In some embodiments, the plurality of conductive species of a pasting paper as described in any one of paragraphs 89-90 comprises conductive particles.

Paragraph 92: In some embodiments, the non-woven fiber web of a pasting paper, battery, or method of any one of paragraphs 31-91 comprises a binder resin.

Paragraph 93: In some embodiments, the plurality of cellulose fibers of a pasting paper, battery, or method as described in any one of paragraphs 31-92 has an average fiber diameter of greater than or equal to 1 micron.

Paragraph 94: In some embodiments, the cellulose fibers of a pasting paper, battery, or method as described in any one of paragraphs 31-93 make up greater than or equal to 20 wt % and less than or equal to 80 wt % of the non-woven fiber web based upon the total weight of the non-woven fiber web.

Paragraph 95: In some embodiments, the plurality of cellulose fibers of a pasting paper, battery, or method as described in any one of paragraphs 31-94 comprises fibrillated cellulose fibers.

Paragraph 96: In some embodiments, the cellulose fibers of a pasting paper, battery, or method as described in any one of paragraphs 31-95 have a Canadian standard freeness of greater than or equal to 45 CSF and less than or equal to 800 CSF.

Paragraph 97: In some embodiments, the plurality of multicomponent fiber of a pasting paper, battery, or method as described in any one of paragraphs 31-96 has an average fiber diameter of greater than or equal to 1 micron.

Paragraph 98: In some embodiments, the plurality of glass fibers of a pasting paper, battery, or method as described in any one of paragraphs 31-97 has an average fiber diameter of greater than or equal to 1 micron.

Paragraph 99: In some embodiments, a plurality of glass fibers of a pasting paper, battery, or method as described in any one of paragraphs 31-98 comprises microglass fibers.

Paragraph 100: In some embodiments, a plurality of glass fibers of a pasting paper, battery, or method as described in any one of paragraphs 31-99 comprises chopped strand glass fibers.

Paragraph 101: In some embodiments, the conductive fibers of a pasting paper, battery, or method as described in any one of paragraphs 31-100 have an average fiber diameter of greater than or equal to 0.1 micron and less than or equal to 100 microns.

Paragraph 102: In some embodiments, the conductive fibers of a pasting paper, battery, or method as described in any one of paragraphs 31-101 make up greater than or equal to 0.1 wt % and less than or equal to 70 wt % of the pasting paper.

Paragraph 103: In some embodiments, the conductive fibers of a pasting paper, battery, or method as described in any one of paragraphs 31-102 have an average conductivity of greater than or equal to 1 and less than or equal to 300,000 S/m.

Paragraph 104: In some embodiments, the conductive particles of a pasting paper, battery, or method as described in any one of paragraphs 31-103 have an average diameter of greater than or equal to 0.001 micron and less than or equal to 100 microns.

Paragraph 105: In some embodiments, the conductive particles of a pasting paper, battery, or method as described in any one of paragraphs 31-104 make up greater than or equal to 0.1 wt % and less than or equal to 50 wt % of the pasting paper.

Paragraph 106: In some embodiments, the conductive particles of a pasting paper, battery, or method as described in any one of paragraphs 31-105 have an average electrical conductivity of greater than or equal to 1 and less than or equal to 300,000 S/m.

Paragraph 107: In some embodiments, the capacitive particles of a pasting paper, battery, or method as described in any one of paragraphs 31-106 have an average diameter of greater than or equal to 0.01 micron and less than or equal to 400 microns.

Paragraph 108: In some embodiments, the capacitive particles of a pasting paper, battery, or method as described in any one of paragraphs 31-107 make up greater than or equal to 0.1 wt % and less than or equal to 50 wt % of the pasting paper.

Paragraph 109: In some embodiments, the capacitive particles of a pasting paper, battery, or method as described in any one of paragraphs 31-108 have an average specific capacitance of greater than or equal to 1 F/g and less than or equal to 500 F/g.

Paragraph 110: In some embodiments, the binder resin of a pasting paper, battery, or method as described in any one of paragraphs 31-109 makes up less than or equal to 10 wt %, less than or equal to 5 wt %, less than or equal to 2 wt %, or 0 wt % of the non-woven fiber web.

Paragraph 111: In some embodiments, a pasting paper as described in any one of paragraphs 31-110 and/or the pasting paper of a battery or method as described in any one of paragraphs 31-110 has an air permeability of greater than or equal to 0.5 CFM and less than or equal to 300 CFM or greater than or equal to 500 CFM and less than or equal to 1000 CFM.

Paragraph 112: In some embodiments, a pasting paper as described in any one of paragraphs 31-111 and/or the pasting paper of a battery or method as described in any one of paragraphs 31-111 is configured to have an air permeability of greater than or equal to 0.5 CFM and less than or equal to 1300 CFM after storage in 1.28 spg sulfuric acid at 75° C. for 7 days.

Paragraph 113: In some embodiments, a pasting paper as described in any one of paragraphs 31-112 and/or the pasting paper of a battery or method as described in any one of paragraphs 31-112 has a 1.28 spg sulfuric acid wicking height of greater than or equal to 0.5 cm.

Paragraph 114: In some embodiments, a pasting paper as described in any one of paragraphs 31-113 and/or the pasting paper of a battery or method as described in any one of paragraphs 31-113 is configured to have a dry tensile strength in a machine direction of greater than or equal to 1 lb/in after storage in 1.28 spg sulfuric acid at 75° C. for 7 days.

Paragraph 115: In some embodiments a pasting paper as described in any one of paragraphs 31-114 and/or the pasting paper of a battery or method as described in any one of paragraphs 31-114 is configured to absorb greater than or equal to 5 g/m² and less than or equal to 100 g/m² of water.

Paragraph 116: In some embodiments, a pasting paper as described in any one of paragraphs 31-115 and/or the pasting paper of a battery or method as described in any one of paragraphs 31-115 has a mean pore size of greater than or equal to 0.1 micron and less than or equal to 100 microns.

Paragraph 117: In some embodiments, a pasting paper as described in any one of paragraphs 31-116 and/or the pasting paper of a battery or method as described in any one of paragraphs 31-116 is configured to have a mean pore size of greater than or equal to 0.1 micron and less than or equal to 300 microns after storage in 1.28 spg sulfuric acid at 75° C. for 7 days.

Paragraph 118: In some embodiments, a pasting paper as described in any one of paragraphs 31-117 and/or the pasting paper of a battery or method as described in any one of paragraphs 31-117 has a specific surface area of greater than or equal to 0.1 m²/g and less than or equal to 3500 m²/g.

Paragraph 119: In some embodiments, a pasting paper as described in any one of paragraphs 31-118 and/or the pasting paper of a battery or method as described in any one of paragraphs 31-118 has a specific surface area of greater than or equal to 0.1 m²/g and less than or equal to 3500 m²/g after storage in 1.28 spg sulfuric acid at 75° C. for 7 days.

Paragraph 120: In some embodiments, a pasting paper as described in any one of paragraphs 31-119 and/or the pasting paper of a battery or method as described in any one of paragraphs 31-119 has an electrical resistance of greater than or equal to 5 milliΩ·cm² and less than or equal to 100 milliΩ·cm².

Paragraph 121: In some embodiments, a pasting paper as described in any one of paragraphs 31-120 and/or the pasting paper of a battery or method as described in any one of paragraphs 31-120 has an electrical conductivity of greater than or equal to 1 S/m and less than or equal to 300,000 S/m.

Paragraph 122: In some embodiments, a pasting paper as described in any one of paragraphs 31-121 and/or the pasting paper of a battery or method as described in any one of paragraphs 31-121 has a specific capacitance of greater than or equal to 1 F/g and less than or equal to 250 F/g.

Paragraph 123: In some embodiments, the battery of any one of claims 31-122 is a lead-acid battery.

Paragraph 124: In some embodiments, a pasting paper as described in any one of paragraphs 31-123 and/or the pasting paper of a battery or method as described in any one of paragraphs 31-123 is disposed on a battery plate.

Paragraph 125: In some embodiments, a pasting paper as described in any one of paragraphs 31-124 and/or the pasting paper of a battery or method as described in any one of paragraphs 31-124 comprises a non-woven fiber web and a layer disposed on the non-woven fiber web, and wherein the layer disposed on the non-woven fiber web is facing the battery plate.

Paragraph 126: In some embodiments, the layer facing the battery plate of a pasting paper, battery, or method as described in any one of paragraphs 31-125 comprises the conductive species.

Paragraph 127: In some embodiments, the layer facing the battery plate of a pasting paper, battery, or method as described in any one of paragraphs 31-126 comprises the capacitive species.

Paragraph 128: In some embodiments, the layer facing the battery plate of a pasting paper, battery, or method as described in any one of paragraphs 31-127 comprises the inorganic particles.

Paragraph 129: In some embodiments, the battery plate of a pasting paper, battery, or method as described in any one of paragraphs 31-128 comprises lead.

Paragraph 130: In some embodiments, a method as described in any one of paragraphs 31-129 further comprises positioning the battery plate in a battery.

Paragraph 131; In some embodiments, a method as described in any one of paragraphs 31-130 further comprises exposing the battery plate to an electrolyte.

Paragraph 132: In some embodiments, an electrolyte of a pasting paper, battery, or method as described in any one of paragraphs 31-131 comprises sulfuric acid.

Paragraph 133: In some embodiments, upon exposure of a battery plate of a pasting paper, battery, or method as described in any one of paragraphs 124-132 to the electrolyte, at least a portion of the pasting paper dissolves in the electrolyte.

Paragraph 134: In some embodiments, after dissolution of at least a portion of a pasting paper as described in any one of paragraphs 31-133 and/or a battery or method of any one of paragraphs 31-133 in the electrolyte, a mean pore size of the pasting paper is greater than a mean pore size of the pasting paper prior to dissolution of at least a portion of the pasting paper in the electrolyte.

Paragraph 135: In some embodiments, after dissolution of at least a portion of a pasting paper as described in any one of paragraphs 31-134 and/or a battery or method of any one of paragraphs 31-134 in the electrolyte, an air permeability of the pasting paper is greater than an air permeability of the pasting paper prior to dissolution of at least a portion of the pasting paper in the electrolyte.

Paragraph 136: In some embodiments, a pasting paper as described in any one of paragraphs 31-135 and/or the pasting paper of a battery or method as described in any one of paragraphs 31-135 comprises barium oxide.

Paragraph 137: In some embodiments, the non-woven fiber web of a pasting paper, battery, or method as described in any one of paragraphs 31-136 comprises the barium oxide.

Paragraph 138: In some embodiments, the non-woven fiber web of a pasting paper, battery, or method as described in any one of paragraphs 31-137 comprises a plurality of glass fibers comprising the barium oxide.

Paragraph 139: In some embodiments, the plurality of glass fibers of a pasting paper, battery, or method as described in any one of paragraphs 31-138 comprises glass fibers comprising barium oxide in an amount of greater than or equal to 0.1 wt % and less than or equal to 10 wt %.

Paragraph 140: In some embodiments, the conductive fibers of a pasting paper, battery, or method as described in any one of paragraphs 31-139 make up greater than or equal to 5 wt % and less than or equal to 30 wt % of the layer, the non-woven fiber web, or the layer disposed on the non-woven fiber web.

Paragraph 141: In some embodiments, the conductive fibers of a pasting paper, battery, or method as described in any one of paragraphs 31-140 comprise a carbon-containing material.

Paragraph 142: In some embodiments, the conductive fibers of a pasting paper, battery, or method as described in any one of paragraphs 31-141 comprise carbon fibers, pitch-based materials, and/or poly(acrylonitrile).

Paragraph 143: In some embodiments, the conductive fibers of a pasting paper, battery, or method as described in any one of paragraphs 31-142 have an average fiber diameter of greater than or equal to 0.1 micron and less than or equal to 100 microns.

Paragraph 144: In some embodiments, the conductive fibers of a pasting paper, battery, or method as described in any one of paragraphs 31-143 have an average fiber diameter of greater than or equal to 2 microns and less than or equal to 30 microns.

Paragraph 145: In some embodiments, the conductive fibers of a pasting paper, battery, or method as described in any one of paragraphs 31-144 have an average length of greater than or equal to 0.1 mm and less than or equal to 500 mm.

Paragraph 146: In some embodiments, the conductive fibers of a pasting paper, battery, or method as described in any one of paragraphs 31-145 have an average length of greater than or equal to 1 mm and less than or equal to 20 mm.

Paragraph 147: In some embodiments, the conductive particles or a pasting paper, battery, or method as described in any one of paragraphs 31-146 make up greater than or equal to 5 wt % and less than or equal to 30 wt % of the layer, the non-woven fiber web, or the layer disposed on the non-woven fiber web.

Paragraph 148: In some embodiments, the conductive particles of the pasting paper, battery, or method as described in any one of paragraphs 31-147 comprise a metal, a metalloid and/or an oxide.

Paragraph 149: In some embodiments, the metal and/or metalloid of the conductive particles of the pasting paper, battery, or method as described in any one of paragraphs 31-148 comprises germanium, silver, copper, gold, and/or platinum.

Paragraph 150: In some embodiments, the oxide of the conductive particles of the pasting paper, battery, or method as described in any one of paragraphs 31-149 comprises tin oxide and/or molybdenum oxide.

Paragraph 151: In some embodiments, the conductive particles of the pasting paper, battery, or method of any one of claims 31-150 comprise a carbon-containing material.

Paragraph 152: In some embodiments, the carbon-containing material of the conductive particles of the pasting paper, battery, or method as described in any one of paragraphs 31-151 comprises carbon black and/or acetylene black.

Paragraph 153: In some embodiments, the carbon-containing material of the conductive particles of the pasting paper, battery, or method as described in any one of paragraphs 31-152 comprises carbon nanotubes, graphite, glassy carbon, highly-oriented pyrolytic graphite, and/or pure and ordered synthetic graphite.

Paragraph 154: In some embodiments, the carbon nanotubes of the pasting paper, battery, or method as described in any one of paragraphs 31-153 make up less than or equal to 10 wt % and greater than or equal to 0.01 wt % of the layer, non-woven fiber web, or layer disposed on the non-woven fiber web.

Paragraph 155: In some embodiments, the conductive particles of the pasting paper, battery, or method as described in any one of paragraphs 31-154 have an average diameter of greater than or equal to 0.01 micron and less than or equal to 20 microns.

Paragraph 156: In some embodiments, the conductive particles of the pasting paper, battery, or method as described in any one of paragraphs 31-155 have an average aspect ratio of less than or equal to 1000:1 and greater than or equal to 1:1.

Paragraph 157: In some embodiments, the conductive particles of the pasting paper, battery, or method as described in any one of paragraphs 31-156 have an average aspect ratio of less than or equal to 3:1 and greater than or equal to 1:1.

Paragraph 158: In some embodiments, the capacitive fibers of the pasting paper, battery, or method as described in any one of paragraphs 31-157 make up greater than or equal to 1 wt % and less than or equal to 40 wt % of the layer, non-woven fiber web, or layer disposed on the non-woven fiber web.

Paragraph 159: In some embodiments, the capacitive fibers of the pasting paper, battery, or method as described in any one of paragraphs 31-158 comprise a carbon-containing material.

Paragraph 160: In some embodiments, the carbon-containing material of the capacitive fibers of the pasting paper, battery, or method of any one of paragraphs 31-159 comprises activated carbon.

Paragraph 161: In some embodiments, the capacitive fibers of the pasting paper, battery, or method as described in any one of paragraphs 31-160 have an average fiber diameter of greater than or equal to 2 microns and less than or equal to 30 microns.

Paragraph 162: In some embodiments, the capacitive fibers of the pasting paper, battery, or method as described in any one of paragraphs 31-161 have an average length of greater than or equal to 1 mm and less than or equal to 20 mm.

Paragraph 163: the capacitive fibers of the pasting paper, battery, or method as described in any one of paragraphs 31-162 have a surface area of greater than or equal to 100 m²/g and less than or equal to 5000 m²/g.

Paragraph 164: In some embodiments, the capacitive particles of the pasting paper, battery, or method as described in any one of paragraphs 31-163 make up greater than or equal to 70 wt % and less than or equal to 90 wt % of the layer, the non-woven fiber web, or the layer disposed on the non-woven fiber web.

Paragraph 165: In some embodiments, the capacitive particles of the pasting paper, battery, or method as described in any one of paragraphs 31-164 comprise a carbon-containing material.

Paragraph 166: In some embodiments, the carbon-containing material of the capacitive particles of the pasting paper, battery, or method as described in any one of paragraphs 31-165 comprises graphene.

Paragraph 167: In some embodiments, the carbon-containing material of the capacitive particles of the pasting paper, battery, or method as described in any one of paragraphs 31-166 comprises activated carbon.

Paragraph 168: In some embodiments, the capacitive particles of the pasting paper, battery, or method as described in any one of paragraphs 31-167 comprise a pseudocapacitive material.

Paragraph 169: In some embodiments, the pseudocapacitive material of the capacitive particles of the pasting paper, battery, or method as described in any one of paragraphs 31-168 comprises NiO, RuO₂, MnO₂, and/or IrO₂.

Paragraph 170: In some embodiments, the capacitive particles of the pasting paper, battery, or method as described in any one of paragraphs 31-169 have an average diameter of greater than or equal to 0.1 micron and less than or equal to 100 microns.

Paragraph 171: In some embodiments, the capacitive particles of the pasting paper, battery, or method as described in any one of paragraphs 31-170 have an aspect ratio of less than or equal to 1000:1 and greater than or equal to 1:1.

Paragraph 172: In some embodiments, the capacitive particles of the pasting paper, battery, or method as described in any one of paragraphs 31-171 have an aspect ratio of less than or equal to 3:1 and greater than or equal to 1:1.

Paragraph 173: In some embodiments, the capacitive species of the pasting paper, battery, or method as described in any one of paragraphs 31-172 is dispersed within the binder resin.

Paragraph 174: In some embodiments, the glass fibers of the pasting paper, battery, or method as described in any one of paragraphs 31-173 comprise microglass fibers.

Paragraph 175: In some embodiments, the microglass fibers of the pasting paper, battery, or method as described in any one of paragraphs 31-174 comprise M glass fibers and/or C glass fibers.

Paragraph 176: In some embodiments, the ratio of the weight of the plurality of conductive species to the weight of a plurality of capacitive species of the pasting paper, battery, or method as described in any one of paragraphs 31-175 is greater than or equal to 7:93 and less than or equal to 25:75.

Paragraph 177: In some embodiments, the ratio of the weight of the plurality of conductive species to the weight of a plurality of capacitive species of the pasting paper, battery, or method as described in any one of paragraphs 31-176 is or greater than or equal to 10:90 and less than or equal to 20:80.

Paragraph 178: In some embodiments, the layer, non-woven fiber web, or layer disposed on the non-woven fiber web of the pasting paper, battery, or method as described in any one of paragraphs 31-177 comprises diatomite particles.

Paragraph 179: In some embodiments, the diatomite particles of the pasting paper, battery, or method as described in any one of paragraphs 31-178 make up greater than or equal to 0.1 wt % and less than or equal to 10 wt % of the layer, non-woven fiber web, or layer disposed on the non-woven fiber web.

Paragraph 180: In some embodiments, the diatomite particles of the pasting paper, battery, or method as described in any one of paragraphs 31-179 have an average diameter of greater than or equal to 1 micron and less than or equal to 100 microns.

Paragraph 181: In some embodiments, the diatomite particles of the pasting paper, battery, or method as described in any one of paragraphs 31-180 have a specific surface area of greater than or equal to 0.5 m²/g and less than or equal to 200 m²/g.

Paragraph 182: In some embodiments, the diatomite particles of the pasting paper, battery, or method as described in any one of paragraphs 31-181 are configured to scavenge iron, nickel, chromium, silver, antimony, cobalt, copper, chlorine, manganese, and/or molybdenum.

Paragraph 183: In some embodiments, the diatomite particles of the pasting paper, battery, or method as described in any one of paragraphs 31-182 are configured to scavenge the iron, nickel, chromium, silver, antimony, cobalt, copper, chlorine, manganese, and/or molybdenum such that the amount of the iron, nickel, chromium, silver, antimony, cobalt, copper, chlorine, manganese, and/or molybdenum in the battery is less than or equal to 150 ppm and greater than or equal to 1 ppm.

Paragraph 184: In some embodiments, a ratio of a weight of the plurality of diatomite particles of the pasting paper, battery, or method as described in any one of paragraphs 31-183 to a weight of the active mass in the battery plate is less than or equal to 1:5 and greater than or equal to 1:200.

Paragraph 185: In some embodiments, the layer, non-woven fiber web, or layer disposed on the non-woven fiber web of the pasting paper, battery, or method as described in any one of paragraphs 31-184 comprises precipitated silica particles.

Paragraph 186: In some embodiments, the precipitated silica particles of the pasting paper, battery, or method as described in any one of paragraphs 31-185 have an average diameter of greater than or equal to 1 micron and less than or equal to 20 microns.

Paragraph 187: In some embodiments, the layer, non-woven fiber web, or layer disposed on the non-woven fiber web of the pasting paper, battery, or method as described in any one of paragraphs 31-186 comprises rubber particles.

Paragraph 188: In some embodiments, the layer, non-woven fiber web, or layer disposed on the non-woven fiber web of the pasting paper, battery, or method as described in any one of paragraphs 31-187 comprises titania, zirconia, bismuth (IV) oxide, copper (IV) oxide, nickel (IV) oxide, and/or zinc (IV) oxide.

Paragraph 189: In some embodiments, the layer, non-woven fiber web, or layer disposed on the non-woven fiber web of the pasting paper, battery, or method as described in any one of paragraphs 31-188 causes the battery plate to exhibit a hydrogen shift of greater than or equal to 10 mV and less than or equal to 500 mV.

Paragraph 190: In some embodiments, the layer, non-woven fiber web, or layer disposed on the non-woven fiber web of the pasting paper, battery, or method as described in any one of paragraphs 31-189 causes the battery plate to exhibit a hydrogen shift of greater than or equal to 30 mV and less than or equal to 120 mV.

Paragraph 191: In some embodiments, the layer, non-woven fiber web, or layer disposed on the non-woven fiber web of the pasting paper, battery, or method as described in any one of paragraphs 31-190 comprises microcapsules.

Paragraph 192: In some embodiments, the microcapsules of the pasting paper, battery, or method as described in any one of paragraphs 31-191 comprise ethyl cellulose, poly(vinyl alcohol), gelatin, and/or sodium alginate.

Paragraph 193: In some embodiments, the microcapsules of the pasting paper, battery, or method as described in any one of paragraphs 31-192 further comprise an active agent.

Paragraph 194: In some embodiments, the battery plate of the battery, or method of paragraphs 31-193 or on which the pasting paper of paragraphs 31-193 is disposed, comprises glass fibers.

Paragraph 195: In some embodiments, the glass fibers of the battery plate of the battery or method of paragraphs 31-194 or on which the pasting paper of paragraphs 31-194 is disposed, make up greater than or equal to 0.1 wt % and less than or equal to 10 wt % of the battery plate.

Paragraph 196: In some embodiments, the glass fibers of the battery plate of the battery, or method of paragraphs 31-195 or on which the pasting paper of paragraphs 31-195 is disposed, make up greater than or equal to 0.5 wt % and less than or equal to 5 wt % of the battery plate.

### Example 1

This Example describes a comparison between certain pasting papers comprising glass fibers, bicomponent fibers, and cellulose fibers with other pasting papers lacking two of these types of fibers.

Three pasting papers were prepared by wet laid forming. Each pasting paper included cellulose fibers, bicomponent fibers, and glass fibers. The bicomponent fibers were 1.3 Dtex PET/PE that were 6 mm long. The glass fibers included chopped strand glass fibers with an average fiber diameter of 13.5 microns and a length of 12 mm and/or microglass fibers with an average fiber diameter of 1.3 microns. These pasting papers were compared to two commercially available pasting papers, one of which lacked bicomponent fibers and glass fibers, and the other of which lacked bicomponent fibers and cellulose fibers. The basis weight, thickness, air permeability, and 1.28 spg sulfuric acid wicking height were determined for each pasting paper in accordance with the methods described above. Then, the pasting papers were stored in 1.28 spg sulfuric acid for 7 days at 75° C. After 1.28 spg sulfuric acid storage, the pasting papers were removed from the 1.28 spg sulfuric acid, washed with water, and then dried. The pasting papers were visually examined to determine whether they retained their structural integrity, and their machine direction dry tensile strengths were measured in accordance with the method described above. Table 1, below, shows the composition of each sample, and the results of the measurements performed thereon.

TABLE 1

| | | Dura-Glass ™ | | | |
|---|---|---|---|---|---|
| | DynaGrid ™ | PR-9 | Sample 1 | Sample 2 | Sample 3 |
| Wt % | 100 | 0 | 50 | 50 | 50 |
| cellulose | | | | | |
| fibers | | | | | |
| Wt % | 0 | 0 | 30 | 30 | 25 |
| bicomponent | | | | | |
| fibers | | | | | |
| Wt % chopped | 0 | 66 | 20 | 0 | 15 |
| strand glass | | | | | |
| fibers | | | | | |
| Wt % | 0 | 0 | 0 | 20 | 10 |
| microglass | | | | | |
| fibers | | | | | |
| Wt % binder | 0 | 34 | 0 | 0 | 0 |
| resin | | | | | |
| Basis weight | 13.4 | 20.2 | 30.9 | 26.4 | 28.1 |
| (g/m²) | | | | | |
| Thickness | 0.054 | 0.159 | 0.125 | 0.120 | 0.121 |
| (mm) | | | | | |
| Air | 272 | 1363 | 107 | 29 | 12 |
| permeability | | | | | |
| (CFM) | | | | | |
| 1.28 spg | 25 | 0.0 | 7.0 | 6.0 | 7.5 |
| sulfuric acid | | | | | |
| wicking | | | | | |
| height (cm) | | | | | |
| Structural | Disintegrated | Structural | Structural | Structural | Structural |
| integrity after | (after two | integrity | integrity | integrity | integrity |
| storage in | hours) | retained | retained | retained | retained |
| 1.28 spg | | | | | |
| sulfuric acid | | | | | |
| Dry tensile | N/A | 2.7 | 2.2 | 1.7 | 1.5 |
| strength after | | | | | |
| storage in | | | | | |
| 1.28 spg | | | | | |
| sulfuric acid | | | | | |
| (lb/in) | | | | | |

As shown in Table 1, pasting papers comprising a glass fibers, bicomponent fibers, and cellulose fibers (Samples 1-3) had beneficial properties both initially and after storage in 1.28 spg sulfuric acid. These pasting papers had initial values of air permeability that were low enough to prevent lead particles and/or lead dioxide particles in a battery plate from migrating through the pasting paper, wicking heights showing appreciable wettability of the pasting paper, and sufficient tensile strength after storage in 1.28 spg sulfuric acid to reduce lead shedding through the pasting paper. By contrast, both the pasting paper lacking glass fibers and bicomponent fibers (DynaGrid™) and the pasting paper lacking cellulose fibers and bicomponent fibers (Dura-Glass™ PR-9) had one or more disadvantageous properties. The pasting paper lacking glass fibers and bicomponent fibers disintegrated quickly in the 1.28 spg sulfuric acid, rendering it unsuitable for preventing lead shedding when present in a battery with a 1.28 spg sulfuric acid electrolyte. The pasting paper lacking cellulose fibers and bicomponent fibers had an incredibly high air permeability, which would result in unacceptably high lead particle and lead dioxide particle transport through the pasting paper, and a wicking height of 0 cm, rendering it undesirable for use in a battery with a 1.28 spg sulfuric acid electrolyte. The pasting papers comprising glass fibers, bicomponent fibers, and cellulose fibers thus outperformed pasting papers lacking at least two of these fiber types.

### Example 2

This Example describes the fabrication and physical properties of pasting papers comprising a variety of particles.

Each pasting paper was fabricated by: (1) positioning a non-woven fiber web on a laboratory-scale roll coater, (2) while passing the non-woven fiber web between two rollers, infiltrating the non-woven fiber web with an aqueous slurry comprising the particles of interest and a binder resin to form a non-woven fiber web comprising the particles of interest and the binder resin, and (3) drying the coated non-woven fiber web to remove the water.

Table 2, below, shows the compositions of the materials used to form each pasting paper and certain physical properties of the pasting papers.

TABLE 2

| | Sample 4 | Sample 5 | Sample 6 |
|---|---|---|---|
| Wt % chopped strand | 25 | 20 | 20 |
| glass fibers with | | | |
| respect to total | | | |
| amount of the fibers | | | |
| in the non-woven | | | |
| fiber web | | | |
| Wt % microglass | 10 | 0 | 0 |
| fibers with respect to | | | |
| total amount of the | | | |
| fibers in the non- | | | |
| woven fiber web | | | |
| Wt % PE/PET | 25 | 30 | 30 |
| bicomponent fibers | | | |
| with respect to total | | | |
| amount of the fibers | | | |
| in the non-woven | | | |
| fiber web | | | |
| Wt % cellulose fibers | 40 | 50 | 50 |
| with respect to the | | | |
| total amount of fibers | | | |
| in the non-woven | | | |
| fiber web | | | |
| Composition of slurry | 85.68 wt % water; | 50 wt % water; 50 | 97.11 wt % water; |
| infiltrated into non- | 11.25 wt % activated | wt % AERODISK WK | 2.24 wt % BaSO4 |
| woven fiber web | carbon particles; 1.25 | silica slurry (a | particles; 0.47 wt % |
| | wt % conductive | commercially | poly(acrylic acid) |
| | carbon particles; 1.46 | available slurry | binder (poly(acrylic |
| | wt % poly(acrylic | comprising 30 wt % | acid) with a weight |
| | acid) binder; 0.36 | silica particles) | average molecular |
| | wt % poly(acrylic | | weight of |
| | acid) processing aids | | approximately |
| | | | 250,000 g/mol); 0.18 |
| | | | wt % poly(acrylic |
| | | | acid) processing aids |
| | | | (poly(acrylic acid) |
| | | | with a weight average |
| | | | molecular weight of |
| | | | approximately 6,000 |
| | | | g/mol) |
| Wt % conductive | 0.54 | 0 | 0 |
| carbon particles with | | | |
| respect to the total dry | | | |
| weight of the pasting | | | |
| paper | | | |
| Wt % capacitive | 7.9 | 0 | 0 |
| carbon particles with | | | |
| respect to the total dry | | | |
| weight of the pasting | | | |
| paper | | | |
| Wt % silica particles | 0 | 10.5 | 0 |
| with respect to the | | | |
| total dry weight of the | | | |
| pasting paper | | | |
| Wt % barium sulfate | 0 | 0 | 1.76 |
| particles with respect | | | |
| to the total dry weight | | | |
| of the pasting paper | | | |
| Thickness of the non- | 0.164 | 0.145 | 0.159 |
| woven fiber web prior | | | |
| to infiltration with the | | | |
| slurry (mm) | | | |
| Thickness of the final, | 0.185 | 0.173 | 0.164 |
| dried pasting paper | | | |
| (mm) | | | |
| Air permeability of | 125 | 108 | 257 |
| the non-woven fiber | | | |
| web prior to | | | |
| infiltration with the | | | |
| slurry | | | |
| Air permeability of | 30 | 45 | 242 |
| the final, dried pasting | | | |
| paper | | | |
| Water absorption of | | 21.3 | |
| the non-woven fiber | | | |
| web prior to | | | |
| infiltration with the | | | |
| slurry (g/m²) | | | |
| Water absorption of | | 47.9 | |
| the final, dried pasting | | | |
| paper (g/m²) | | | |
| Capacitance of the | 0 | 0 | 0 |
| non-woven fiber web | | | |
| (F/g of non-woven | | | |
| web) | | | |
| Capacitance of the | 42 | 0 | 0 |
| final pasting paper | | | |
| (F/g of carbon) | | | |

As can be seen from Table 2, the incorporation of silica particles into a pasting paper increases its water absorption, and the incorporation of capacitive and conductive species into a pasting paper increases its capacitance.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A battery, comprising:
a battery plate comprising an active mass comprising lead;
a layer, comprising:
a plurality of conductive species; and
a plurality of capacitive species,
wherein:
a ratio of a weight of the plurality of conductive species to a weight of the plurality of capacitive species is greater than or equal to 5:95 and less than or equal to 30:70; and
a ratio of a sum of the weight of the plurality of conductive species and the weight of the plurality of capacitive species to a weight of the active mass is less than 1:100.

2-9. (canceled)

10. A battery as in claim 1, wherein the plurality of conductive species comprises conductive particles.

11. A battery as in claim 10, wherein the conductive particles make up greater than or equal to 5 wt % and less than or equal to 30 wt % of the layer.

12-14. (canceled)

15. A battery as in claim 10, wherein the conductive particles comprise a carbon-containing material.

16. A battery as in claim 15, wherein the carbon-containing material comprises carbon black and/or acetylene black.

17-18. (canceled)

19. A battery as in claim 10, wherein the conductive particles have an average diameter of greater than or equal to 0.01 micron and less than or equal to 20 microns.

20-28. (canceled)

29. A battery as in claim 1, wherein the plurality of capacitive species comprises capacitive particles.

30. A battery as in claim 29 wherein the capacitive particles make up greater than or equal to 70 wt % and less than or equal to 90 wt % of the layer.

31. A battery as in claim 29, wherein the capacitive particles comprise a carbon-containing material.

32. (canceled)

33. A battery as in claim 31, wherein the carbon-containing material comprises activated carbon.

34-35. (canceled)

36. A battery as in claim 29, wherein the capacitive particles have an average diameter of greater than or equal to 0.1 micron and less than or equal to 100 microns.

37-40. (canceled)

41. A battery as in claim 1, wherein the layer comprises a binder resin.

42. A battery as in claim 41, wherein the conductive species is dispersed within the binder resin.

43. A battery as in claim 41, wherein the capacitive species is dispersed within the binder resin.

44. A battery as in claim 41, wherein the binder resin makes up greater than or equal to 0.5 wt % and less than or equal to 30 wt % of the layer.

45. A battery as in claim 1, wherein the layer comprises a plurality of cellulose fibers.

46-51. (canceled)

52. A battery as in claim 1, wherein the ratio of the sum of the weight of the plurality of conductive species and the weight of the plurality of capacitive species to the weight of the active mass is greater than or equal to 1:1000.

53. A battery as in claim 1, wherein the ratio of the weight of the plurality of conductive species to the weight of a plurality of capacitive species is greater than or equal to 7:93 and less than or equal to 25:75.

54-70. (canceled)

71. A battery as in claim 1, wherein the battery plate comprises glass fibers.

72. A battery as in claim 71, wherein the glass fibers make up greater than or equal to 0.1 wt % and less than or equal to 10 wt % of the battery plate.

73-167. (canceled)
